(19) United States
(12) Patent Application Publication
(10) Pub. No.: US 2025/0131451 A1
(43) Pub. Date: Apr. 24, 2025

(54) METHOD OR SYSTEM FOR DETERMINING AND/OR EVALUATING A SUSTAINABILITY OF A PRODUCT, A SERVICE, AN ORGANIZATION AND/OR A PERSON

(71) Applicant: Vincent DERT, Middletown (DE)

(72) Inventor: Vincent DERT, Middletown (DE)

(21) Appl. No.: 18/833,984

(22) PCT Filed: Jan. 27, 2022
(86) PCT No.: PCT/US2022/014167

§ 371 Date: Jul. 29, 2024

(51) Int. Cl. G06Q 30/018; G06Q 10/087; G06Q 30/0283

(52) U.S. Cl. CPC G06Q 30/018; G06Q 10/087; G06Q 30/0283

(57) ABSTRACT

The present invention relates to a method for determining and/or evaluating a sustainability of a product, a service, an organization and/or a person, wherein said method comprises the steps of:
i. providing and/or establishing an evaluation system on the basis of pre-defined evaluation variables, which evaluation system is appropriate and/or configured to assign a sustainability value to the product, the service, the organization or the person to be evaluated,
ii. quantifying, on the basis of the pre-defined evaluation variables, impacts on the environment and impacts affecting human conditions for the product, the service, the organization or the person to be evaluated, and
iii. assigning, on basis of the quantified impacts, a specific sustainability value to the product, the service, the organization or the person to be evaluated.

The present invention further relates to a corresponding system and use of the method.

### CROSS-REFERENCES TO RELATED APPLICATIONS

This application is a National Stage filing of International Application PCT/US 2022/014167 (WO 2023/146525) filed Jan. 27, 2022, entitled “Method or system for determining and/or evaluating a sustainability of a product, a service, an organization and/or a person. The subject application claims priority to PCT/US 2022/014167 and incorporates all by reference herein, in their entirety.

### BACKGROUND OF THE INVENTION

The invention relates to a method or a system for determining and/or evaluating a sustainability of a product, a service, an organization and/or a person.

In the following, the determined and/or evaluated sustainability is in particular related to a product. However, it has to be understood that the explanations with regard to the sustainability of a product also relate to the sustainability of a service, an organization and/or a person. The sustainability of a service can in particular be the sustainability of a service provision, like a massage and/or any other treatment that is a service. The sustainability of an organization can in particular relate to an organization which produces products and/or provides services. Moreover, the sustainability of the organization can also take the employees, the working conditions, the consumption of energy or any other products or any other variable related to sustainability into account.

Sustainability is increasingly important and related to many issues including inhumane conditions, biodiversity losses, global warming, water shortage, coastal flooding, natural resource depletion and soil degradation and loss. These aspects threaten to reduce global biodiversity to low levels through massive extinctions, reducing the global human carrying capacity and quality of life of the surviving species populations (including human) to far below currently acceptable levels throughout most of the world.

Human working and living conditions were thus far not included as sustainability variables. Human conditions must especially be included as critical sustainability variables.

(Human) population growth adversely affects all aspect of sustainability and is therefore an important sustainability variable by itself. Population growth in combination with increased animal husbandry, trading in live wild animals for consumption and incursion into, and loss of wildlife areas, increases the probability of development and spreading of infectious diseases. Human suffering from pandemics negatively affects human conditions. Increases in pandemic probabilities are also non-sustainable, since resources abating pandemics and income not earned are no longer available to accelerate sustainable developments.

Global warming and loss of wildlife area need to be stopped and conditions need to be restored before increasingly damaging and irreversible changes set in. These environmental and human condition problems require an integrated solution currently unavailable.

For individuals various online “footprint” calculation methods exist, allowing the calculation of individual ecological and carbon footprints. No such calculations exist for human condition impacts.

For products a large number of measurement systems related to sustainability were developed over the last decades. However, no singular definition of sustainability is used in these systems and in most cases a panel of consumers is asked to define what they feel sustainability should include. All focus on a per method different and narrow application area using application specific inputs and creating application specific outputs. Each system is so different that this prevents their use for global products.

Some manufacturers provide calculators that aim to calculate some metric related to sustainability of their products while others produce “sustainability scorecards”, where typically the producer and a collection of other stakeholders define which variables are important for sustainability.

Governments thus far have not only been ineffective in reversing non-sustainable developments, but they have been stimulating all non-sustainable developments. Even after publication of Limits to Growth in 1972, governments stimulated burning/landscape change of tropical rain forests and other wildlife areas to grow sugar cane for ethanol production, for palm oil plantation and corn to ethanol schemes. More recently, businesses, many of them trying hard to do the rights thing, have failed to improve global sustainability as well, mainly because they lack the tools needed to correctly calculate sustainability and to correct damage done.

While consumers think they have choices that could lower their (negative) environmental impacts, in reality making such different choices has (on average) little effect. Without reliable and reasonably accurate indications of product sustainability, available for comparable products at time of purchase, consumers cannot distinguish more sustainable from less sustainable products. Without such reasonably accurate product sustainability data, marketers color everything “green”.

While sustainability is widely recognized as very important, available systems have the following drawbacks:
Environmental impacts of employees are excluded from sustainability calculation methods.
No systematic and accurate methods exist to calculate the sustainability of labor, manufactured products and services as part of a universal system.

### BRIEF SUMMARY OF THE INVENTION

The object of the present invention is to provide a method or a system for determining and/or evaluating and improving a sustainability in particular with regard to the sustainability of product, a service, an organization and/or a person, wherein the disadvantages of the prior art are overcome or at least substantially reduced.

The aforementioned object is solved with a method or a system according to claims provided.

Advantageous embodiments are stated in the dependent claims.

According to the invention, a method for determining and/or evaluating a sustainability of a product, a service, an organization and/or a person is provided, wherein said method comprises steps of:
i. providing and/or establishing an evaluation system on the basis of pre-defined evaluation variables, which evaluation system is appropriate and/or configured to assign a sustainability value to the product, the service, the organization or the person to be evaluated,
ii. quantifying, on the basis of the pre-defined evaluation variables, impacts on the environment and impacts affecting human conditions for the product, the service, the organization or the person to be evaluated, and
iii. assigning, on basis of the quantified impacts, a specific sustainability value to the product, the service, the organization or the person to be evaluated.

The inventive method and/or system in particular allows near real time determination of environmental and human (environ-human or EH) impacts and their conversion to EH liabilities for products and income. The method can calculate the transaction price (value) of a product by adding the EH liability costs to the list price (asking price). To maintain profit margin, the seller in particular needs to raise prices for non-sustainable products. Participant buyers preferably need to buy EH conservation to reach 100% conservation sustainability. Based on logic and math used, consumers can buy such conservation at essentially zero net costs while saving money in the overall process.

Damaging EH impacts of products and services can best be prevented in the processes used to make the products and/or provide the services. In addition, conservation could be applied to neutralize remaining damaging EH impacts. However, these two approaches are in particular not or insufficiently applied. In addition, consumers have in particular no insight in such damaging and conserving impacts applied and would need a sustainability value based on all EH impacts in order to apply a conservation. Therefore, due to the measurement of sustainability—that means due to the determined sustainability value—the inventive method can in particular be used for applying conservation to a product, person, service and/or organization and thus transforming the product, person, service and/or organization from a non-sustainable to a sustainable product, person, service and/or organization. The determination of sustainability values is preferably indicative of how the values score on the sustainabilities scale. This application of conservation is a preferred embodiment of the invention.

According to the invention, the variables can include the variables itself as well as their values. Thus, the values of the variables, in particular the pre-defined evaluation variables, can also be used in the inventive method.

In particular, as part of the method, certain amounts of each type of natural resource used, referred to as “sustainable resource use allowances”, can be used sustainably by every individual or person. Such allowances do in particular not exist for current of historic environ-humane (EH) damage done.

In particular, in the following the terms “individual” and “person” can be used interchangeable. Therefore, the term “individual” can refer to a “person” and vice versa.

The method can modify the use of money by removing the EH liabilities of money through conservation payments. This creates money free of EH impacts. The method creates markets for all forms of EH conservation required and for unused natural resource use allocations. This preferably allows the fastest possible return to pre-industrial atmospheric conditions while minimizing permanent biodiversity damage, potentially erasing poverty and otherwise improving human conditions. The method acts like a catalyst to overcome barriers, allowing rapid change from a higher cost non-sustainable to a lower cost sustainable condition.

The method and/or the system provides near real time determination of the sustainability of labor, products and services by quantifying damaging and conserving environ-human (EH) impacts. As part of the method, environmental and human impacts are only allowed to move in the direction of the end-user, resulting in EH impact-free money flows for payments made between participants. EH impacts can be categorized as damaging, conserving or as sustainable use of natural resources.

For the classic use of money, the amount of money paid to purchase a product can reflect the value of the product. This reflection of value can be typically expressed as and limited to the currency used and the numbers of units of the currency used for payment. Under the invention, the product can include all associated EH impacts. The classic reflection of the value of money can therefore be expanded to include the value of all EH impacts. In turn, this can allow the calculation of EH impact values for all financial accounts and for other assets and their derivatives.

The invention in particular describes the Metrics system using the concept of supply chains, but uses these in particularly very different ways than in their current use and definition.

The supply chain steps used for the invention are therefore referred preferably to as environ-human supply chain steps or ESCS. The invention in particular uses three types of ESCS: individual supply chain steps (ISCSs), product supply chain steps (PSCSs) and rating supply chains steps (RSCSs). ISCSs are used to calculate the EH impacts, liabilities and sustainability of individuals. PSCSs are used to calculate the EH impacts, liabilities and sustainability of products. RSCS are used to estimate the EH impacts, liabilities and sustainability of all inputs to ESCS that are not “rated” (do not originate form ISCS, RSCS or PSCS). Preferably, in case of 100% societal Metrics participation, all ESCS inputs would originate from ISCS and PSCS, precluding the use of RSCSs, other than for the initial determination and periodic updating of location based impacts (LBIs) in case such LBIs are present.

In particular, in the theoretical case of absence of trade (100% individual self-reliance and absence of products exchange), PSCSs would not exist. In that case individual EH impacts, individual liabilities and individual sustainabilities could be calculated using only ISCSs and RSCSs. ISCS are therefore in particular the most essential type of ESCS. Since humans do exchange products and services with each other, PSCSs are preferably needed in a secondary role. RSCS are particularly needed in a tertiary role.

In particular, only three types of ESCSs are used, where each type of ESCS has specific functional units and uses specific calculation methods to calculate outputs. The three types of ESCS can be:
Individual supply chain step (ISCS): used to calculate EH impacts and financial compensations outputs of ISCSs based in their inputs.
Product supply chain step (PSCS): used to calculate EH impacts and financial compensations outputs of PSCSs based in their inputs.
Rating supply chain steps (RSCS): used to estimate EH impacts inputs and calculate EH impacts outputs that are inputs to ESCSs.

RSCS are supply chain steps where “unrated” LBIs, supplies and labor that are inputs to downstream ESCS are determined. RSCS can operate similar to PSCSs where inputs (energy, materials, parts and products) can be modified using labor and materials, but such that their modification can be limited to the assessment of their EH impacts. For purposes of sustainability, the global supply chain can be calculated, while offering seamless interconnections, using only these three types of ESCSs.

ISCSs can be used to calculate individual EH output impacts and individual sustainability. This in particular includes a specific calculation method for the calculation of personal sustainable absorption (PSA). The EH impacts of individuals can in turn be inputs to a PSCS. For each individual, only one ISCS over the individual's life time and this one particularly ISCS preferably needs to be calculated. In particular, ISCS is also not known by those skilled in the art and can be an essential inventive concept.

PSCSs can be used to calculate product EH output impacts and product sustainability. This includes in particular a specific calculation method for the calculation of the excess impact deduction (XID). The EH impacts of products can be in turn inputs to ISCS for the individuals consuming these products. For each product only one PSCS particularly needs to be calculated.

The use of dedicated PSCSs with their associated environmental supply chain calculations is not known by those skilled in the art and can be an essential inventive concept.

The limitation of supply chain steps to these three standard types can allow the required functionality and seamless interconnection not present before and not only simplifies calculation, but essentially makes such supply chain calculations possible and can be an essential inventive concept.

All inputs to ESCS originating from other ISCS, PSCS and RSCS can have known EH impacts (that means that they are in particular “rated”). RSCS can be supply chain steps where “unrated” LBIs, supplies and labor (originating from activities carried out at the location, and/or from non-participating sellers and/or from employees) that are inputs to downstream ESCS, are given a rating. Such determinations are preferably made by an impact rating organization (IRO).

RSCS operate similar to PSCSs where inputs (energy, materials, parts and products) can be modified using labor and materials, but such that their modification can be limited to the assessment of their EH impacts.

The use of dedicated RSCSs is not known by those skilled in the art and can be an essential inventive concept.

The product outputs of a PSCS as expressed in EH impact values can be typically not merely equal to the sum of all EH impact inputs. While this sum in particular happens to be the correct case under sustainable individual labor conditions it is particularly not the case under non-sustainable individual labor conditions. Under sustainable conditions, the labor output of an individual (as represented by the ISCS), can be free of EH impacts. In that case all EH impacts that are inputs to the ISCS enter with the goods and services consumed and as location based impacts (LBIs) and are fully absorbed as PSA. This changes when individual consumption becomes non-sustainable. Under non-sustainable individual conditions, some of the same EH impacts that entered the PSCS with the labor input did already enter the same or another PSCS as supplies or LBI, leading to double counting of damaging EH impacts somewhere in the environmental supply chain. When left uncorrected this double counting would in particular lead to an erroneous accumulation of damaging EH impacts in the supply chain. The EH impacts corresponding with the amount entering the PSCS a 2^{nd} time needs to be deducted from the PSCS product output as excess impacts deduction (XID). The realization that such XID can be needed and the use of the corresponding XID calculations can be essential inventive concepts.

Preferably, the invention allows calculation of individual, product and service sustainabilities on a scientific and global basis. In extension it can allow the calculation of organizational, national, regional and global sustainabilities. In addition to being useful and having concrete and tangible results, the invention can be of extreme importance in order to improve global sustainability in the fastest possible way. The invention can define all environ-human (EH) impacts associated with a product, a service or with labor (including damage done) as an integral part of the same product, service or labor. The invention preferably applies any required conservation automatically and immediately as a 2^{nd} purchase following each (1^{st}) purchase, but limited to availability. Such conservations (e.g. CO₂ sequestration, wildlife area restoration) would otherwise not take place and are tangible results of the invention.

More preferably, the invention describes a method to measure individual and product sustainability measurement and improvements on a scientific basis. The invention can accomplish all aspects of sustainability scientists have been looking for.

Both from a theoretical and practical point of view, EH impacts, EH liabilities and sustainabilities for both individuals, products and services can preferably only be calculated using at least the individual supply chain step (ISCS). The use of ISCS, PSCS or RSCS cannot be found in the prior art.

Preferably, the use of ISCS is essential in order to determine individual EH impacts, liabilities and sustainabilities. ISCSs can be used to calculate the collected individual EH input and output impacts and sustainability. The labor output of each ISCS can provide inputs to PSCS; hence without the use of ISCS, EH impacts and EH liabilities for products and product sustainabilities cannot be calculated and/or the required amounts of conservation cannot be applied.

For each individual only one ISCS preferably needs to be calculated and updated once per accounting period (day, hour, other). The use of individually dedicated ISCSs with their associated environmental supply chain calculations is not known by those skilled in the art and can be an essential inventive concept.

Preferably, in the inventive method and/or in the inventive system individual and product impacts, liabilities, required conservation and sustainabilities can be calculated using three types of environmental supply chain steps (ECSCs).

More preferably, in the inventive method and/or in the inventive system the EH impacts, EH liability, applied and required conservation and sustainabilities of individuals, products and services along the supply chain can be measured and/or determined.

Implementation of the invention would in particular create an extremely competitive environment where more sustainable individuals and organizations have lower costs and drive non-sustainable individuals and organizations into non-competitive positions (and out of business). This would preferably lead to the fastest possible change towards a sustainable society.

In particular, the mostly damaging EH impacts of products and services purchased/consumed are transferred to the consuming individuals or processes. However, the automatic application of title to conservation (TTC) as a 2^{nd} purchase immediately can follow the initial purchase of the product or service. This purchase of TTC effectively can remove the package of damaging EH impacts (or part of it based on availability) from the products and thus transforms the product. For example, if a purchase of 1 Gal of gasoline would produce 9 kg of carbon dioxide upon combustion, an automatic 2^{nd} purchase of 9 kg of sequestered CO₂, immediately following the gasoline purchase, would immediately remove the CO₂ (to be emitted upon combustion) from the product bought.

In particular, the concept of conversion of conservation of each type to globally standardized units for which the “title” of having applied the conservation (“title to conservation” or TTC) can be traded and applied to individual consumption, is not known by those skilled in the art and can be an essential inventive concept.

In order to purchase the TTC reflecting the removal of carbon dioxide from air, factories preferably need to be built, extracting carbon dioxide from air and (permanently) sequestering the carbon dioxide deep underground (C-sequestration). Once such C-sequestration capacity exists, for each amount of gasoline purchased, the corresponding carbon dioxide emissions to the atmosphere can be fully removed from the same atmosphere by the 2^{nd} purchase of TTC.

When sufficient C-sequestration capacity is available, the transformation process can take place before, during or immediately after consumption of the combustible fuel. Immediate C-sequestration of C-emissions makes it easier for consumers to envision the transformation taking place. However, any earlier or later C-sequestration in particular does not make the removal of the C-emissions from the product less transformative as long as good contracts are in place to link specific amounts of C-emissions generated and C-sequestrations applied, to a specific product or service and guarantee the removal of the amount of C-emissions purchased with the TTC. In case insufficient C-sequestration capacity can be available at a particular time, the 2^{nd} purchase of TTC can still take place, removing the carbon dioxide from the product purchased in the 1^{st} transaction based on contracts for future delivery.

While damaging and conserving impacts are in particular still tactile for both the loss and the restoration of wildlife areas, such restoration can take more time (decades to centuries) than for the delayed delivery of C-sequestration, but otherwise particularly does not change the transformation of the product.

In particular, in addition to the physical changes to products by removing damaging EH impacts through the application of conservation (preferably e.g. removing C-emissions by applying C-sequestrations), there is another change that transforms the product: A change in price!

For participating vendors selling to participating buyers, an unsustainable product will preferably become more expensive by the amount corresponding to the cost of conservation needed to offset the EH use and damage impacts. While such changes are relatively small for the average product (in particular 5 to 6%) they are much larger for some products (e.g. fossil fuels). Consequently, less sustainable products will particularly price themselves out of the market. Product prices go up and down with supply and demand, but one could argue that a systematic and non-reversible price increase for a product would constitute a product transformation by itself. Likewise, (more) sustainable products will preferably drop in price over time in particular due to the transition to lower cost solar and wind power and the elimination of damaging EH impacts in general.

Under current manufacturing conditions, for each intended product made, byproducts (e.g. carbon dioxide and pollutants) are in particular produced while other EH damage is done (e.g. wildlife area loss, biodiversity loss, inhumane living and working conditions). While manufacturers would like to make us believe that such damaging EH impacts do not exist on a product by product basis, these EH impacts were created while manufacturing the product, continue to exist and therefore are in extension part of the intended product sold. The same applies to services provided. Under current agreements, prices and incomes paid cannot be corrected for the value of EH impacts. Such impacts currently can represent mostly EH damage and thus can represent EH liabilities. Under the Metrics system, participants can accept EH impacts, collected along the supply chain for the manufacturing of the product, as an integral part of the product. The (negative) value of the EH impacts can be therefore added to the price paid or salary earned. For products with net EH liabilities, this can lead to a price reduction. For labor outputs with net EH liabilities this can lead to a salary reduction. To maintain profit margins, sellers will in particular need to increase prices for non-sustainable products. Since sustainable products have lower costs, prices for sustainable products would particularly remain (initially) unchanged or drop slightly (later).

The price increases for non-sustainable products will preferably price these “out of the market” and can provide a strong incentive to buy more sustainable products.

Preferably, the step ii of the inventive method comprises quantifying damaging impacts on the environment and damaging impacts affecting human conditions for the product, the service, the organization or the person to be evaluated. Further, the step ii of the inventive method can comprise a determination of conservation, and optionally its costs, required to neutralize the damaging impacts and/or use of resources. Due to the quantified damaging impacts it is possible to overcome the negative influence of the damaging impacts because the conservation that is required to neutralize these impacts can be determined and thus in particular also realized and/or applied. The sustainability (i.e. a sustainable product or service) can therefore be provided because the negative/damaging impacts can be neutralized. The neutralization can be achieved in different ways and with regard to different groups for which a conservation could be applied.

According to a further preferred embodiment of the present invention, the conservation required to offset and/or neutralize the impacts on the environment and the impacts affecting human conditions, in particular the damaging impacts, for the product, the service, the organization and/or the person to be evaluated in step ii of the method can be selected from at least one of the following groups:
human condition conservation,
wildlife area conservation,
watershed area conservation,
carbon sequestration,
soil and sediment conservation,
soil and surface water pH restoration,
dike protection of coastal areas at risk of flooding.

It has to be understood that also at least one or a combination of the aforementioned groups can be used to neutralize and/or offset the damaging impacts. In particular the conservation required can be purchased in the form of title to conservation (TTC) representing at least one of the aforementioned types or groups of conservation.

The invention also relates to a system for determining and/or evaluating a sustainability of a product, a service, an organization and/or a person. The system can be realized together or independently from the aforementioned method. The system is in particular configured to
a. quantify, on the basis of pre-defined evaluation variables, impacts on the environment and impacts affecting human conditions for the product, the service, the organization or the person to be evaluated, and
b. assign, on basis of the quantified impacts, a specific sustainability value to the product, the service, the organization or the person to be evaluated.

It has to be understood that the aforementioned and the following mentioned features with regard to the method can be also applied to the inventive system without further explicit disclosure. Moreover, the advantages that are described with regard to the method also apply to the inventive system. Thus, reference can be made to the already described advantages with regard to the inventive method.

Advantageous embodiments of the inventive system are described in the dependent claims of the system.

The inventive system preferably enables the application of conservation to a product, organization, a service or a person, based on the value of their sustainability. Thus, a transformation of non-sustainable products, services, persons or organizations to sustainable ones is in particular made possible.

The invention is explained in more detail below by way of the description of preferred exemplary embodiments, partly with reference to the drawing. The features described above and/or disclosed in the claims and/or in the following description can be combined with one another, where needed, but can also be realized independently from one another, even if this is not described explicitly in detail.

### BRIEF DESCRIPTION OF THE DRAWINGS

FIG. 1 a schematic illustration of the method according to the invention,

FIG. 2A a schematic illustration of a product,

FIG. 2B a schematic illustration of an individual/person

FIG. 2C a schematic illustration of a service,

FIG. 2D a schematic illustration of an organization,

FIG. 3 a further schematic illustration of the method according to the invention,

FIG. 4A a sustainability change cycle for individuals, in particular showing improving outcomes for participation,

FIG. 4B a sustainability change cycle for individuals, in particular showing deteriorating outcomes for non-participation,

FIG. 5A a sustainability change cycle for organization, in particular showing improving outcomes for participation,

FIG. 5B a sustainability change cycle for organization, in particular showing deteriorating outcomes for non-participation,

FIG. 6 a schematic illustration of an individual supply chain step,

FIG. 7 a schematic illustration of a product supply chain step,

FIG. 8 a schematic illustration of the combined individual supply chain step and the product supply chain step,

FIG. 9 a schematic illustration of a rating supply chain step, in particular providing rated inputs to a PSCS.

FIG. 10 a further schematic illustration of a rating supply chain step, in particular providing rated inputs to an ISCS,

FIG. 11 a schematic illustration of the depiction of an individual supply chain step and a product supply chain step with storage blocks for money, supplies purchased and products made,

FIG. 12 a schematic illustration of the conversion of non-sustainable asset value,

FIG. 13 a schematic illustration of the combination of individual supply chain step and the product supply chain step, in particular where all supplies originate from a “nested environmental supply chain step (ESCS) group”,

FIG. 14A a schematic illustration of the combination of individual supply chain step and product supply chain step for allowance variables under normalized reference conditions, in particular for environ-human impacts and monetary compensation for global systems,

FIG. 14B a schematic illustration of the combination of individual supply chain step and product supply chain step for allowance variables under normalized non-sustainable conditions, in particular for environ-human impacts and monetary compensation for global systems,

FIG. 15 a schematic view of the sustainability of an organization,

FIG. 16A a schematic view of the transformation of non-sustainable products to sustainable ones,

FIG. 16B a further schematic view of the transformation of non-sustainable products, services, persons or organizations to sustainable ones.

### DETAILED DESCRIPTION OF THE INVENTION

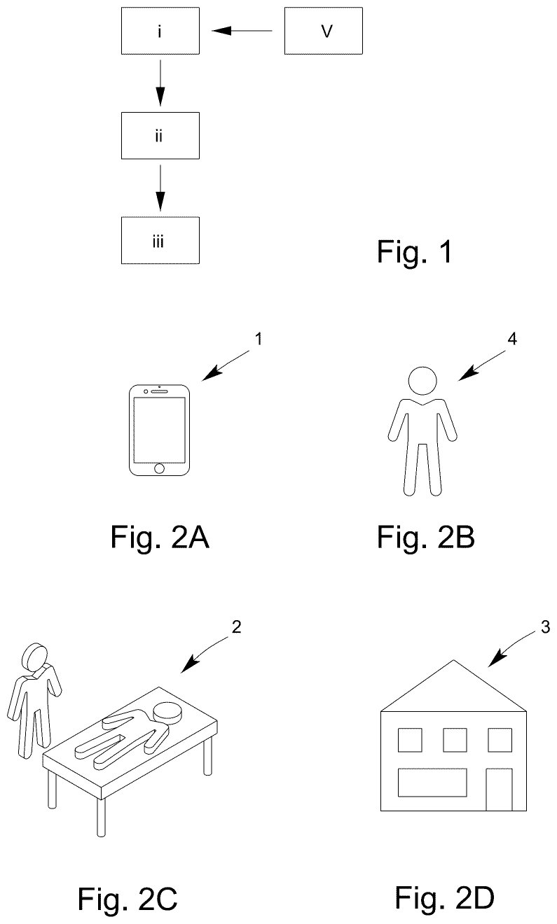

FIG. 1 shows a method for determining and/or evaluating a sustainability of a product 1, a service 2, an organization 3 and/or a person 4. The method includes the steps i. to iii., which are preferably carried out successively.

The product 1 is schematically shown in FIG. 2A. Further, FIG. 2 A shows as a product 1 a mobile phone, in particular a smartphone. Nevertheless, different products 1 and services 2 can be integrated in the inventive method. Preferably, in the method all the products 1 and services 2 which are sold and/or purchased, or change ownership, in particular including those with zero costs, like donations and/or volunteer work, can be taken into account by the inventive method.

One possible form of a service provision for a service 2 is shown in FIG. 2C. In particular, FIG. 2C depicts as a service 2 a massage carried out by a masseur.

Moreover, FIG. 2D shows a schematic illustration of an organization 3. The organization 3 can be a company, an independent worker or any other form of an organization 3 which produces products 1 and/or provides services 2.

FIG. 2B shows in a schematic illustration a person 4. In particular, any person 4 can be taken into account for the evaluation and/or determination of the sustainability. Preferably, the age or the sex are no limiting factors for the access of the person 4 to the inventive method.

The step i. shown in FIG. 1 includes the step of providing and/or establishing of an evaluation system on the basis of pre-defined evaluation variables V. The influence of these variables V is also shown in FIG. 1. The evaluation system is appropriate and/or configured to assign a sustainability value to the product 1, the service 2, the organization 3 or the person 4.

The totality of the components of FIG. 1 including all supporting organizations that provide functionality needed for the system to operate as designed, like impact rating organizations and organizations providing conservation, can also be referred to as the Metrics System or the “Metrics”.

Preferably after the evaluation system has been used in step i. to determine the predefined evaluation variable values, the impacts on the environment and impacts affecting human conditions for the product 1, the service 2, the organization 3 or the person 4 to be evaluated can be quantified in step ii., in particular on the basis of the pre-defined evaluation variables V shown in FIG. 1. These impacts can include EH resource use and/or otherwise damaging impacts as well as EH conserving impacts.

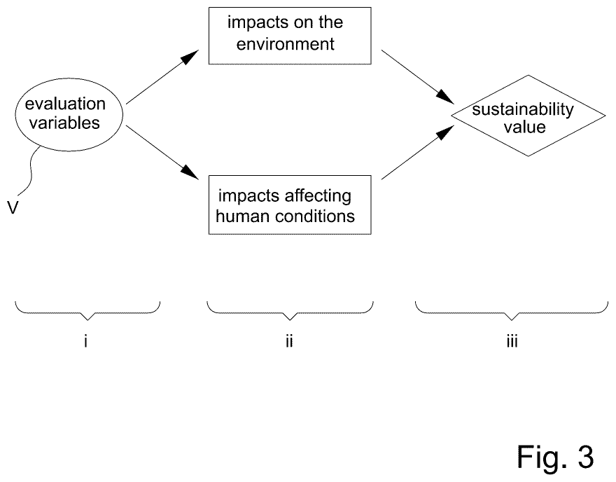

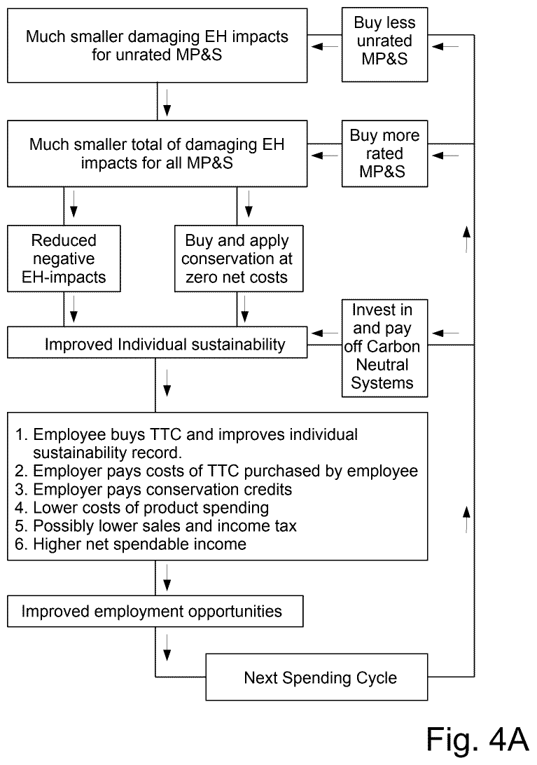

Step iii. as preferably shown in FIGS. 1 and 3 includes in particular the step of assigning on the basis of the quantified EH impacts, a specific sustainability value to the product 1, the service 2, the organization 3 or the person 4 to be evaluated. Therefore, step iii. in particular is dependent on the assigned EH impacts values as shown in step ii of FIG. 3.

Due to the fact that it is possible to determine the use and damage impacts and sustainability values, the negative influences of the impacts can be offset. In particular, the negative influence of the impacts can be fully or partially offset by the conservation in preferably almost all practical and near future cases by determination of EH impacts, preferably alone. In the case of the use of “compensated sustainability”, additional conservation can be applied based on sustainability values leading to a more than fully offsetting of damaging impacts.

In particular, the inventive method can be used for the partial or complete removal of damaging impacts on the environment or on the people.

The influences of the different steps or variables of the inventive method are in particular shown in FIG. 3. FIG. 3 shows that in step i. of the method evaluation variables V, in particular pre-defined evaluation variables V, are used. Based on these variables V in step ii. impacts on the environment and impacts affecting human conditions—as already outlined above—can be quantified and determined. Based on this quantification, it is possible to determine the sustainability value in step iii.

The step ii. of the inventive method shown in FIGS. 1 and 3 can comprise the method step of quantifying damaging impacts on the environment and damaging impacts affecting human conditions for the product 1, the service 2, the organization 3 or the person 4 to be evaluated. Thus, the step ii. can in particular include in addition to the quantifying of the impacts on the environment and the impacts affecting human conditions the quantifying of the damaging impacts on the environment and the damaging impacts affecting human conditions. The damaging impacts are in particular included in the impacts as outlined with regard to step ii. Further, the step ii. can include the step of determining a conservation, and optionally its costs, required to neutralize the damaging impacts and/or use of resources. This determined conservation can in particular be realized and/or implemented with projects or measures, preferably by investing into different projects concerning the conservation. Preferably, with the determined costs for the conservation these amounts of money can be invested, preferably to neutralize the damaging impacts. Thus, sustainability can be reached and/or improved.

The specific sustainability value for the product 1, the service 2, the organization 3 or the person 4 can in particular be used to sell the product 1 or to buy the service 2 with an amount of money which includes together with the price for the product 1 or the service 2 the costs for the conservation required to neutralize the damaging impacts and/or the use of resources. Therefore, a sustainable trading and/or commerce can be reached and/or realized. The sustainability value of the organization 3 or the person 4 can be used by the organization 3 respectively by the person 4 to ensure that the organization 3 has a sustainable way of working or manufacturing, in particular of products 1 and providing in particular services 2.

Further, the sustainability value can be used for transforming non-sustainable products 1, services 2, organizations 3 or persons 4 into sustainable ones, preferably by applying a conservation which is in particular based on the sustainability value.

In particular, in order to be effective, the method and/or the Metrics can need to include three essential tasks: quantification of impacts, determination of required conservation and implementation of such conservation. The determination of a sustainability value is preferably useful as in indicator. Of the three essential tasks two include, quantifying damaging impacts on the environment and damaging impacts affecting human conditions for the product (1), the service (2), the organization (3) or the person (4) to be evaluated and determining a conservation, and optionally its costs, required to neutralize the damaging impacts and/or use of resources. The 3^{rd} can also be combined in step ii. Preferably, step ii. is related to conservation applied in case this conservation was purchased and paid for by consumers or producers and assigned to a specific product make.

Organizations 3 and individuals (persons 4) can already in particular choose to pay for conservation, not assigned to specific products. These conservations can be “non-rated” often vague and should be kept separate from the (rated) conservation applied to specific products.

Preferably, the conservation required to offset the impacts on the environment and the impacts affecting human conditions for the product 1, the service 2, the organization 3 or the person 4 to be evaluated in step ii., preferably the damaging impacts on the environment and the damaging impacts affecting human conditions, can be selected from at least one of the following groups:
human condition conservation,
wildlife area conservation,
watershed area conservation,
carbon sequestration,
soil and sediment conservation,
soil and surface water pH restoration,
dike protection of coastal areas at risk of flooding.

Preferably for each damaging impact the corresponding conservation impact type needs to be applied in matching EH impact amounts. For example 1 ton carbon dioxide sequestration needs to be applied to neutralize the emission of 1 ton carbon dioxide. However, insufficient C-sequestration capacity may be available as TTC, while more wildlife conservation capacity is available as TTC than is in current demand. Under those conditions conservation types can be swapped as long as the dollar amounts applied remain the same. It has to be understood, that also a combination/combinations of several of the aforementioned groups is/are possible. Nevertheless, it is sufficient if at least one of the aforementioned groups is used to offset the negative impacts as long as the matching type of conservation for each type of EH damage are not available.

Moreover, the step ii. shown in FIG. 3 can comprise the step of quantifying based on the predefined evaluation variables V, the impacts for cultivated area and/or biodiversity change.

Alternatively or additionally, the step ii. of the method can comprise the step of quantifying based on the pre-defined evaluation variables V, the impacts for climate change and/or fresh water use and conservation. Thus, of the pre-defined evaluation variables V, different groups regarding the environment and regarding human conditions can be used.

Furthermore, step ii. comprises preferably the step of measuring pre-defined evaluation variables V for at least one of the following groups:
human conditions,
human reproduction,
cultivated area use,
biodiversity change,
climate change,
fresh water use and conservation,
soil and sediment use and conservation,
soil and surface water acidification and/or pH change,
coastal area use and conservation,
infectious disease prevention and mitigation,
atmospheric ozone layer damage and conservation.

It has to be understood, that it is possible that a combination/combinations of the aforementioned groups for the pre-defined evaluation variables V can be used. However, it is also possible to use the pre-defined evaluation variables V of at least one of the aforementioned groups. Herewith, every single combination of the aforementioned groups is disclosed.

More preferably, in step ii. of the method the quantification of impacts is based on at least three types of environmental supply chain steps, namely,
individual supply chain steps for quantifying the impacts of persons 4,
product supply chain steps for quantifying the impacts of manufactured products 1 and rendered services 2, and
rating supply chains steps for estimating the impacts of location based impacts, labor of person 4, products 1 and services 2 not evaluated previously.

The different supply chain steps can be used together with the pre-defined evaluation variables V to first quantify EH impacts and second to neutralize the impacts in question.

The novel and non-intuitive aspect of a PSCS is preferably that all employee labor outputs of an ISCS are inputs to the PSCS, while employee labor outputs can never be inputs to an ISCS.

Preferably, in step iii. of the method, the required conservation determined in step ii. of the method is automatically applied, preferably limited to availability, with regard to the price of a product 1, the service 2, the organization 3 or the person 4 for the product 1, the service 2, the organization 3 or the person 4 to be evaluated. More preferably, the conservation is applied with regard to at least one human condition, wildlife area, watershed area, amount of carbon, soil or sediment, soil and surface water pH, and coastal areas at risk of flooding. Alternatively or additionally, preferably with regard to EH impacts and/or impacts groups, in particular human condition conservation, soil and surface water acidification, wildlife area conservation, watershed area conservation, carbon sequestration, soil and sediment conservation, dike protection of coastal areas at risk of flooding. Thus, the required conservation to offset or neutralize the negative or damaging impacts can in particular be applied automatically. This enables that the sustainability of the product 1 or the service 2 or in extension of person 4 can be reached immediately or in due time.

Preferably, the conservation is also actually applied and not only to the price.

In particular, the conservation is applied to amounts available. Preferably, the amounts available for each type of conservation will initially be zero and at a later stage be only a fraction of the conservation that should be required to render the product 1 or service 2 free of EH impacts.

In addition to the above, it is in particular not enough to only:
quantify EH impacts
quantify corresponding conservations needed to render the product “free of EH impacts”
calculate the costs of such conservations
pay the costs of such conservations

The combination of the above four aspects is in particular no limiting factor. Participants, buyers and sellers in particular need to meet various conditions (6 to 8 each) to allow a pending transaction to proceed as a sustainability enabled transactions (SEFT). These conditions can include being a Metrics participant, buying and selling a rated product 1, having financial account types that can support Metrics transactions, having accounts with an impact rating organization (IRO) and an EH conservation fund organization (ECFO), having the required product scanning equipment, other electronic hardware and chip cards to carry out the data transmissions, having sufficient IFFA funds to allow the transaction and having additional funds for TTC to apply towards the product purchased. These above conditions are instantly checked and form a “trigger mechanism” where the trigger is only activated when all conditions are met.

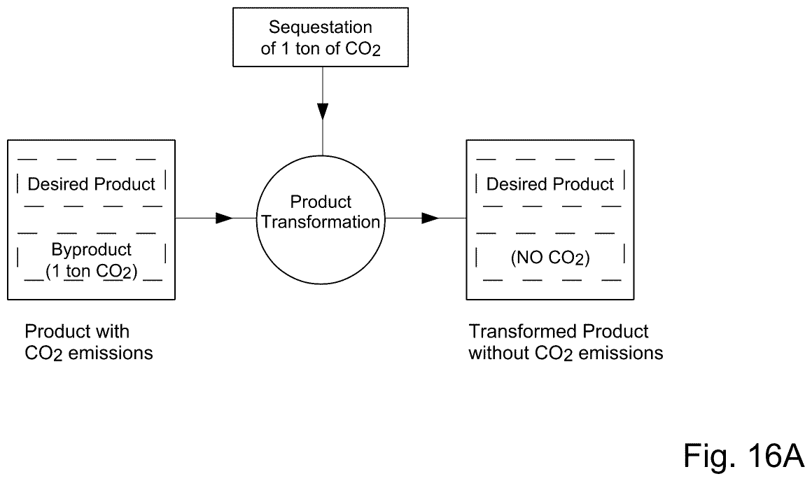

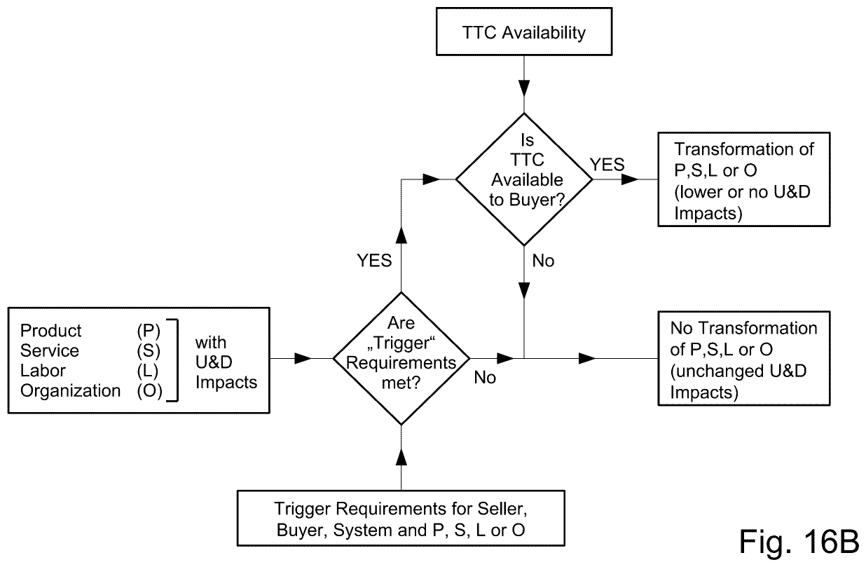

Only when the trigger is activated, the transaction proceeds as a SEFT. Following this SEFT, an amount of TTC is purchased in a secondary transaction, where the TTC amount purchased depends of TTC availability. During the secondary transaction the conservation is applied to the specific product 1 purchased, transforming the product 1. The triggering process is preferably thus an essential element allowing the transformation and binding the conservation to the product 1 being purchased. Such transformation is in particular shown in FIG. 16A and FIG. 16B.

In addition to all of the above, the following two requirements in particular need to be met:
the payment of the conservation costs must preferably be triggered by the purchase of a (rated) product in a transaction between participants
conservations in particular need to be applied to the product (limited to availability), either:
   Immediately. In this case the amount of conservation originates from amounts “held in reserve”: an amount of conservation already applied but not yet assigned to a product 1 or service 2 (e.g. 1 kg of CO₂ removed from air, sequestered under ground not yet assigned to a product 1 or service 2).
On delivery. The conservation is purchased “on long term contracts” (say 1 kg of CO₂ to be sequestered underground two years from now).

Note that in particular the amounts of conservation not yet assigned to a product 1 or service 2 but already applied or to be applied in the future are only applied because the conservation organization expects or already has purchase contracts for such conservations.

Without purchase contract for such conservation or without the expectation of receiving such contracts, the conservation organizations would not apply such conservation. While there will be some timing difference between receiving the contract for conservation and the actual application of the conservation, the exact amounts of conservation applied are directly connected with the specific product item (say a gallon of milk) to which they are applied.

In both cases the conservation can be applied in full (if available) or partial (if supply is limited). In particular, it has to be noted that the conservation can also be applied to the “labor product”, preferably meaning that the conservation can be applied to an individual. Preferably, under the Metrics, the output of an ISCS is in particular the product of someone's labor.

Payments for conservation, although often vague with respect to how they will be spent, are made all the time. Preferably, wildlife area conservation can be provided by wildlife conservation organization under “vague” conditions, will operate in parallel to wildlife area conservation provided by certified NPOs where only NPOs are allowed to issue TTC for wildlife area conservation.

In particular, any payment for conservation not directly triggered by and linked to a specific purchase made would in particular be treated under the method and/or the Metrics either as a conservation amount held “in storage” to be used for later application as TTC to a particular product, service or individual or (as currently) as a charitable donation of such conservations and would not count towards any change in product, service or individual sustainability. In all cases, each purchase of conservation in particular needs to be specific and must exactly describe the amount and type of conservation and the product, service or individual to which the application will be assigned.

Furthermore, the evaluation variables, in particular the pre-defined evaluation variables V, are organized and/or stored in a metrics database. This database can be used to carry out the inventive method, in particular the steps i. to iii. The metrics database can further be used to distinguish the different variables and to assign the determined values to the variables to calculate and/or determine the EH impacts and the sustainability value. The metrics database can in particular help to measure quantitative data, in particular with regard to the sustainability.

The evaluation variables, in particular the pre-defined evaluation variables V, are measured in terms of allowance values, historic damage values, current damage values and conservation values, and preferably compared against reference and representative conditions.

In particular, in the scope of the present invention the concept of a “variable” can include the variable name, the variable description, the symbol itself and/or the unit and measured, calculated otherwise assigned value.

Reference conditions can be defined as the 100% sustainable conditions for products 1, services 2 and individuals 4 for each of the Metrics variables. Reference conditions can be defined for environmental resource use, current damage and for historic damage impacts and calculated on a per capita basis and can be expressed in the specific units for each variable.

In addition to the above, for current damage variables, representative conditions can be defined as the 0% sustainable conditions for products 1, services 2 and individuals 4 and can be expressed in the specific units for each variable.

Examples are the use of cultivated area, use of precipitation or watershed area and the use (i.e. deterioration and loss) of soil and sediments. Reference and representative conditions can be also defined for human condition's variables. Reference and representative conditions are in particular the key to the calculation of individual and product sustainabilities.

In a further preferred embodiment of the invention the method runs computer-implemented. Therefore, the method can in particular be carried out via at least one computer using a computer program product which is designed to carry out the aforementioned steps of the inventive method. The computer enables to carry out a fast, comprehensible and storable way of the method to determine the sustainability value.

Further, the method can allow the comparison of sustainability values of products 1, services 2, organizations 3 and/or persons 4 of the same kind or different kinds. Thus, it is possible for the consumer to distinguish between non-sustainable products 1 or organizations 3 and sustainable products 1 or organizations 3. The same relates also to services 2. Furthermore, the comparison of the sustainabilities of the persons 4 can in particular be used to reach a sustainability for all persons 4. For example, the sustainability of a person 4 can be connected to other possible ways to ensure that the sustainability can be reached. For example, the sustainability of a person 4 can be connected to a tax system and/or other methods which affect the working or personal life of the person 4. Thus, incentives could be provided to improve the sustainability of the person 4.

In a preferred embodiment, in the inventive method and/or system the so called “VICATS” procedure is carried out and/or can be carried out. VICATS can in particular include the following six steps, wherein the steps are performed preferably in the given order: providing an evaluation system of predefined evaluation variables (V), determination of EH impacts (I) using the predefined evaluation variables, determination of the amount of conservation (C) required to remove damaging impacts, determination whether required conservation can be applied automatically (A) and as part of the Metrics system, transformation (T) of the product by automatic application of a conservation and determination of a product sustainability (S).

More preferably, the steps of VICATS are:
(V) providing and/or establishing an evaluation system on the basis of pre-defined evaluation variables, which evaluation system is appropriate and/or configured to
assign impacts on the environment and impacts affecting human conditions for the product 1, service 2 or the person 4 to be evaluated, and/or
(I) quantifying, on the basis of the pre-defined evaluation variables, impacts for the product 1, service 2 or the person 4, to be evaluated, and
(C) quantifying, on basis of the quantified impacts, an adequate conservation that should be applied to the product 1, service 2 or salary of person 4, and
(A) Determination on basis of participation status of parties involved, financial account types used and/or availability of conservation at time of transaction, whether the transaction can be carried out as an automated sustainability enabled transaction, and/or
(T) applying (in particular limited to availability) for transactions qualifying as sustain ability enabled, the quantified conservation to the product 1, service 2 and/or salary of individual 4, preferably de facto transforming the product 1, service 2 and/or individual 4 into a more or fully sustainable product 1, service 2 and/or individual 4. Such a transformation is in particular shown in FIG. 16A and FIG. 16B.
(S) assigning, on basis of the quantified impacts, a specific sustainability value to the product 1, the service 2, the organization 3 or the person 4 to be evaluated.

Due to the present invention, it is preferably made possible to determine the quantification of EH impacts on a per product basis, the granular availability of all required types of conservation and/or the linking of the application of conservation to a particular transaction and in particular the resulting ability to calculate a sustainability.

Without the “trigger” step A, conservation is in particular unlikely to be applied at all, the timing is preferably disassociated from the transaction event, conservation can be applied to non-qualifying transactions and conservation applied cannot be linked to specific products 1 or services 2 bought or individuals 4 who applied it.

Therefore, the most inventive aspect of these sex steps is preferably the realization that “trigger” step (A) which is preferably required to link the application of conservation to the products 1 and services 2 transacted and/or to salaries of persons 4 paid

In a further preferred embodiment of the inventive method, in the method a triggering procedure in particular to apply conservation can be provided. Preferably, the triggering procedure comprises the following steps:
the occurrence of a transaction between two participants; and/or
a transaction with known EH impacts; and/or
the hardware and software system infrastructure to carry out a SEFT; and/or
the use of money free of EH impacts; and/or
use of sustainability enabled accounts; and/or
a calculated positive value for a required conservation; and/or
the market availability of the conservation required.

In particular, participants of the inventive method can agree to the automatic purchase of conservation, preferably if triggered by the above conditions. It is in particular the conservation applied and triggered by this mechanism that transforms a product 1, service 2 and/or salary paid to person 4 from non-sustainable to more sustainable or to fully sustainable. Preferably, the realization that such trigger mechanism can remove EH impacts can be needed to transform a product to one more or fully sustainable one. Such a transformation is in particular shown in FIG. 16A and FIG. 16B.

The use of such a triggering mechanism to apply conservation to a specific product, service or to specific labor allowing the transformation to partially or fully sustainable products, service or labor, is not known to those skilled in the art and can be an essential inventive concept.

The inventive method and/or the inventive system can also apply to money and/or assets in an impact rated financial account (so called IRFA), preferably by applying conservation in a conversion to impact free money while in transfer to an impact free financial account (so called IFFA).

Products can clearly be “of different kinds”. In particular, the Metrics and/or the method can treat persons as “of different kinds”. For example, children are treated differently, since they will have age dependent allowances assigned to their parents. For women, a higher than replacement rate of children (still alive) birthed by a woman is not assigned as a non-sustainable condition to the woman but to the collection of males in her region. A lower than replacement rate of children (still alive) birthed by a woman will lead to an additional allowance (cultivated area use, water consumption) for the specific woman.

Preferably, the method allows to assign a commercial price, value and/or salary and profits paid to the persons 4, product 1, the organization 3 and/or the service 2 to be evaluated, in particular an objective commercial price and/or objective salary, value and/or profits paid. This price and/or this salary and profits paid can therefore be designed in such a way that a partially or fully sustainable product 1 or service 2 can be offered. Further, this enables that there are more chances for sustainable products 1 or services 2 to be bought for the reason that non-sustainable products 1 or services 2 will have a higher price.

The commercial price can in particular include the salaries and/or profits connected to the product 1, the organization 3 and/or the service 2 to be evaluated. Preferably, the employee labor, which can be taken into account for the commercial price, can be treated as a pure labor service while investing can be treated as a financial service.

In particular, the quantification of impacts can be based on environmental supply chain step outputs which can comprise an environmental supply chain block one or more of supporting absorption or deduction blocks and/or a supporting calculation method. By taking at least one of the aforementioned environmental supply chain blocks into account, the quantification of impacts can be improved.

Preferably, the environmental supply chain outputs can represent the impacts of the labor product of an individual supply chain step and/or the impacts of the manufactured product 1 or service 2 of a product supply chain step and/or the rated impact values of a rating supply chain step representing previously unrated inputs of a product or individual supply chain step.

Alternatively or additionally, the environmental supply chain output can be calculated as the environmental balance over the environmental supply chain step.

Moreover, the method can further be designed to operate financial accounts holding a plurality of items, like money, assets or products. In particular, in the method an account expressing a plurality of EH-variables can be taken into consideration. The considered EH-variables can include at least one variable representing the non-sustainable asset value (NSAV), wherein a remainder can represent environmental and human impact variables. Further, the method can be able to calculate the monetary value of the EH-impacts CW_{Account, Amount} of the account—in particular as a function of EH-variable values and the unit cost of conservation of the fraction of the account to be converted. Finally, the method can preferably be able to calculate the EH liability free asset value (EFAV) of the amount to be converted by adding CW_{Account} to the NSAV.

In a further preferred embodiment of the invention, the method can include the trading of sustainable available unused resource use allowance (SAURUA) fractions. In particular, in this embodiment the method is able to determine the size of the unused resource use allowance fractions which are in particular sustainable available and can approve such fractions for sale. Therefore, a marketplace can be used where SAURUA fractions can be traded. Further, a platform can be used where individuals 4 can set ask and bid prices for SAURUA fractions. Preferably, SAURUA applies to lower income individuals 4 who did not use all of their individual allowance and can trade the remainder for income, reducing or eliminating poverty.

Especially, a trade execution process can be included in the method to effectively implement the SAURUA fraction exchange when the bid price is above the ask price and otherwise meeting conditions. In particular, an arbitrage board overseeing and approving all aspects of the SAURUA trading process can be provided.

The invention also relates to a system.

The system is in particular visualized by the interaction of the different steps i. to iii. shown in FIGS. 1 and 3. Therefore, also the system can be described with regard to the figures. The system can comprise the steps a. and b., wherein the step a. can be realized by the capability of carrying out the step ii. of the method. The step b. can be configured in such a way that the system is configured to carry out the step iii. of the method.

The system is used to determine and/or to evaluate a sustainability of a product 1, a service 2, an organization 3 and/or a person 4. Moreover, the system is configured to carry out the method which has already been described in detail.

In particular, the system is configured to quantify on the basis of pre-defined evaluation variables V the impacts on the environment and the impacts affecting human conditions for the product 1, the service 2, the organization 3 or the person 4 to be evaluated.

Further, the system can be configured to assign, on the basis of the quantified impacts, a specific sustainability value to the product 1, the service 2, the organization 3 or the person 4 to be evaluated.

In particular, the so-called “Metrics system” or “Metrics” which is described in the present application can be regarded as the inventive system. The system is configured so that at least one of the aforementioned features of the method can be carried out.

In particular, the system can ensure the partial or complete removal of damaging impacts on the environment or on the people and provide conserving impacts to render natural resource use sustainable and maintain and/or improve humane conditions.

With regard to the preferred embodiments and advantages of the system, reference can be made to the further explanations with regard to the inventive method which can relate in the same way also to the inventive system.

In particular, the inventive system can ensure that a transformation from non-sustainable products 1, services 2, organizations 3 or persons 4 into sustainable ones can take place. This transformation can use the application of conservation to the products 1, services 2, organizations 3 or persons 4 which can be determined based on the individual and product sustainability values.

Preferably, the system can be configured to quantify damaging impacts on the environment and damaging impacts affecting human conditions for the product 1, the service 2, the organization 3 or the person 4 to be evaluated and further to determine a conservation, and optionally its costs, required to neutralize the damaging impacts and/or the use of resources.

Moreover, the system can be configured to select the conservation prior to offset the impacts on the environment and impacts affecting human conditions for the product 1, the service 2, the organization 3 or person 4 to be evaluated in the aforementioned step of assigning the sustainability value of the system from at least one of the following groups:
human condition conservation,
wildlife area conservation,
watershed area conservation,
carbon sequestration,
soil and sediment conservation,
soil and surface water pH restoration,
dike protection of coastal areas at risk of flooding.

The system can be configured to measure the pre-defined evaluation variables V for the cultivated area and/or the biodiversity change. In particular, the system is configured to measure the pre-defined evaluation variables V for climate change and/or fresh water conservation. The aforementioned groups for measuring the evaluation variables V can be implemented alone or together as a combination.

In particular, the system can be configured to measure the pre-defined evaluation variables V for at least one of the following groups:
human conditions,
human reproduction,
cultivated area use,
biodiversity change,
climate change,
fresh water use and conservation,
soil and sediment use and conservation,
soil and surface water acidification and/or PH change,
coastal area use and conservation,
infectious disease prevention and mitigation,
atmospheric ozone layer damage and conservation.

It has to be understood, that also at least one of the aforementioned groups can be used as well as a combination. In particular, all of the aforementioned groups for measuring the pre-defined evaluation variables V are used in the present system.

Further, the system can be configured to quantify said impacts on basis of three types of environmental supply chain steps, namely
individual supply chain steps for quantifying the impacts of persons 4,
product supply chain steps for quantifying the impacts of manufactured products 1 and rendered services 2, and
rating supply chains steps for estimating the impacts of location based impacts, labor of persons 4, products 1 and services 2 not evaluated previously.

The system can be configured so that the conservation determined with regard to the price of the product 1, the service 2 or the person 4 can be automatically applied, preferably limited to availability, to the product 1, the service 2, the organization 3 or the person 4 to be evaluated. Preferably, the conservation is also actually applied and not only to the price.

In particular, the conservation is applied to amounts available. Preferably, the amounts available for each type of conservation will initially be zero and at a later stage be only a fraction of the conservation that should be required to render the labor, product 1 and service 2 free of damaging EH impacts.

As already outlined above, the system can comprise a metrics database in which the evaluation variables V are organized and/or stored. This database can be used to determine the EH impacts and the sustainability values. The metrics database can in particular help to measure quantitative data, in particular with regard to the sustainability.

The system is further configured to measure the evaluation variables V in terms of allowance values, current damage values, and historic damage values, and, preferably, to compare the evaluation variables V against reference and representative conditions.

It is not shown that the system can comprise a processor and/or computer configured to execute the method of one of the aforementioned embodiments. The processor and/or computer can comprise a computer program product which enables the execution of the aforementioned embodiments of the method.

The system can further be configured to compare the sustainability values of products 1, services 2, organizations 3 and/or or persons 4 of the same kind or different kinds. Therefore, it is possible to determine which of the aforementioned products 1, services 2, organizations 3 and/or persons 4 is sustainable or what the costs are to make it sustainable.

Preferably, the system is configured to assign a commercial price, value and/or salary to the persons 4, product 1, the service 2 and/or the organization 3 to be evaluated, in particular an objective commercial price, value and/or salary. This commercial price can include the EH impact values from which the sustainability value and required conservations can be calculated. Application of the required conservation can further neutralize the damaging impacts of the product 1 service 2, salary of person 4 and/or organization 3. Thus, the price or salary can include also the costs required for the conservation and thus for the improvement of the sustainability.

In particular, an objective value for an organization can be used to determine a sustainable value for the company stock and bonds issued, in particular an objective commercial value.

In a further preferred embodiment of the invention, the system is configured for trading in entities representing title to conservation (TTC) in particular as outlined above. The system can therefore be configured to determine the value of the variables underlying the type of conservation expressed under standardized conditions. Further, EH impact rating organization(s) can be used to determine the value of variables, in particular the value of the variables underlying the type of conservation required and expressed under standardized conditions.

Preferably, the system can comprise a platform where EH conservation fund organization(s) (ECFO) can offer various types of TTC for sale and set an ask price and where buyers can set bid prices for various types of TTC. More preferably, the system can comprise a marketplace where TTC can be traded using a trade execution process to effectively implement the TTC exchange when the bid price is above the ask price and otherwise meeting conditions. In particular, an arbitrage board overseeing and approving all aspects of the TTC trading process can be provided for this preferred embodiment of the system.

Furthermore, the invention also relates to the use of a system of one of the aforementioned embodiments for determining and/or evaluating a sustainability of a product 1, a service 2, and organization 3 and/or a person 4.

Alternatively or additionally, the invention can also relate to the use of a method of one of the aforementioned embodiments or a system of one of the aforementioned embodiments for establishing a sustainable economy. A sustainability/sustainable economy can in particular be reached by changing sustainabilities, measuring the sustainability and in particular with regard to a taxation or taxation alternative concerning the sustainability.

In the following, the inventive method is described in more detail, in particular with regard to the impacts and the different variables used in the inventive method. The following explanations can be used for the system as well as for the method.

It has to be understood that the following explanations can in particular include facultative features which can be combined with at least one of the aforementioned features. The following explanations do not limit the scope of the inventive method or the inventive system:

In the following, when using the term “product” this explanation can preferably be applied to products 1, in particular products, as well as services 2 or vice versa. In particular, in formulas used and in the description of formula variables and terms, the term “product” is used while typically meaning “products and/or services”. In particular, when using the term “labor” reference is made to the output of an ISCS.

In particular, all variables for current and future use can be categorized as at least one of three types:

### Allowance Variables:

Variables for which less than a maximum amount can be consumed per individual. The per capita and variable maximum amount calculated is referred to as “the allowance”.

### Current Damage Variable:

Variables without an allowance reflecting current damage for which the variable value should be reduced to zero.

### Historic Damage Variables:

Variables used for restoration of environmental conditions in order to return to year 1750 conditions (as good as possible) for which a minimum requirement exists. The requirement amount is defined for the reference individual and corrected for the ratio of actual over reference income.

The use of these three types of variables can allow per variable comparison against reference and representative conditions and can allow different calculation methods for each variable type. Such calculations can be used for absorption of “natural resource using”, “damaging” and “conserving” impacts as personal sustainable absorption. Following this step it also can allow calculation of the outflow of the remaining (mostly) damaging impacts with the labor output as input to the PSCS. The categorization of all variables used as one of these three types of EH variables for the purpose of sustainability calculations can be an essential inventive concept.

Quantification of EH-impacts allows the calculation of sustainability values for labor, product 1 and services 2 and listing of such data on marketed products 1, brochures for services 2 and in their associated product data sheets. Using known cost of conservation for all resource use and damage impacts, all EH impacts of products 1, services 2 and labor can be expressed as EH liabilities (for resource use and damage impacts) and EH assets (for conserving impacts). Buyers can reduce EH impacts of resource use and damage by selecting alternative products 1 and services 2 that use fewer resources or are less damaging. Buyers can increase EH conservation impacts by paying for products 1 and services 2 that include conservation or by buying such conservation independently. For participant sellers, the cost to protect natural resources and humane conditions (EH protection) and the costs of environmental restoration and human rehabilitation (EH restoration) are in particular withheld from the product or service list price. These are referred to as conservation withholding or CW_{Prod}. In turn, the buyer in particular agrees to pay for the costs of EH conservation during a 2^{nd} purchase transaction immediately following the 1^{st}, by buying titles to EH conservation (TTC) for the CW_{Prod} amount withheld. Participating individuals/employees can also agree to have a different CW_{Labor} withheld from their salaries. Such application of CW_{Labor} could lead to a reduction of employee purchasing power and would require a salary increase neutralizing the CW_{Labor} applied. For participating employees, the salary increase can be calculated such that this never leads to a lower net purchasing power compared to nonparticipation. To maintain profit margins, participating sellers would need to increase prices for less sustainable products 1 and services 2. Prices for sustainable products 1 and services 2 will initially remain unchanged but drop over time due to their lower costs.

Initially, most EH impacts reflect EH resource use and damage. Prevention of EH damage always represents lower costs than EH restoration. By implementing EH impact-positive changes (e.g. installing carbon neutral systems, paying a decent wage) individuals 4 and organizations 3 increase the sustainability of their incomes earned and products 1 and services 2 produced, while reducing costs. This results in lower product and services costs, higher profits for businesses, lower costs for governments (possibly leading to lower taxes) and higher purchasing power and quality of life for consumers.

As a consequence of CW, the costs of TTCs purchased and damage prevented by employees are in particular refunded with salaries paid. For employers, the costs of TTC purchased by and reimbursed to employees no longer need to be purchased on the market. The higher prices for non-sustainable products 1 and services 2 will be a driver for reduction of EH resource use and damage and thus increase sustainability. For sustainable products and services, the lower production costs and absence of CW_{Prod} and therefore the ability to maintain the original list price, will increase profit margins.

While limited by supply, title to conservation (TTC) can be purchased essentially free of net cost for participating buyers. This method will drive societies to implement systems with low to zero damaging EH impacts while installing conservation capacity and applying conservation at the highest achievable industrial manufacturing rates.

Initial implementation will in particular start with only a few variables (cultivated area use, biodiversity protection and CO₂ emissions). Early adopter consumers are likely all consumers who feel that sustainability and human conditions are important, especially since participation results in the same (initially) of greater (later) purchasing power. Early adopter producers are likely those producers who already improved the sustainability of their products 1 and services 2 by reducing cultivated area use, protecting wildlife area, reducing CO₂ emissions and protect human conditions within own and supplier organizations 3, but thus far do not receive an additional financial benefit for these efforts other than costs saving. Such early adopter producers are likely to vastly increase market share and thus further benefit from their earlier more sustainable efforts.

The invention can use EH impact variables divided in particular over eleven EH impact groups, with multiple variables per impact group. These eleven impact groups can be designed to cover all currently known EH impacts that are recognized to have a significant effect on the environment or on human conditions. If so needed, the number of impact groups can be expanded in the future.

At full implementation the total number of impact variables used can be likely to be 50 to 100 while using variables from all impact groups. Initial implementation will particularly start with only a few variables and will be in particular expanded once the underlying methods and systems allow such. Under all circumstances the same variables will preferably be used globally at any given time, in particular allowing global use and calculations of variable data between all steps in the supply chain. Use of such globally standardized EH variables covering all significant effects on environment and on human conditions, for the purpose of sustainability calculations, can be an essential inventive concept.

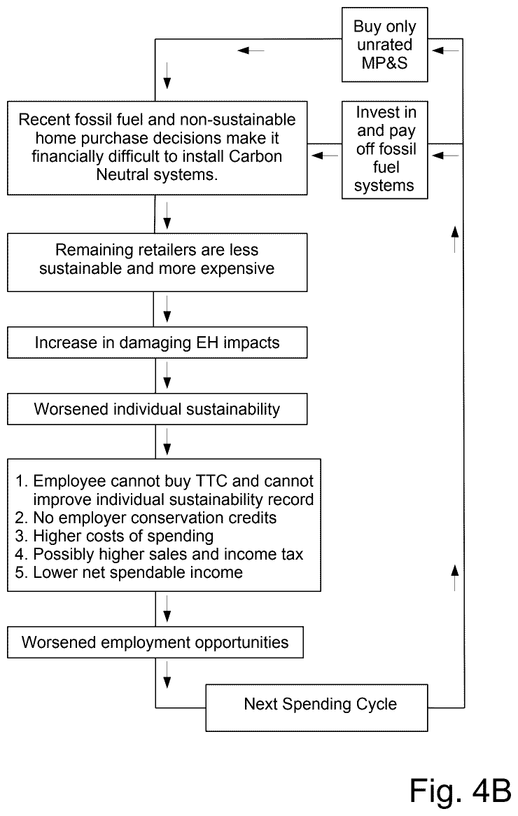

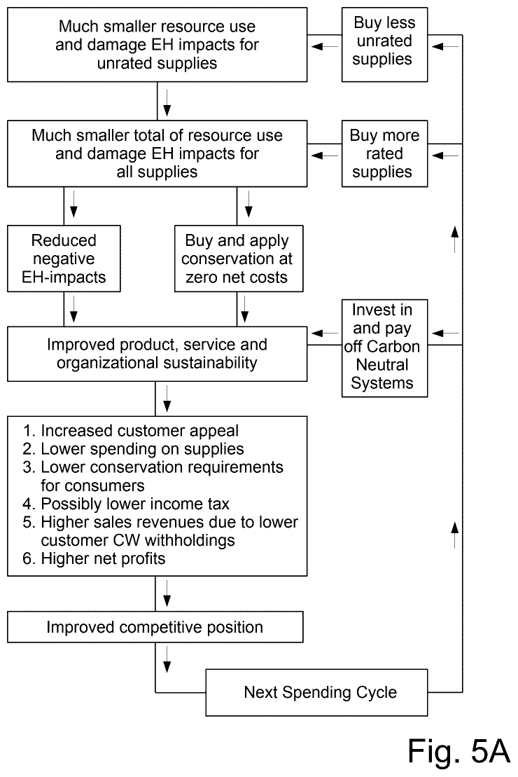

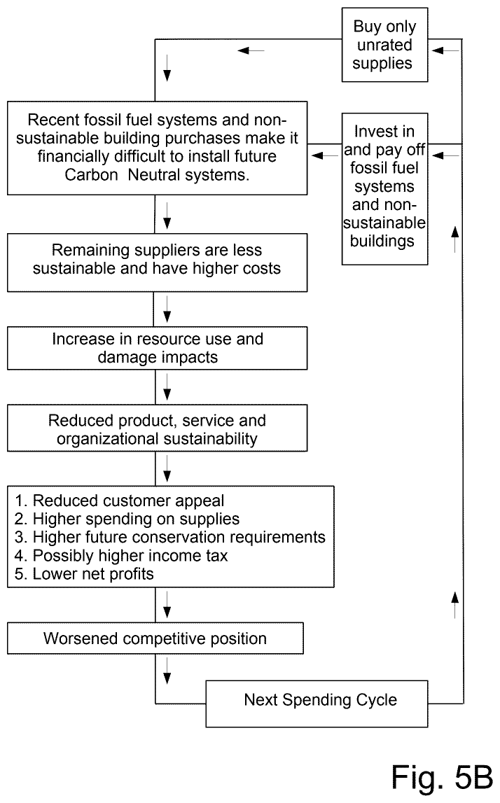

FIGS. 4A and 4B as well as FIGS. 5A and 5B show the method and/or the process of measuring the sustainability, in particular the real time sustainability, preferably by applying CW and the effects of changes in sustainability outcomes for participating and non-participating individuals 4 and organizations 3. FIGS. 4A and 4B depict the sustainability change cycle for individuals 4, in particular showing the deteriorating outcomes for non-participation shown in FIG. 4B and improving outcomes for participation shown in FIG. 4A.

Further, FIGS. 5A and 5B show a sustainability change cycle for organizations 3, in particular showing deteriorating outcomes for non-participation (shown in FIG. 5B) and improving outcomes for participation (shown in FIG. 5A).

The Metrics system quantifies impacts of two types; impacts on the environment and impacts affecting human conditions. The combination of environmental and human conditions and impacts are referred to as environ-human or EH conditions and EH impacts. EH impacts can especially be at least one of the following impacts:
neutral (EH resource use under conditions of sufficient conservation of the EH re source),
negative or damaging (e.g. environmental pollution, wildlife area loss or fragmentation, carbon dioxide emissions, modern slavery and child labor and sweatshop conditions),
positive or conserving (e.g. pollution remediation, wildlife area conservation, carbon sequestration, liberation from human bondage and improvements of humane working conditions).

EH damage represents negative EH impacts and represents EH liabilities, while EH conservation represents positive EH impacts and EH assets. Conservation can represent protection, restoration or both. Neutral impacts represent the use of natural resources at or below sustainable available levels. EH resource use beyond sustainable available levels reflects a negative impact (EH damage) and creates an EH liability.

For persons sustainability is referred to as individual sustainability and distinguished from product sustainability as used for manufactured products 1 and services 2.

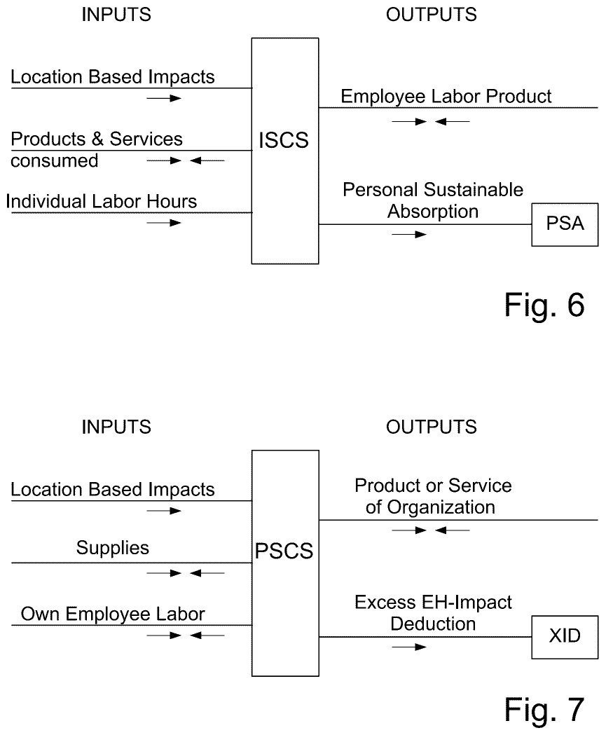

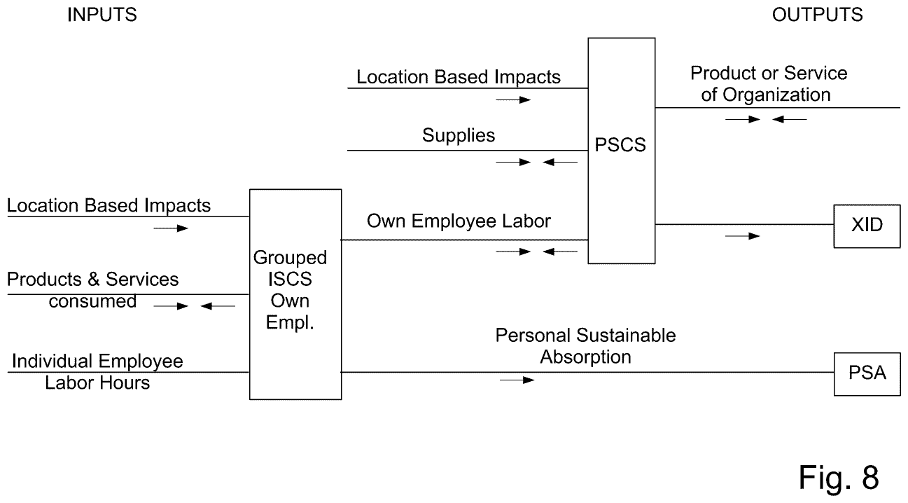

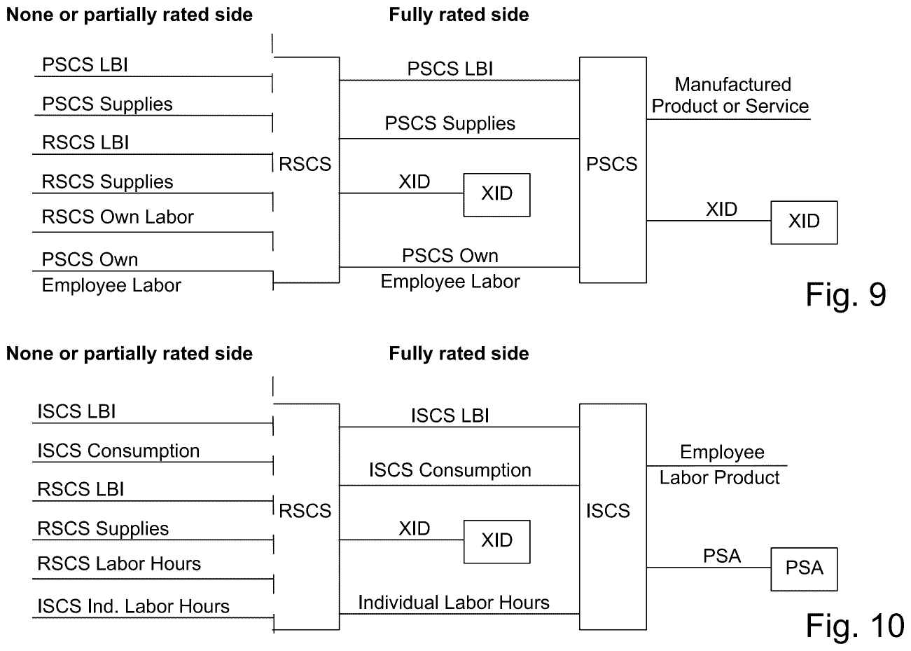

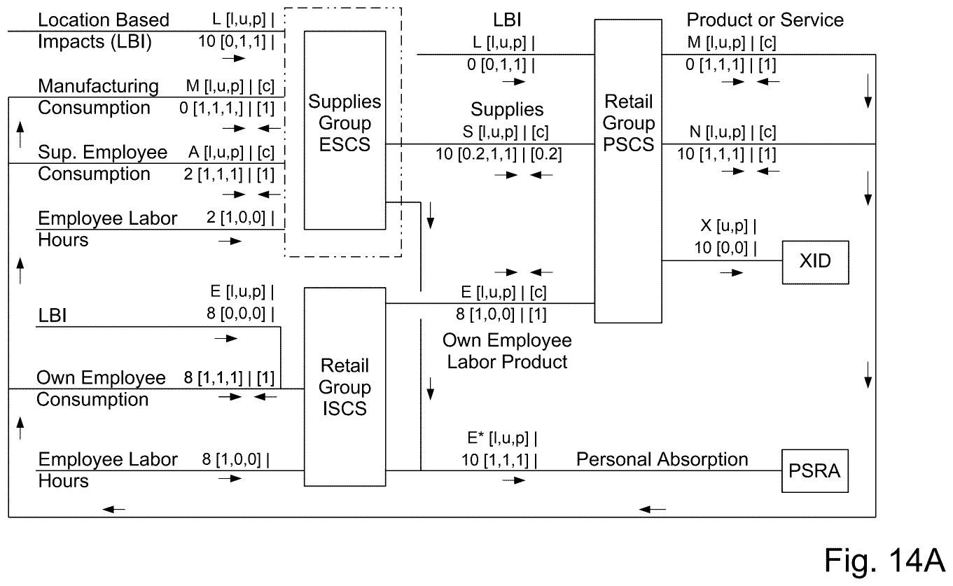

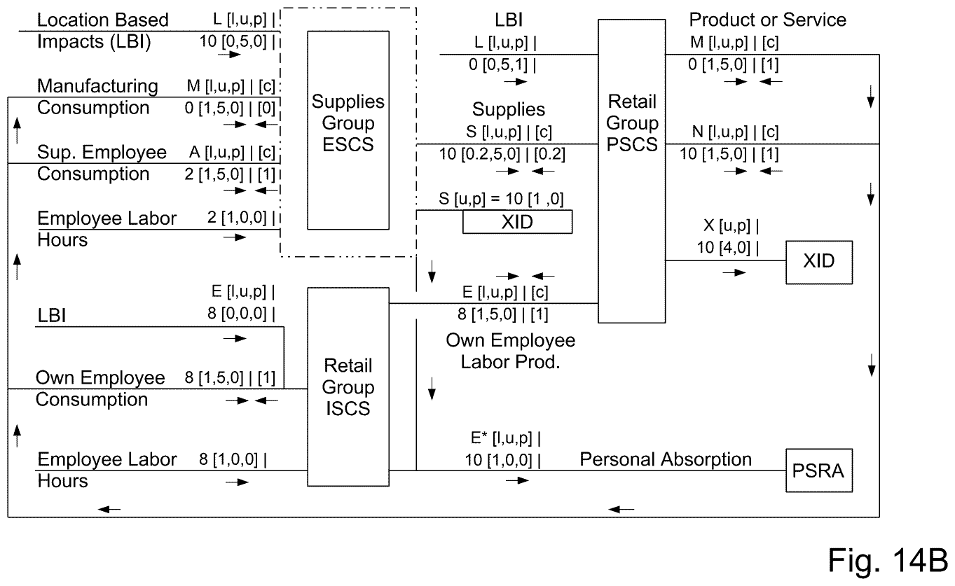

The proposed solution is in particular to use the following overall process as part of the Metrics system (“the Metrics”). This Metrics system can preferably enable at least one of the following steps:
1. Form a Metrics organization 3 to implement, manage and improve the Metrics system.
2. Define the most important environmental and human impacts that need to be included in the Metrics system. Impacts should include effects on human conditions (working and living conditions, education, healthcare, others) and effects on the environment (natural resource use, global warming, environmental and ecological damage) and all associated forms of conservation.
3. Using scientific methods, define the smallest set of globally standardized variables which (in combination) would best express the selected environ-human condition impacts.
4. Define sustainable value ranges for each resource use and damage impact variable. De fine type and adequate amounts of EH conservation for each amount of EH resource use, to prevent environmental damage and biodiversity losses.
5. Develop scientific methods to measure all variables. Base the methods on generally accepted scientific principles and peer reviewed scientific studies. Continuously improve methods when new studies become available. Set up and maintain independent scientific boards for each metric impact group.
6. Prioritize the implementation order of all EH impact variable pairs (resource use and damage versus conservation).
7. Define the types of environmental supply chain steps (ESCS) that are needed to adequately propagate EH impact variable values along the supply chain as:
   a. Rating supply chain step (RSCS) where all EH-impact variables of location based impacts (LBIs) all nonparticipant labor and other unrated products 1 and services 2 that are inputs to the client ESCS are first estimated. This will be based on similar recently rated products 1 and services 2 and labor locally available. The values are then multiplied by an impact uncertainty multiplier (IUM>1) based on the standard deviation of the EH impacts of said products and services. After this quantification, EH variable values for the product and/or service output are calculated using the EH balance over the RSCS. The client labor, product and service inputs evaluated are now classified as “rated”. In particular, this is shown in the FIGS. 9 and 10.
   b. Individual supply chain step (ISCS) representing EH-impacts of the work done by an individual (labor product or labor). The labor EH-impacts (an ISCS output) are calculated using the EH balance over the ISCS based on all rated consumption impacts (inputs) and personal sustainable absorptions (PSA, outputs) that can be assigned to the individual. This is schematically illustrated in FIG. 6.
   c. Product supply chain step (PSCS) representing EH-impacts of manufactured products 1 and services 2 (MP&S). Each MP&S represents either a single product 1 or service 2 or a series of identical products 1 and services 2 made in a single production series or batch and having identical EH-impacts. EH-impacts of MP&S are calculated based on rated EH-impacts of all inputs, and the excess impact deductions (XID), using the EH balance over the PSCS. In this regard, reference can be made to FIG. 7.
8. Define the functional components of each type of supply chain step. This step can in particular be seen in de FIGS. 6, 7, 8, 9 and 10.
9. Quantify the environ-humane (EH) impact values for all standardized variables for all environmental supply chain step (ESCS) inputs. Reference is made to FIGS. 14A and 14B.
10. Develop sustainable condition criteria for individual labor, products and services.
11. Develop standardized methods to calculate ESCS outputs for standardized EH-impact variables.
12. Develop standardized methods to create and maintain EH impact-free financial accounts.
13. Calculate ESCS outputs for standardized variables using standardized methods.
14. Link each ESCS to its neighboring contiguous ESCSs (product outputs of upstream ESCSs are inputs for downstream ESCSs).
15. Invite individuals 4 and organizations 3 to participate (hereafter referred to as participants).
16. Once the above required organizations 3, systems and methods are set up/implemented and participants have joined, the actual calculations can be carried out.
17. Calculate the individual sustainability for participating individuals 4.
18. Calculate the product and service sustainabilities for rated products 1 and services 2 of participating organizations 3.
19. Calculate the sustainability of the organization 3 producing the product 1 or service 2.
20. Calculate the various other metrics that give participants insight into the percentage of currently attainable sustainability goals reached.

Using at least one, preferably all, of the above steps, EH-impacts are expressed especially as function of one or more EH impact variables. Stringing ESCSs together can allow propagation of these impacts along the supply chain, and allows calculation of sustainabilities for product 1, service 2 and individual 4 for every ESCS along the participating environmental supply chain section.

Assigning directionality to EH impacts for labor for Metrics participants and for all products & services, such that all EH impacts flow in end-user consumer (“downstream”) direction, can disallow and thus can prevent the flow of EH impacts in “upstream” direction. This in turn can allow a systematic “quenching” of EH usage and damage with the corresponding amount of EH conservation. In combination with the expansion of the reflective value of money, this can allow the creation of money free of EH impacts.

Method to Transfer Unused Allowances from Low Income to High Income Individuals

Lower income individuals 4 participating in the Metrics and buying products of (over time) increasing sustainability, can be the first to reach individual sustainability for one or more metric impact groups. Unfortunately, this group of “sustainable” individuals 4 is particularly not rewarded for their efforts. A large fraction would in particular continue to live sustainable in poverty. Unless additional methods are applied, these individuals 4 would likely not be interested in participation. The use of a method where low income individuals 4 could sell the sustainable available fraction of their unused natural resource use allowances to high income individuals 4 and would thus provide income to the world's poor and low income population, would also create an incentive for lower income individuals 4 to participate in the Metrics, preferably while reducing (or eliminating) global poverty. This method is not known by those skilled in the art and can be an essential inventive concept.

### Method for Calculating EH Impacts and Corresponding Liabilities and Assets

EH impacts can be first calculated per impact group variable (e.g. carbon dioxide emission and methane emissions) and then combined per impact group (e.g. the carbon dioxide emission equivalent global warming impact). Following this step, the conservation impacts required to neutralize the EH damage for each impact group can be calculated (e.g. the amount of carbon dioxide to be sequestered). Using known costs for conservation, the costs of the restorative impacts can be calculated per metric impact group (e.g. the current costs of the sequestered amount of carbon dioxide). The EH liabilities for the damaging EH impacts can be then set to the value of the corresponding costs of conservation. These calculations can be carried out for each EH impact variable for each product and each income paid. Actual conservations applied can be limited to the EH variables implemented and limited to the conservation capacity available at that time. This method is not known by those skilled in the art and can be an essential inventive concept.

### Metric Impact Groups and Variables

### Impact Groups:

Under the Metrics, EH-impact variables are in particular defined for eleven metric impact groups:
1. Human conditions
2. Human reproduction
3. Cultivated area use (all areas not protected for its biodiversity)
4. Biodiversity change
5. Climate change
6. Fresh water use and conservation
7. Soil and Surface Water Acidification
8. Soil and sediment use and conservation
9. Coastal area use and conservation (protection from changes due to sea level rise)
10. Infectious disease prevention and mitigation
11. Atmospheric ozone layer damage and conservation

Each impact group can represent multiple impacts. Impacts can be using, damaging or conserving. Conserving impacts can be in the same metric impact group or in a different one. For example, the conserving impact for cultivated area use is wildlife area protection which is found in the metric impact group biodiversity change. For most other impacts, use, damage and conserving impacts are preferably found in the same metric impact group.

Impacts can be a function of multiple variables; for example, climate change impacts are represented by a separate variable for each greenhouse gas emitted (carbon dioxide, methane, N₂O, fluorinated gasses). Climate change impacts can be calculated per climate change variable and combined for all variables. Variables used within each impact group can represent a single independent of dependent variable (say the population size of a single species in an area) or a function defined as a rule for taking an input and providing an output.

### Impact Variables:

Three types of impact variables are especially used:
Allowance variables, representing use of natural resources for which a per capita maximum usage exists (the allowance). The use or each natural resource is only sustainable if the use is equal or less than the allowance, while a sufficient amount of the resource is protected in its natural form. Allowance variables represent pairs (or triples) of variables where the first reflects the resource use and the second (and/or third) reflects the protection and restoration of natural resources and systems. The ratios of resource protection over resource use vary per variable. Example pairs and triples:
Use of cultivated area and protection of wildlife area within the same ecoregion, for its biodiversity.
Use of watershed/precipitation area for its water and protection of watershed/precipitation area for its water quality and amount, and protection of forests to allow evapotranspiration.
Use of soil/sediments for cultivation purposes and conservation of soils and sediments such that losses and degradation are less than the local natural rates of restoration or formation.
Use of cultivated area at risk of flooding and dike protection of a cultivated area against flooding such that flooding risks of the cultivated area are very low.
Use of cultivated area at risk of flooding and dike protection of a wildlife area at risk of flooding within the same ecoregion, such that flooding risks of the wildlife area are extremely low.
Current damage variables reflect damage done since a globally set date and include restoration variables. No allowances exist for current damage variables. Examples:
inhumane conditions and rehabilitation to human conditions
current CO₂ emissions and current CO₂ sequestration
current wildlife area loss and current wildlife area restoration
current fresh water extraction (rivers, aquafers) and current restoration of flows and volumes
current damage to and loss of soil and sediments and their current restoration
current loss of coastal land at risk of flooding and their reclamation after flooding
Historic damage variables, reflecting damage done prior to a globally set date (say year 2022). No allowances exit, but instead requirements exist for historic damage variables. Examples:
historic CO₂ emissions and current CO₂ sequestration of the historic emissions
historic wildlife area loss and current wildlife area restoration of the historic lost area
historic damage to and loss of soil and sediments and their current restoration
historic fresh water extraction (rivers, aquafers) and current restoration of flows and volumes
historic loss of coastal land at risk of flooding and their reclamation after flooding

Current and historic damage variables often use the same restoration variables. For each metric impact group, each variable represents a measure for that group. At full implementation, two or more variables representing resource use or damage and at least one conservation variable (from same or different group) will in particular be used to best reflect each environ-human (EH) impact group. At first implementation only a few variables will be used for the total of all metric groups.

### Environ-Human Supply Chain Step (ESCS) Attributes

### Participants:

Under the Metrics system two types of participants can be defined: individuals 4 and organizations 3. All participants other than individuals 4 are categorized as organizations 3.

The Metrics system especially distinguishes two types of products: the product of individual labor (labor product or labor) and manufactured products 1 and services 2 (MP&S) also referred to as products 1 and services 2 (MP&S) or simply as product(s). Labor and products 1 and services 2 are each represented by dedicated environmental supply chain steps (ESCSs), each with inputs and outputs. An individual working for himself (having his own business) is working as an employee for his own organization. The words “organizations” and “producers” are used as synonyms. A producer is usually defined as an organization 3 that makes, supplies or otherwise provides products 1, commodities or services 2 for sale or other distribution. Under the Metrics the definition of producers is in particular extended to all entities providing products 1, services 2 or anything else distributed to others. Governments are in particular producers of laws (a product 1) and services 2. Schools are in particular producers of educational products 1 and services 2. Broadcasting organization 3 are in particular organizations 3 that distribute information via radio, TV, cable or internet. Charities are in particular organizations 3 that provide products 1 and services 2 for the common good. Churches and political parties are in particular organizations 3 that provide ideological products 1 and services 2. Retailers are the producers most of us see on a daily basis.

Obviously, someone receiving money as wages/salary is a worker producing labor. But this concept of receiving income in exchange for producing a labor product is especially extended under the Metrics. Retirees receiving a pension receive this as a delayed payment of income for work done in prior years and continue to be categorized as employees. Under the Metrics (and for the purpose of calculation) the category of employees is especially extended to all individual receivers of income, even if the number of hours worked is low or zero and even in absence of any prior employment history between payer of income and payee (investors, welfare receivers, etc.). In turn and in order to simplify and standardize the Metrics calculations, all payers of income are treated as employers and the receivers of income are preferably treated as their employees.

### Location-Based Impacts:

All environ-human (EH) impacts preferably take place at a specific location somewhere in the world and are referred to as location-based impacts (LBI). LBIs are in particular all EH impacts not yet included in purchases or labor (e.g. use of land as cultivated area, raw material extracted, emissions). Once LBIs are in particular used as input to an environ-human supply chain step (ESCS), they become part of labor or product impacts.

### Environmental Supply Chain Step (ESCS):

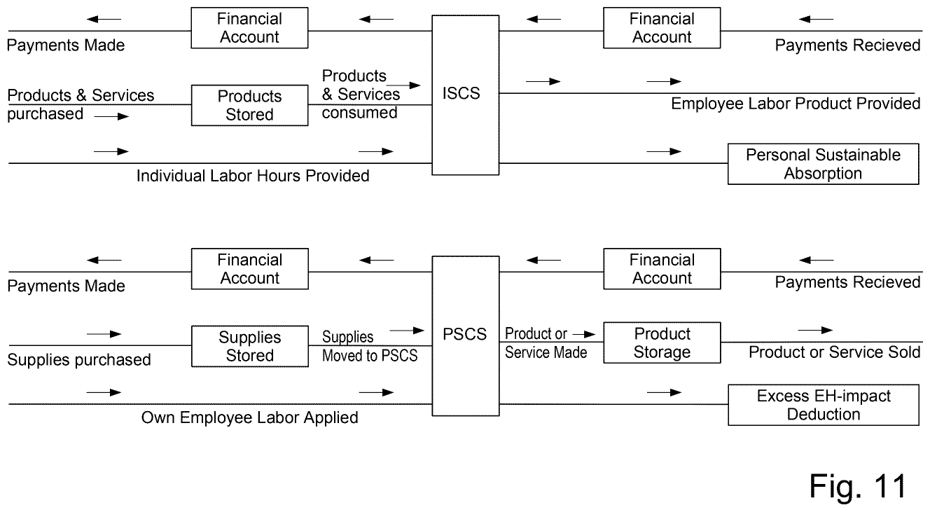

ESCS figures can be read like process flow diagrams (PFD) used in the chemical industry, although there are differences. In process flow diagrams (PFDs) a “single line” represents flow in one direction while two directional flows are represented by a “single line” in ESCSs. Mass flow values for the various chemical components in PFDs are replaced by various EH impact flow values in ESCSs. While mass and energy balances apply in PFD calculation, EH impact and financial balances apply in ECSC calculations. Different to PFDs, where equipment has volume, ESCS elements (unless specified) have no volume. Only designated storage elements have volume (and/or storage capacity) in ESCS figures. The “financial account” blocks shown in the figures, in particular in FIG. 11, at both sides of the supply chain step can represent the same account used for receiving and paying money but are shown twice for clarity. In other figures the existence of these storage blocks is implied but none are shown.

### Individual Supply Chain Step (ISCS):

An ISCS can represent input and output impacts of one individual. ISCSs have in particular three separate inputs: human conditions, EH impacts of products 1 and services 2 consumed and LBIs as shown in FIG. 6. Of all human conditions that can be inputs to ISCS, only the labor hours worked and wages paid are always carried. The human condition input is therefore typically labeled “Individual Labor Hours”. When additional human condition variables representing the ISCS individual are carried, they are carried as part of the same input that carries individual labor hours. Human condition variables values representing other individuals 4 than represented by the ISCS are carried by the other ISCS inputs (“Products and Services Consumed” and “Location Based Impacts”) as shown in FIG. 6. ISCSs have in particular two outputs: personal sustainable absorption (PSA) and the labor product. The PSA can allow removal of matching amounts of EH resource use and EH protection applied from the supply chain. PSA can also allow removal of matching amounts of damage done and restored from the supply chain. Such removal of matching amounts of EH use and damage and EH restoration impact can be needed to prevent supply chain accumulation of such impacts, in particular shown in FIG. 6. Since at early stages of implementation no human condition inputs other than labor hours are used, no other variable symbols or values are indicated for this input.

In particular, by living, humans use natural resources no longer available to wildlife systems.

For example, humans use terrestrial and marine surface area, consumer fresh water and lose and deteriorate soil no longer available to wildlife systems. As long as such resource use for cultivated purposes is combined with wildlife area protection for its biodiversity, such that no biodiversity loss takes place, such natural resource use does not represent damage. However, in addition to such resource use, humans do damage to (have damaging impacts on) the environment and on other humans. By choice, human can also apply environmental restorative and human condition rehabilitating impacts (grouped as EH impacts).

The inventive method particularly does not merely measure all impacts that are consumed (entering the ISCS), but can deduct conserving impacts from sustainable use and damaging impacts.

The deduction of sustainable available resource amounts and their matching amounts of conservation applied can be not only needed to calculate the correct amount of EH impacts that need to be forwarded with the labor output to the PSCS of the employer, but can be also needed to prevent accumulation of EH impacts in the environmental supply chain. The same can apply for EH damage and conservation variables.

The PSA deduction can have a maximum for each allowance variable but can be unlimited for damage variables. Both the allowed deductions and the corresponding amounts of damage can be deducted as personal sustainable absorption (PSA). The balance of EH impacts consumed and the PSA can be carried by the labor output and transferred to the employer for the products made (PSCS labor input).

The realization that the use of such PSA can be needed as well as the corresponding PSA calculation methods required are not known by those skilled in the art and can be essential inventive concepts.

### Product Supply Chain Step (PSCS):

A PSCS can represent the input and output EH impacts of a single product 1 or service 2 or a series of identical products and services. PSCSs have three inputs: labor, supplies and LBIs. PSCS have preferably two outputs, one for the excess impact deduction (XID) and one for the EH impacts of the single or series of identical products 1 made and services 2 provided. In almost all cases waste is in particular produced that needs to be treated by a waste processer requiring more EH inputs and payments. In that case the waste processing becomes an input to the PSCS where the waste was produced. All EH impacts of the process, including the waste produced and treated, can be assigned to the product. When different products 1 and services 2 are created at one location, each can represent a different PSCS. In that case the inputs, XID and waste are assigned to the different PSCSs on an equitable basis (like proportional to sales volume in dollars). Products 1 and services 2 can include fresh water and material withdrawn, consume products 1 and services 2 and their assemblages, real estate, protected wildlife areas, protected water withdrawal areas, sequestered carbon, mineral deposits, financial assets and anything else representing a financial and/or environmental value.

### Representation:

Each labor output can represent a single individual and is the result of individual consumption choices. The individual supply chain step (ISCS) thus can also represent the environ-human (EH) impacts of the individual. This is different for products 1 and services 2 of organizations 3. Participant organizations 3 may not have all products 1 and services 2 rated, especially during the transition period. Products 1 and services 2 part of the same production series can be represented by the same product supply chain step (PSCS). However, products 1 and services 2 following a different route to consumers (via different distributors or retailers) can end up via different PSCSs to the point of sale to end-user consumers and end up with different EH impacts. Products 1 and services 2 can be non-sustainable while made by sustainable organizations 3 (but it is harder to do the reverse). A PSCS can represent the EH impacts of a product 1 or service 2 but does not represent the EH impacts of an organization.

### Single and Bi-Directional Flow:

The wording used for inputs and outputs of environmental supply chain steps (ESCSs) are defined based on flow direction of the entity represented. Materials and supplies consumed as well as products 1 and services 2 produced are indicated in figures to flow in end-user direction; from left to right. Financial investment and loans are supplies to each ESCS (a supply of money) and also flow from left to right. Financial compensations such as salary and payments for products 1 and services 2 purchased, flow in resource (or compensation) direction; from right to left. All products 1, services 2 and labor are inputs to ESCS and flow in end-user direction, while salary paid and payments made for products 1 and services 2 purchased are inputs to ESCS and flow in resource direction, in particular represented in the FIGS. 6 to 8. The term “downstream” is used to indicate the material flow through the supply chain from resource to consumer (left to right in figures), while the term “upstream” is used to indicate the financial compensation flow in resource direction (from right to left in figures).

### Conservation Applied:

Under the Metrics, conservation applied by an individual or organization 3 can be conservation “consumed”: conservation applied cannot be resold or credited to other labor or another product. Humans consume resources, do EH damage directly and indirectly, and can apply EH conservation with the products 1 and services 2 they consume. Products 1 and services 2 store resources used, damage done and conservation applied until the product 1 or service 2 is consumed by individuals 4 or organizations 3.

### Work Hours and Salary:

For individuals 4, labor hours worked and salaries paid are especially among the most important human condition variables. All income received by individuals 4 (e.g., salary, pension, investment returns, welfare, unemployment benefit, gifts) can be treated as compensation, irrespective of hours worked. The world's very poor not receiving sufficient compensation (reflecting inhumane conditions) are preferably treated as workers who should receive welfare. Minors are treated as supported by their parents and will preferably have their individual allowances assigned to their parents. All adults and homeless/non-supported minors (once identified as such) are preferably treated as both consumers and employees under the Metrics.

All costs paid for products 1 and services 2 bought are ultimately income to someone. Therefore, costs paid for products 1 and services 2 made and salaries paid for work done can be treated the same and both are EH impact variables.

### ESCS Lifecycle:

Labor (as the product of work done by an individual) and salary paid change over time, but the same ISCS remains associated with a specific individual for a lifetime. This is not the case for PSCS, which have a fleeting life. Each time a product 1 is sold or a service 2 is provided or an EH-impact not yet included is added to a product or service, a new PSCS is formed. This does not only happen during manufacturing when labor, materials and energy used are added or removed, but also with change of ownership, and during shipment and storage of the product. Each downstream ESCS absorbs/consumes the EH impacts of the labor, supplies and location-based impacts (LBI) added by upstream ESCSs. If possible to do so in advance, multiple “process” steps can be combined in a single PSCS. A PSCS continues to exist in active form as long as one or more of the products 1 and services 2 in the series represented by the PSCS exist. Once all products 1 and services 2 are especially absorbed by downstream supply chain steps (sold, consumed in downstream manufacturing, written off and treated as waste), the PSCS goes especially dormant and can only be accessed for historical data retrieval.

### Display of Variables and Values in ESCS Figures:

With 50 to 100 EH variables in use at full implementation, not all variables or their values can be shown in ESCS without obscuring the figures. The number of variables shown in the figures is therefore limited to the following four: L, Uₘ, Pₙ and C. L and C represent respectively the labor hours worked and the salary paid. Uₘ represents all EH damage and natural resource use variables, while Pₙ represents all EH conservation variables (in both cases for all eleven EH impact groups). Showing Uₘ and Pₙ would represent all variables, while showing the variable symbol without subscripts (U and P) would represent specific variables as specified in the accompanying text. Specific variables could also be indicated using a multiletter subscript specified in the accompanying text. While part of variable groups Uₘ and Pₙ, variables L (labor hours worked) and C (wages or price paid) are two of the most important human condition variables that are always included in the series of four variables shown. Variables L and C also indicate product scale. E.g. for a standard work week of 40 hours, working L=80 h per week would represent excessing labor hours. Analogously, a C=$300 weekly income would represent only 60% of a (say) $500 weekly local “living wage”. When it is known that the employee labor hours spent and income paid were average, a product 1 with L=80 h and C=$1,000 would both indicate that it took two average labor weeks and the average salary to make the product 1 (scaling). Due to their importance for human conditions and scaling aspects, variables L and C are always shown as two of the four variables in figures.

### Directional Grouping of Variables:

The four variables used in text and figures are especially indicated as:

[L,Uₘ,Pₙ]|[C].

The two groups of (three and one) variables are separated by a vertical bar “|”, while in figures arrows below or above the variable groups indicate the flow direction for each variable group. L, Uₘ and Pₙ thus flow in consumer direction (left to right), while C flows in resource direction (right to left). Note that all inputs and outputs are represented by single horizontal lines to indicate variables for which product 1, service 2 and labor flows flow in consumer direction and financial compensation (payments for products 1 and services 2 and salaries) flows in resource direction.

In figures, variable values are written directly above or below the corresponding variable letters. Streams without financial compensation have no value for compensation variable C, and the letter C and number are left out. Since under the Metrics environ-human (EH) impacts are only allowed to flow in consumer direction (left to right in figures), all payments C made by participants must be free of EH impacts.

### Normalization and Normalized Conditions:

Normalization is used in quantum mechanics (where wave functions are divided by itself to return unity) and in other science applications. In quantum mechanics, normalization allows much shorter notations when wave functions are multiplied by different factors (which are often by themselves complex mathematical notations). Normalization simplifies the notation and (can) create unit less terms. Normalization by itself is not anything new, although its use for sustainability supply chains is likely new. Use of normalization in the Metrics, returns variable values under reference conditions that are either zero or unity (depending on the variable type), greatly simplifying the overview of variable values in figures and facilitating its use in formulas. It was the use of normalization in figures and the associated simplification that facilitated the development of calculation rules for PSA (personal sustainable absorption) and XID (excess impact reduction).

Variables can be expressed as absolute values (like cultivated area used in Ha) or as ratios (cultivated area used by an individual divided by the per capita cultivated area allowance). In the latter case, the ratio of units (Ha/Ha) becomes unit less. To allow the required calculations, variables are typically expressed as ratios referred to as normalized (and unit less) conditions and indicated using small letters, while capitals are used for variables using values expressed in units. Expressed under normalized conditions, variables can be expressed as

[l,uₘ,pₙ]|[c]
where l=L/L_{ref}, uₘ=Uₘ/U_{m,ref}, pₙ=Pₙ/P_{n,ref}, c=C/C_{ref}.

Note that in particular for current damage variables no allowances exist and U_{m,Ref}=0, leading to infinite values for uₘ=Uₘ/U_{m,Ref} in case U_{m,Ref} would be used. While reference conditions continue to exist for current damage variables, U_{m,Ref} is replaced by U_{m,Rep}, where the subscript “Rep.” stands for “representative”. U_{m,Rep} is choses to reflect a representative current damage as measured over a representative recent period.

Variables L, Uₘ, Pₙ and C represent the variable values as quantified. L_{ref} and C_{ref} are the 100% sustainable or reference values for hours worked and salary paid. For allowance and historic damage variables, U_{m,ref} and P_{n,ref} represent the 100% desirable or sustainable values, while for current damage variables U_{m,rep} represents the longer term average against which variable Uₘ is compared (called representative value). For example if the global annual per capita carbon (C) emissions are 5 ton carbon per year (U_{C,rep}=5 tC/y) the C-emission impact of an individual emitting 10 tC/y (U_{C}=10 tC/y) would be represented under normalized conditions by

$${u}_{C} = {U}_{C} / {U}_{C , rep} = ( 10 tC / y ) / ( 5 tC / y ) = 2.$$

Variable expression as normalized value is needed for ISCSs to calculate the personal sustainable absorption (PSA), which is in turn needed to calculate the labor output. For PSCSs the use of normalized values is needed to calculate the XID and in turn the resulting EH impacts of products 1 made and services 2 provided.

### Reference Conditions:

The theoretical individual living 100% sustainable with respect to all EH impact variables, working the standard number of hours and earning the per capita global income, can be referred to as living under reference conditions. Normalized reference conditions for the total of all consumption for the reference individual preferably differ per variable type: allowance variables, current damage variables and historic damage variables.
For allowance variables, the normalized reference condition values for the total of all individual consumption (products land services 2 purchased plus location-based impacts (LBI)) can correspond to

$$[ l , u , p ] \vert [ c ] - [ 1 , 1 , 1 ] \vert [ 1 ] .$$

For current EH damage variables, the normalized reference condition values for the total of all individual consumption can correspond to

$$[ l , u , p ] \vert [ c ] = [ 1 , 0 , 0 ] \vert [ 1 ] .$$

Historic damage parameters behave similar to allowance parameters, but with the difference that in order to reach 100% sustainability on the variable, a minimum amount needs to be restored compared to the maximum amount that can be used for allowance parameters. For historic EH damage variables, per capita annual restoration requirements (U_{m,ref}) are calculated based on the technical minimum restoration period. The per capita annual restoration values are further modified as function of individual income c. While U_{m,ref} reflects the historical damage for variable Uₘ for the reference individual,

$${U}_{m , Indi} = {c}_{i} \times {U}_{m , ref}$$

can represent the historical damage for variable Uₘ used for individual i with income cᵢ. Expressed under normalized conditions: u_{m,Indi}=cᵢ. To live sustainable with respect to historic damage variables, all historic damage needs to be restored (p_{m,Indi}=u_{m,Indi}). Normalized conditions, 100% sustainable with respect to conservation for historic damage variables, can correspond to

$$[ l , u , p ] \vert [ c ] = [ 1 , 1 , 1 ] \vert [ 1 ]$$

for the reference individual and to

$$[ l , u , p ] \vert [ c ] = [ 1 , 5 , 5 ] \vert [ 5 ] .$$

for the individual with income

$${c}_{i} = C / {C}_{ref} = 5.$$

### Presumptive and Measured Conservation Ratio:

The world is especially divided in ecoregions; relatively large areas of land or water where the probability of encountering different species and communities at any given point remains relatively constant. In order for cultivated area to be sustainable available, a certain fraction of wildlife area within the same ecoregion in particular must be protected for its biodiversity.

The ratio

$${R}_{Bio} = {P}_{region} / {U}_{region}$$

can represent the lowest ratio of wildlife area (WA) protected and cultivated area (CA) used where biodiversity losses in the particular ecoregion remain zero. In the normalized case, the minimum required wildlife area to be protected is

$${p}_{WA} = {u}_{CA} \times {R}_{Bio} .$$

The ratio R_{Bio} can be a presumptive ratio (default) or a ratio based on actual measurements (after adequate studies). In order to live sustainable with respect to conservation, sufficient wildlife area (WA) especially needs to be protected for its biodiversity.

Primary (1^{st}) and 2^{nd} Order Effects:

Some types of environmental damage in particular affect future environmental damage due to feedback effects. In some cases, it can affect the same type of damage and in other cases different types of damage. For example, anthropogenic carbon dioxide emissions cause both increase growth of forests and global warming (1^{st} order effect). Immediate sequestration of carbon dioxide would prevent both. Any delay in C-sequestration can cause an increase in C-emissions as a feedback due to:
accelerated melting of permafrost and the subsequent release of methane and CO₂ and/or
increased C-emissions due to increased digestion of stored carbon in soils at higher temperatures.

Such increases preferably are added to the individual C-emissions account. Similar 2^{nd} order effects can apply to other types of current damage (e.g. biodiversity loss). Similar to current damage, 2^{nd} order effects can apply to delayed conservation for allowance variables and for delayed restoration for historic damage variables. The determinations of 1^{st} and 2^{nd} order effects especially need to be carried out for all EH variables in all eleven EH impact groups listed above. This implies that emissions of 1 tC not immediately sequestered in particular require a future C-sequestration much larger than 1 tC to reach the same atmospheric effect over the next 200 years.

### Restoration Capacity Effects:

To restore environmental damage, a capacity to restore such damage can be needed, but the prevention of new environmental damage is essential. For example, a section of virgin wildlife area destroyed (cultivated) may take 100 year to recover 50% of its virgin species populations in 100 year and 99% in 300 years if adjacent to an unaffected virgin wildlife area section. For 20% of global land in virgin wildlife condition and 20% of land area under constant wildlife restoration, an annual loss of 0.066% of virgin wildlife area would result in no net restoration of wildlife area. Wildlife area restoration capacity is thus especially limited and requires very low losses of virgin and largely recovered wildlife areas to be effective.

For carbon sequestration the restoration capacity can be limited by the rate at which humanity can build C-sequestration capacity. At a set exponential growth capacity for such systems, year 1750 atmospheric carbon dioxide conditions will be reached after X years, if current carbon dioxide emissions would stop immediately. Any continuation of current carbon dioxide emissions would preferably increase period X to Y, where Y>>X. This increase in environmental damage compared to the immediate cessation of damage needs to be assigned to individuals 4 who continue to cause this damage for each damage variable. This effect will especially be expressed as the cost needed to install and operate the additional C-sequestration capacity needed to reach year 1750 conditions in the X year period. These additional costs can be expressed as equivalent additional C-sequestration requirements (C-emission multiplier).

### Reference Conditions for ISCS:

The total consumption input of individual supply chain steps (ISCSs) can be the sum of products 1, services 2 and location-based impacts (LBI) consumed. The normalized reference condition values for allowance and historic EH damage variables for the total consumption of ISCSs happen to be the same, but can differ for current damage variables.

Reference consumption total for allowance and historic damage variables:

$$[ l , u , p ] \vert [ c ] = [ 1 , 1 , 1 ] \vert [ 1 ] .$$

Reference consumption total for current damage variables:

$$[ l , u , p ] \vert [ c ] = [ 1 , 0 , 0 ] \vert [ 1 ] .$$

Reference PSA for allowance and historic damage variables:

[l,u,p]=[1,1,1].

Reference PSA for current damage variables:

[l,u,p]=[1,0,0].

Looking at the labor outputs of the ISCS to the supply chain step (PSCS) in the figures, normalized reference labor conditions for all three variable types can correspond to:

$$[ l , u , p ] \vert [ c ] = [ 1 , 0 , 0 ] \vert [ 1 ]$$

This means that 100% sustainable labor is always free of EH impacts.

### Individual Income and Sustainability Distribution:

Incomes are not normally distributed either currently or in an on average sustainable society. For a normally distributed income in an on average 100% sustainable world, preferably exactly half the population would live more than 100% sustainable while the other half would especially live less than 100% sustainable. Under those conditions the unused natural resource allowances available to the lower income half of the population are used by the higher income half of the world population.

### Combined ISCS-PSCS:

No single set of normalized reference condition input values preferably exist for the combination of location-based impacts (LBI) and supply inputs to product supply chain steps (PSCS). For each supply chain step the calculation can be carried out for each variable u from the group uₘ and for each corresponding variable p from group pₙ. When shown as a combined ISCS-PSCS, ISCSs are typically shown as a group of ISCSs. The grouped ISCS is used to reduce space requirements in figures. Unless all employees are identical, the personal sustainable absorption (PSA) for allowance variables can especially only be correctly calculated by doing so separately for each individual supply chain step (ISCS), after which results can be combined. Comparing the same variables types, normalized reference product outputs for PSCS have identical impact variable presentations as the normalized reference total consumption inputs for ISCSs:

Reference product 1 and service 2 outputs for allowance and historic damage variables:

$$[ l , u , p ] \vert [ c ] = [ 1 , 1 , 1 ] \vert [ 1 ] .$$

Reference product 1 and service 2 outputs for current damage variables:

$$[ l , u , p ] \vert [ c ] = [ 1 , 0 , 0 ] \vert [ 1 ] .$$

See additional explanation under “Product Portfolio”.

### Use of Multipliers:

For combined ISCS-PSCSs the multipliers E, S, L, M and N are used in combination with the environ-human (EH) variable notation (in particular shown in FIGS. 14A and 14B),

E[l,u,p]|[c],

where each multiplier operates at both sides of the vertical bar “|”. In the above example the multiplier E is used. E=number of own employees, S=units of supplies, L=units of location-based impact (LBI) while N is the number of products 1 and services 2 produced. An individual supply chain step can (in particular shown in FIG. 6) represent a single individual and no multipliers are used. For group-ISCSs, the multiplier E is used for all inputs and outputs (in particular shown in FIG. 14A).

### Product Portfolio:

Individuals 4 consume a large number of mostly different products 1 and services 2 during a year. While a product supply chain step (PSCS) can represent a single product 1 or service 2, or series of identical products and services, it is sometimes easier to visualize the interaction of in- and outflows of individual supply chain steps (ISCS) and PSCS by imagining that this single product 1 is the portfolio of many products 1 and services 2 as consumed over one year by an individual.

In particular, a mix of LBI and supplies is used as input to each PSCS (in addition to labor), but theoretically, only LBI or only supplies could be used (in addition to labor). L and S then represent the number of batches of respectively LBI and supplies used to make these N portfolios, such that S=N when L=0 and L=N when S=0. Using this convention, the values for

[l,u,p]|[c]

in the LBI and supplies inputs to the PSCS are sized in proportion to those used in the (reference or other) product portfolio and can more easily be followed throughout the combined ISCS-PSCS diagram.

While the use of product portfolios facilitates the understanding of supply chain diagrams and calculations, these diagrams and calculations remain the same if used for smaller amounts purchased, with the only difference that all values for

[l,u,p]|[c]

representing inputs and outputs of ESCS are smaller numbers.

Under reference conditions the normalized EH impact variable values for products 1 and services 2 consumed by the individual part of the grouped ISCS can be represented by

$$[ l , {u}_{m} , {p}_{n} ] \vert [ c ] = [ 1 , 0 , 0 ] \vert [ 1 ]$$

for current damage variables. These are the same for the product output of the PSCS, since these are the same products 1 and services 2 (or product portfolios). Analogous and as illustrated in FIG. 14A the reference normal representation for products 1 and services 2 (or product portfolios) for allowance and historic damage variables is especially

$$[ l , {u}_{m} , {p}_{n} ] \vert [ c ] = [ 1 , 1 , 1 ] \vert [ 1 ]$$

and is the same for products 1 and services 2 consumed by reference individuals 4. As explained above, the numerical values for these representations are the same when expressed yearly, monthly or daily and thus independent of the period selected.

### The Actual PSA Outflow is Preferably:

The PSA outflow is preferably equal to E+A [l, uₘ, pₙ] for both current damage variables, allowance and historic damage variables, where E represents the number of own employees and A represents the number of supplier employees.

For simplicity of illustration, the LBI inputs to the ISCS can be set to zero

([l,u,p]_{LBI}=[0,0,0]).

A reference individual renting a carbon neutral high rise apartment would come close to zero LBI inputs, since almost all EH impacts “consumed” are covered by payments made.

### Data Transmission Between ESCS and Database:

All individuals 4 can have a unique identification (ID) number representing their labor that gives access to their ISCS data sheet. This data sheet can be only accessible to the individual. The individual can give the employer (revocable) access to a limited subset of these data. Likewise, each PSCS representing a particular manufactured product 1 or service 2 can have a unique product ID number. Each product 1 copy, part of the same product 1 series, represented by the product ID number in particular must have a unique serial number. The PSCS ID number gives especially access to the product data sheet containing all pertinent data like product ID, description, EH variable values, and serial numbers of all copies in the series. All data sheets of marketed products 1 and services 2 are preferably in turn stored in a database, are public and can be accessed to allow consumers to compare products. During each sales transaction, the unique product serial number tag can be electronically read, linking the product 1 to its product data sheet. During the transaction, all pertinent data are transmitted as a collection of elements

A={a,b,c, . . . zz}

between the seller's terminal, the regional database and seller's and buyer's accounts. The ensuing environmental supply chain step (ESCS) calculations result in a deduction of product environ-human (EH) variable values from the seller's account and an addition of these values to the buyer's account. The EH variable values of the item purchased are not based on the data as provided by the seller (which could be an incorrect data set), but checked against the global or regional database. For every item in the product series sold, the total of unsold items is reduced by one unit during the sale transaction. Selling of products 1 previously sold or selling counterfeits is thus in particular impossible.

### Rating of Unrated Inputs to ESCSs:

EH-impacts of LBIs, supplies and inputs originating from non-participating sellers and nonparticipating employees, preferably first need to be quantified by an impact rating organization 3 (IRO). Each IRO rating for LBIs, a single item or batch of items or for labor, can form its own rating supply chain step (RSCS), providing inputs for a product supply chain step (PSCS) and for an individual supply chain step (ISCS). With increasing societal participation, the fraction of ESCSs in the supply chain can increase (ideally to 100%) and RSCS ratings in particular will be limited to initial location-based impacts (LBI) assessments and periodic updates to cover LBI changes.

In figures, the vertical dashed line indicates the border between the unrated (left) and rated (right) sides of the figure. All impact inputs to the PSCS first pass through the RSCS where they enter as a mix of rated or unrated inputs and exit as rated. The RSCS brings its own impacts for LBI, supplies and own labor The far majority of impacts to the RSCS are client PSCS impacts passing through, while being rated. Unrated impacts consumed by an IRO need to be determined by an independent IRO. The sum of RSCS impacts and original PSCS impacts passing through, form the new supplies impacts to the client PSCS, in particular as shown in FIGS. 9 and 10.

In particular, it has to be noted that while indicted in the FIG. 9 as having all inputs originating from a RSCS, the PSCS can also have inputs from PSCS and ISCS.

Further, with regard to FIG. 10 the following should in particular be noted, namely that while indicated in the FIG. 10 as having only inputs originating from a RSCS, the ISCS can also have inputs from PSCS rated products.

### Rating of Manufactured Products 1 and Services 2 (MP&S):

Within participating organizations 3, dedicated and World Sustainability Metrics Organization 3 (WSMO) licensed software can be used to assign EH impacts to manufactured products 1 and services 2 (MP&S), such that the sum of all EH impacts inputs (from employee labor, supplies and LBIs) can be equal to the sum of all EH impact outputs of all MP&S PSCSs. Where different products 1 and services 2 are made, EH impacts inputs preferably must be distributed based on their consumption, while newly created EH impacts (waste, emissions) especially must be assigned to the different products 1 and services 2 based on the specific generation of such new EH impacts. Data entry in particular will be mostly automated (machine to machine) but especially must be audited on a continuous basis by an independent IRO.

These independent IROs are preferably in turn audited by the World Sustainable Metrics Organization 3 (WSMO) who assigns rating multipliers (>1) as penalties for inadequate auditing, which would apply to all current customers of the IRO.

### Use of Storage Blocks:

Inputs and outputs of environmental supply chain steps (ESCSs) often do not represent continuous flows and where continuous, are not always delivered as a constant flow, while billing is never a constant flow. Individual income earned is in part saved to be spent in later years. Any accumulation of money or assets is a form of financial storage. Products 1 are often stored, or large purchases can be made that are consumed over years or decades (appliances, cars, buildings). Where appropriate and desired, virtual (electronic) storage blocks should be used to even out EH impacts over time. Virtual storage blocks are also used for product outflows in case products 1 are physically stored prior to sale or used for recycling and waste treatment, in particular reference is made to FIG. 11. In most figures, storage blocks are implied but not shown.

### Personal Sustainable Absorption (PSA) Calculation

### Allowances:

In principal, the use of natural resources by humans is especially considered to be environmental damage, unless a sufficient amount of the same resource is protected such that no biodiversity losses would result now or in the future as a result of the resource use. For individuals 4, a certain amount of natural resource use (“the allowance”) is in particular sustainably available for each resource use variable. These allowances are only sustainably available when the required amounts of conservation are applied. Any use of natural resources within an allowance but without sufficient conservation is in particular no longer sustainably available and thus considered environmental damage and unsustainable. Any use of natural resources in excess of the allowance is in particular unsustainable and would result in less than 100% resource use sustainability for the particular natural resource use variable. Even so, conservation corresponding to the total of natural resource use can be still required in order to reach 100% conservation sustainability.

For current damage variables, in particular no allowances exist for EH-damage done. To reach and maintain 100% conservation sustainability, all current damage must especially be fully and immediately restored by applying the required amount of title to conservation (TTC) for the appropriate conservation variables.

Carbon (C) emissions are one form of current damage. C-emissions need in particular to be reduced to zero ASAP. This prevents the need to remove these C-emissions by C-sequestration. In addition, C-sequestration capacity used to offset current C-emissions, can reduce the remaining capacity to sequester historic C-emissions, can increase the restoration period needed to reach year 1750 conditions and can increase the C-emission multiplier used.

Any individual environ-human (EH) resource use above allowances and any current and historic EH damage may not match EH restoration and may end up in the labor output.

For R=1, matching amounts of conservation need to be applied as TTC for natural resource use. For current damage done and historic damage done matching amounts of conservation need to be applied as TTC and are in particular deducted as personal sustainable absorption (PSA) in a PSA block attached to each ISCS. Note that for resource use and current damage done, conservation must in particular be applied at the time of resource use and/or damage done. For historic damage, the required application of conservation may be delayed until sufficient TTC is available. Even so, all resource use and damage done not neutralized by application of conservation creates additional damage due to the 2^{nd} order effects. This damage is calculated and recorded as additional current damage.

### Calculation of Personal Sustainable Absorption (PSA):

The PSA is in particular calculated differently for each of the different types of variables (allowance, current damage and historic damage). The function of PSA is to absorb “conditional matching amounts” of use and damage and conservations impacts applied that should not end up as EH impacts in the labor output. The name personal sustainable absorption (PSA) is used as a general name, but different names are used per variable type:
PSRA: personal sustainable resource use absorption for allowance variables
PCDA: personal current damage absorption for current damage variables
PHDA: personal historic damage absorption for historic damage variables.

For allowance parameters, the allowance can be the per capita environ-human (EH) impact amount that can be used sustainably. However, resource use allowances are only sustainable available if sufficient associated resources are conserved. Any shortfall in conservation applied, in particular results in a proportional reduction of the personal sustainable resource use absorption (PSRA) for the allowance variable. For example; expressed on a portfolio basis over a defined period and applied to the allowance variable cultivated area use u_{CA}, for R_{Bio}=1 and u_{CA,Consumed}=1, the required wildlife area to be protected is p_{WA,Required}=1. If the actual wildlife area protected with consumptions made corresponds to p_{WA,Applied}=0.5, only half of u_{Consumed} was sustainable available and can be absorbed as PSA. In contrast to restoration applied for damage variables (e.g. C-sequestration) excess resource use cannot be undone by restoration, but still requires conservation. For allowance variables, all EH impact amounts used in excess of the sustainable available amounts need to end up in the labor product.

For the use of allowance variables in general, the ratio R_{Bio} defaults to the general ratio R for unspecified allowance variables. For allowance variables the resource use amount that can be absorbed as PSRA is especially:
never more than the allowance: u_{m,PSRA}≤u_{m,Allowance}=1
never more than was consumed: u_{m,PSRA}≤u_{m,All,Consumed}
never more than is sustainable available: u_{m,PSRA}≤u_{m,SA}=MIN
   (u_{m,Allowance}, p_{n,Applied}/p_{n,Reference})

For allowance variables the amount of conservation that can be absorbed as PSRA is:
Never more than is required: p_{n,PSRA}≤p_{n,Required}=u_{m,All,Consumed}*R
Never more than was applied: p_{n,PSRA}≤p_{nApplied}
Never more than applied for
reference consumer: p_{n,PSRA}≤p_{n,Reference}=u_{m,Allowance}*R

For allowance variables u_{n,All}, the PSRA values are:

u_{m,PSRA}=MIN(1,u_{m,All,Consumed},u_{m,SA})

Substituting the above expression u_{m,SA}=MIN(u_{m,Allowance}, p_{n,Applied}/p_{n,Refernce}) gives:

$${u}_{m , PSRA} = MIN ( 1 , {u}_{m , All , Consumed} , MIN ( {u}_{m , Allowance} , {p}_{n , Applied} / {p}_{n , Reference} ) )$$

| | | |
|---|---|---|
| where u_{m, PSRA} = | personal sustainable resource use | [IU] |
| | absorption for allowance variable | |
| | uₘ | |
| where u_{m, SA} = | individual sustainable available amount | [IU] |
| | of resource use for allowance variable | |
| | uₘ | |
| where u_{m, All, Consumed} = | individual resource use consumption for | [IU] |
| | allowance variable uₘ | |
| where u_{m, Allowance} = | personal allowance for allowance | [IU] |
| | variable uₘ | |
| where p_{n, Applied} = | actual amount of conservation applied | [IU] |
| | for conservation variable pₙ | |
| where p_{n, Reference} = | reference amount of conservation | [IU] |
| | applied for conservation variable pₙ | |

Note:
Units IU stands for “impact units” representing the specific unit of the impact variable

For allowance variable u_{m,All} the PSRA values for the associated conservation variable pₙ are:

p_{n,PSRA}=MIN(p_{n,Reference},p_{n,Required},p_{n,Applied})

Substituting the above expression p_{n,Required}=u_{m,All,Consumed}*R gives:

$${p}_{n , PSRA} = MIN ( {p}_{n , Reference} , {u}_{m , All , Consumed} - R , {p}_{n , Applied} )$$

| | | |
|---|---|---|
| where p_{n, PSRA} = | personal sustainable resource use | [IU] |
| | absorption for conservation variable pₙ, | |
| | associated with allowance variable uₘ | |
| where p_{n, Reference} = | reference amount of conservation to be | [IU] |
| | applied for conservation variable pₙ, | |
| | associated with allowance variable uₘ | |
| where p_{n, Required} = | required amount of conservation to be | [IU] |
| | applied for conservation variable pₙ, | |
| | associated with allowance variable uₘ | |
| where p_{n, Applied} = | actual amount of conservation applied | [IU] |
| | for conservation variable pₙ, | |
| | associated with allowance variable uₘ | |

The above formulas do not include the corrections needed to cover any increases in allowances for women with less than the replacement rate of children.

For R=1, this simplifies to:

$${u}_{m , PSRA} = {p}_{n , PSRA} = MIN ( 1 , {u}_{m , All , Consumed} , {p}_{n , Applied} )$$

The above equation is much simpler than the combination of formulas used for R≠1. The case for R=1 is therefore used throughout this invention description unless stated otherwise. As shown above for cases where R≠1, all equations need to be modified as done for the earlier formulas. In absence of values for ratio R, determined in actual studies (R_{Determined}), presumptive value for R are used (R_{Presumptive}), such that R_{Presumptive}>R_{Determined}.

Prior to actual determination of R_{Determined}, scientists need to estimate R_{Determined} and use a multiplication factor >1, such that there is a high probability that after determination of R, the presumed R_{Presumptive} was indeed larger than the determined R_{Determined}. Values for R are local or regional. For example, values for R_{Bio} will differ per ecoregion. The WWF has identified 867 terrestrial ecoregions, approximately 450 freshwater ecoregions and 232 marine ecoregions across the Earth. This number is likely to grow. This implies that R values need to be determined for more than 1550 ecoregions.

The personal sustainable absorption (PSA) value for labor hours consumed is the minimum of the individual labor hours allowance, the individual labor hours worked and the amount of labor hours consumed. Labor hours worked (or represented otherwise) is on itself an allowance variable, but as discussed earlier, labor hours are typically carried as the first of the four variables in all EH variable data sets [l, uₘ, pₙ]|[c]. The value for labor hours l is the same, independent of variable type used for the use and damage variable uₘ. Excessive labor hours worked (slave, child and sweatshop labor) need to show up in the labor output. In order to show such excessive hours originating from products consumed, never more than the reference labor hours (l=1) should be deducted as PSA. If the individual works part time (or is retired) no more than the actual hours worked should be deducted as PSA in order to allow forwarding of excessive labor hour from products consumed to the labor output. The calculation of labor hours to be deducted as PSA is independent of the variable type uₘ. We therefore refer to these labor hours as l_{PSA}.

l_{PSA}=MIN(1,l_{worked},l_{consumed})

| | | |
|---|---|---|
| where l_{PSA} = | personal sustainable absorption for | [h/y] |
| | individual labor hour variable | |
| where l_{worked} = | personal labor hours worked | [h/y] |
| where l_{consumed} = | labor hours corresponding with products | [h/y] |
| | and services consumed | |

The allowance variable for individual labor hours worked is one of the many human condition variables of which most will be added once data on such variables are available. Most of the human condition variables represent current and historic damage.

For current damage variables u_{m,CD} the calculation is simpler than for allowance variables u_{m,PSRA}; the amount of conservation to be applied is equal to the damage done. If less than the required amount of restoration is applied, also less of the damage done can be deducted as PCDA. The minimum of damage done and restoration applied are adsorbed as PCDA:

$${p}_{n , PCDA} = {u}_{m , PCDA} = MIN ( {u}_{m , CD , Consumed} , {p}_{n , Applied} )$$

| | | |
|---|---|---|
| where p_{n, PCDA} = | personal sustainable current damage | [IU] |
| | absorption for conservation variable | |
| | pₙ, associated with current damage | |
| | variable uₘ | |
| where u_{m, PCDA} = | personal sustainable current damage | [IU] |
| | absorption for current damage | |
| | variable uₘ | |
| where p_{n, Applied} = | actual conservation applied for variable | [IU] |
| | pₙ, associated with current damage | |
| | variable uₘ | |
| where u_{m, CD, Consumed} = | individual current damage consumption | [IU] |
| | for allowance variable uₘ | |

Any amount of current damage for which no conservation is applied as the associated restoration, ends up in the labor output of the ISCS. Any amount of conservation applied towards current damage in excess of requirements is treated as applied to historic damage.

For historic damage variables u_{m,HD} the calculation is in part different. If the required amount of restoration is applied to offset the historic damage, then p_{n,PHDA}=u_{m,PHDA}=u_{m,HD,Required}. If less than the required amount of historic restoration is applied, then p_{n,PHDA}=u_{m,PHDA}=p_{n,Applied} and the balance of historic damage is carried in the labor output.

Historic damage was the “current damage” of the past. Both historically and today, higher income individuals 4 spent and consumed more and thus created more “current damage”. For historic damage, the requirements for restoration of environmental conditions to year 1750 are calculated as a function of income c. For the average global individual with the average global income C=C_{Ref} and c=C/C_{Ref}=C_{Ref}/C_{Ref}=c_{Ref}=1. The per capita historic damage done (also called reference historic damage) is equal to u_{m,HD,Reference}. The amount of historic damage that can be absorbed as PHDA is never more than the requirement. The PH DA for individuals 4 of all incomes is calculated as:

$${u}_{m , PHDA} = MIN ( {c}_{i} * {u}_{m , HD , Reference} , {p}_{n , Applied} ) \\ {p}_{n , PHDA} = {p}_{n , HD , Applied}$$

| | | |
|---|---|---|
| where p_{n, PHDA} = | personal sustainable historic damage | [IU] |
| | absorption for conservation variable | |
| | pₙ, associated with historic damage | |
| | variable uₘ | |
| where u_{m, PHDA} = | personal sustainable historic damage | [IU] |
| | absorption for current damage | |
| | variable uₘ | |
| where cᵢ = | normalized income for individual i | [$/y] |
| where u_{m, HD, Reference} = | amount of historic damage assigned | [IU] |
| | to reference individual | |
| where p_{n, Applied} = | actual conservation applied for | [IU] |
| | conservation variable pₙ, associated | |
| | with historic damage variable uₘ | |

Restoration applied to historic damage in larger amounts than required are absorbed as PHDA until an individual income dependent lifetime maximum requirement amount is reached.

Once reached, no further restoration requirement exists for the variable (u_{m,PHDA}=p_{n,PHDA}=0) and all additional restoration applied ends up in the labor product. The “above requirement” application of restoration to historical damage is mostly theoretical, since insufficient means of conservation will be available for most of the historic restoration period (hundreds of years). Access to (historic) conservation needs to be rationed to allow access to all individuals 4 and organizations.

### PSRA Example for Allowance Variable:

In the following an example with regard to PSRA is described:

We set (example) reference conditions for workweek and weekly income at respectively 40 h/w and $400/w. Assume further that for the allowance variable cultivated area (CA) use, the reference is set to 1 Ha. An employee works 60 h/week, earns $800/week of which all is spent on products and services 2 (MP&S). His consumption reflects reference labor hours, 3 Ha of cultivate area use, while no conservation is applied as part of the product. All income earned flows in resource direction and ends up flowing out with MP&S purchased. The own labor hour input is:

[l]=[1.5]

The consumption total (sum of all LBI and products 1 and services 2 consumed) is:

$$[ l , u , p ] \vert [ c ] = [ 1 , 3 , 0 ] \vert [ 2 ] .$$

PSA calculation: Using R_{Bio}=1, this results in p_{WA,Required}=u_{CA}*1=3.

Without wildlife area protection the

PSA would be:

[l,u,p]=[1,0,0].

The labor output for l, u and p are calculated as the EH balance over the ISCS:
+Own work hour input: [l]=[1.5]
+Consumption input: [l,u,p]|[c]=[1, 3, 0]|[2].
−PSRA output: [l,u,p]=[1, 0, 0]
=Labor output: [l,u,p]|[c]=[1.5,3,0]|[2]

The cultivate area use is at 300% of the sustainable maximum and the individual CA use sustainability is equal to 33%. The employee decides to purchase the required conservation as a 2^{nd} purchase immediately following the 1^{st} purchase. With the wildlife area now protected in the name of the individual, the EH impact balance over the ISCS is:
+Own work hour input: [l]=[1.5]
+Consumption input: [l,u,p]|[c]=[1,3,3]1 [2].
−PSRA output: [l,u,p]=[1, 1,1]
=Labor output: [l,u,p]|[c]=[1.5,2,2]|[2]

With all required conservation applied, the 100% conservation sustainability mark is reached. However, the cultivate area use still corresponds to 200% of the sustainable maximum and the individual CA use sustainability is equal to 50%. This would be the case if the conservation would be applied at the time of CA use. Delayed application of conservation would create a 2^{nd} order effect.

### PCDA Example for Current Damage Variable:

In the following an example with regard to PCDA is described:

Using current carbon (C) emissions as an example of current damage, a recent decadal per capita average of 4 tC/y is be used as U_{ref}. The reference individual is working 2000 h/y and earning $20,000/y, no current damage would be done and the required conservation for current damage would be zero. However, for the average individual the amount

$${P}_{ref} = {U}_{Rep} = 4 tC / y$$

would need to be sequestered to meet the conservation requirements. For an individual working 1,000 h/y, earning $40,000/y and a total consumption reflecting reference labor hours and C-emissions of 8 tC/y, the required C-sequestration would be equal to the amount emitted

$$P = U = 8 tC / y .$$

Expressed as normalized values, the C-sequestration would be equal to:

$$p = u = U / {U}_{ref} = 8 / 4 = 2.$$

After this application of C-sequestration, the consumption, now 100% sustainable with respect to conservation, corresponds to:

$$[ l , u , p ] \vert [ c ] = [ 1 , 2 , 2 ] \vert [ 2 ] .$$

In and outputs of the ISCS are:
+Own work hour inputs: [l]=[0.5]
+Consumption input: [l,u,p]|[c]=[1, 2,2]| [2]
PCDA output: [l,u,p]=[0.5,2,2]
=Labor output: [l,u,p]|[c]=[1,0,0]|[2]

In contrast to allowance variables, all matching amounts of conservation applied and current damage done can be absorbed as PCDA, in which case none is forwarded to the labor output, resulting in a sustainable labor output. Since all conservation was applied as required the individual conservation sustainability is 100%. However, the C-emissions still took place and the C-sequestration capacity used could have been used for sequestration of historic C-emissions. As can be seen from this example, individual sustainability in particular needs to be calculated from the total individual consumption and not from the labor output (with in this case is 100% sustainable for l, u and p). This would apply if the C-sequestration would take place at the time of C-emissions. Delayed application of conservation would create a 2^{nd} order effect.

### PHDA Example for Historic Damage Variable:

Prior to the reference date to all historic damage is preferably collectivized. After date τ₀ all damage becomes “current” and is individualized. Starting from date to, the reference individual will especially need to periodically (monthly) apply restoration for each historic damage impact amount. This restoration should ideally be included with products 1 and services 2 purchased, but otherwise needs to be purchased separately. Normalized reference conditions for historic damage variables are represented by

$$[ l , u , p ] \vert [ c ] = [ 1 , 1 , 1 ] \vert [ 1 ] .$$

In the following an example is described:

Assume the per capita required (reference) C-sequestration for historic C-emission is 4 tC/y. For an individual earning 5 times the average income (c=C/C_{ref}=5), working reference hours and buying products 1 and services 2 made using reference labor hours, the required normalized conditions for C-sequestration would be p=u=c=5. If the conservation applied to historic C-emissions corresponds to p=2, the total consumption impact corresponds to

$$[ l , u , p ] \vert [ c ] = [ 1 , 5 , 2 ] \vert [ 5 ] .$$

In and outputs of the ISCS are:
+Own work hour inputs: [l]=[1]
+Consumption input: [l,u,p]|[c]=[1,5,2][5]
−PCDA output: [l,u,p]=[1,2,2]
=Labor output: [l,u,p]|[c]=[1,3,0]|[5]

The labor is thus not sustainable with respect to the restoration applied to this historic damage variable. Since not all restoration is applied as required, it is per definition “delayed”. Delayed application of conservation creates a 2^{nd} order effect and increase the amount of historic damage carried with the labor.

### Excess Impact Deduction (XID) Calculation

### Global Supply Chain Under Reference Conditions

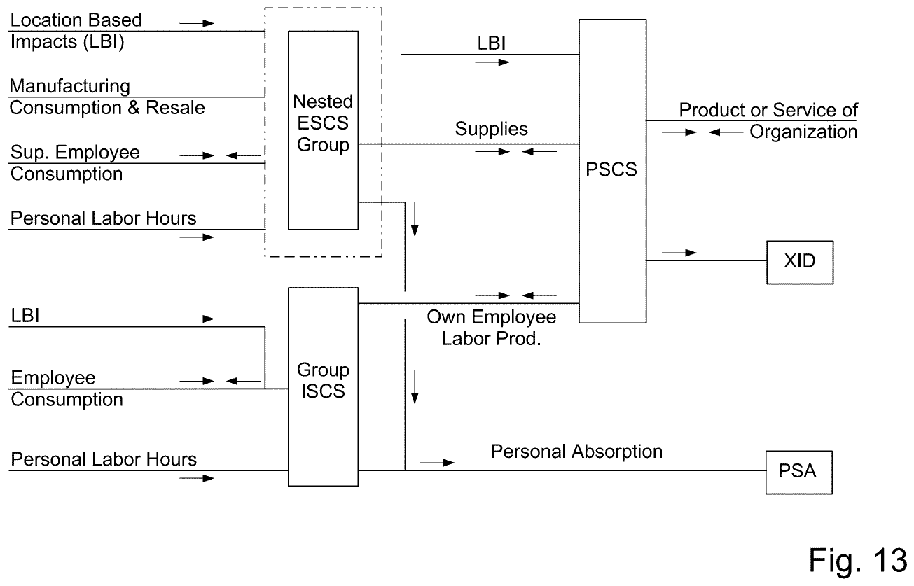

The Metrics are based on environ-humane (EH) impact balance calculations over environ-humane supply chain steps (ESCSs). Products 1 and services 2 are treated in particular as merely packaged forms of EH impacts. While physical products 1 can be stored on shelves and store such EH impacts for a long time, especially services 2 and labor transfer such EH impact packages for immediate delivery. All original EH impacts preferably enter the ISCS-PSCS as individual labor hours and location-based impacts (LBIs) and exit as personal sustainable absorption (PSA) and excess EH impacts deduction (XID), preferably reference is made in this regard to FIGS. 13 to 14B. Individual labor hours and LBIs can be measured accurately and the PSA can be exactly calculated, while the XID is the catchall for the remainder of EH impacts. For industrial societies, most LBIs enter the ISCS-PSCS as a direct product supply chain step (PSCS) input (LBI_{PSCS}), while a smaller fraction enters the individual supply chain step (ISCS) (LBI_{ISCS}).

Per definition, under reference conditions, the annual product portfolio consumed by the reference individual (the reference product portfolio), is preferably 100% sustainable. Independent of the size of the LBI fraction, under reference conditions, the labor output is preferably free of (net) EH impacts and all EH impacts enter the combined ISCS-PSCS with Supplies and LBIs, in particular reference is made to the FIGS. 6 to 8.

A PSCS typically especially requires supplies from a number of supply PSCSs, each of which in turn have their own employees and need their own supplies. This represents a case of “nesting” difficult to show in a figure other than using a dedicated “nested ESCS group”, in particular as shown in FIG. 13 (general) and FIG. 14A and FIG. 14B (with variable and value notations). Storage blocks are included in the figures as well but are typically not shown.

In order to understand how to calculate the XID, we need to evaluate the global system of ESCSs. On a global sale all products 1 and services 2 produced are ultimately consumed by the world's human population. Products 1 wasted and all EH impacts otherwise ending up as waste are considered EH impacts “consumed” by individuals 4. To better visualize this, the world can be divided in three groups of ESCS and fold all ESCS for each group into a single ESCS of its kind.

In particular, FIG. 14A shows a combination of ISCS and PSCS preferably for allowance variables under reference conditions for producers (e.g. organizations 3) with suppliers and employees. Further, a nested group ESCS repeat unit is shown

We thus create three group ESCSs:
All retailers (producers) selling directly to consumers (Retail Group PSCS)
All suppliers supplying retailers (Suppliers Group ESCS)
All employees working directly for retailers (Retail Group ISCS)

We assume that the entire world participates is the Metrics system and all products 1 and services 2 consumed are PSCS rated products. These three groups of ESCSs are visualized in the figures, in particular in FIG. 14A. FIG. 14A shows reference conditions for a product and consumers for allowance variables. In particular, FIG. 14A is a flow-chart for EH-impacts and monetary compensation for global system where all products 1 and services 2 are either supplies (preferably in ESCS) or retail products (in particular in PSCS). All employees working for retail group PSCS can be grouped in one global group ISCS.

The multipliers E and A in FIG. 14A can represent respectively the number of “own” employees working for the retail group PSCS and the remainder of employee working for the nested supplies group ESCS. These additional group ISCSs are part of the nested supply group ESCS but hidden from view. Multipliers N and M represent respectively products consumed by employees (E*=E+A) and those consumed in manufacturing. Multipliers L and S respectively represent the number of “batches” of respectively LBI and supplies used as inputs to grouped PSCSs.

FIG. 14B visualizes the combined ISCS-PSCS for allowance variables under normalized non-sustainable conditions representing five times the sustainable resource use without conservation (u=5 and p=0) and without product recycle to manufacturing (M=0).

Each product 1 manufactured in FIGS. 14A und 14B can represent the global annual portfolio consumed by the average global citizen. In particular, there is a potential for supply chain accumulation of EH impacts for use and damage variable u, (where u stands for any of m variables uₘ) and it will be explained later why this is not an issue for any of the other EH impact variables l, pₙ and c. Looking at the global EH impact balance, all environmental impacts enter as location-based impacts (LBI), while all humane impacts enter with the humane condition input, for which currently only the labor hours l are represented. All global EH impacts can only flow out as personal sustainable absorption (PSA) and excess impact deduction (XID). The global EH impact balance for variable u is

$$\begin{matrix}IN = OUT \\ {u}_{LBI \_ ESCS} + {u}_{LBI \_ PSCS} + {u}_{LBI \_ ISCS} = {u}_{PSA} + {u}_{XID}\end{matrix}$$

Under the sketched global “recycle” conditions, all net EH impacts can originate from Supplies and LBIs that are inputs to supplier ESCS and retail PSCS groups. Since this is a global balance, the entire global production can be consumed as individual consumption by the global population. Under reference conditions (FIG. 14A) all EH impacts can be absorbed as PSA and the labor input to the PSCS is free of EH impacts. All compensation paid can flow in compensation direction and the compensation balance closes over all ESCS groups. The EH impact balance over the Retail Group PSCS and the Supplies Group PSCS can close for all EH variables without the need for any XID deduction for use and damage variables (u_{LBL}=u_{PSA} and u_{XID}=0).

### Global Supply Chain Under Non-Sustainable Conditions

For non-sustainable conditions as shown in FIG. 14B, the labor input to the product supply chain step (PSCS) does carry environ-human (EH) impacts. The higher EH impacts of products 1 and services 2 (MP&Ss) made are “recycled” with the retail products 1 and services 2 and consumed by consumers, but not absorbed as PSA. The EH impacts in the labor input to the PSCS can thus represent a 2^{nd} pass of the same EH impacts that were earlier recorded entering the group PSCS for the 1^{st} time as originating from Supplies and retail LBIs consumed by the retail PSCS.

As before, in the overall global balance, EH impacts continue to enter as LBI inputs to supplies and individuals 4, but without conservation applied, none exits the system as personal sustainable adsorption (PSA). In particular, even when conservation is applied, use and damage impacts larger than the allowance would not exit the system as PSA, since for allowance variables, the PSA is limited to the allowance even when ample conservation is applied.

Focusing on variable u (representing use and damage variables) in the variable set [l,u,p]|[c], without any outflow as excess EH impact deduction (XID), the sum of inputs to the PSCS would especially double the value of u in the product 1 u_{Product}. If left uncorrected, this in turn would especially double the EH impacts for all individual consumption in the next consumption cycle and lead to EH impact accumulation in the inventory of supply chain products (supply chain accumulation), leading to increasingly higher calculated EH impacts for MP&S produced. Unless corrected, this issue caused by the 2^{nd} counting of EH impacts would also represent erroneous results for both EH impacts of products 1, services 2 and labor. The amount of EH impacts entering for the 2^{nd} time must be removed by routing these to an (XID) block.

FIGS. 14A and 14B show a closed EH impact balance for allowance variables. A total of M+N portfolio products are made, of which M are consumed as supplies in manufacturing and N are consumed by employees. Any fraction of production recycled to manufacturing increases the internal flows of EH impacts but does not affect the net individual consumption or the XID required. For simplicity of further evaluations, M is set to zero.

Excess EH impact accumulation is not an issue for any of the other EH impact variables l, pₙ and c.

Starting with conservation variable pₙ, conservation cannot accumulate in the supply chain due to shortage of conservation throughout the entire environmental restoration period. Access to conservation can affect individual sustainability, career options, income and preferably future taxation. For reasons of fairness, access to conservation preferably needs to be rationed and not enough conservation will be available to offset sustainable requirements for products and services 2 (MP&S) purchased. Even in case it would be available, any conservation applied by >100% conservation sustainable individuals 4, that ends up in the labor input to a product supply chain step (PSCS), ends up consumed in the next consumption cycle, removing such excess.

The variable for labor hours worked l, is an allowance variable, for which the allowance is preferably set close to or equal to the average number of labor hours worked and may be regionally adjusted. Consequently, on average all labor hours entering with employee labor exit with personal sustainable resource use absorption (PSA) and (except for some regional effects) no significant accumulation is likely to occur.

Compensation variable c moves in compensation direction, independently of environmental impacts. Compensation does in particular not accumulate in the supply chain defined as “accumulation of EH impacts in stored MP&S and labor, such that this increases the EH impacts of MP&S and labor with each successive consumption cycle, in excess of the actual EH impacts”, since compensation paid under the Metrics system is free of EH impacts. Money especially represents a mere promise to buy MP&S in the future for the value represented by the money.

The above section shows that use and damage EH impacts [u] will in particular accumulate in the supply chain if no corrections are made.

The objectives for a method to calculate product use and damage variables impacts are at least one of the following groups:
1. Create a strong incentive for sustainability improvements for all participants.
2. Prevent supply chain accumulation of use and damage impacts variables.
3. Calculate the most accurate use and damage variables impacts for products.

### Recycling to Manufacturing and Effects on XID

It has already been outlined that in particular under globally sustainable conditions, the environmental use and damage (U&D) impacts collected during manufacturing of products 1 and services 2 (MP&S) end up in the products and services without any need for correction as excess impact deduction (XID). Under globally (on average) sustainable conditions, the location-based impacts (LBIs) and supplies that are inputs to the retail group PSCS, can add up to the impacts reflecting sustainable product values. Once these sustainable products 1 and services 2 are consumed by the average global consumers, the resulting labor is sustainable, implying zero EH impacts. While this labor provides an input to the retail group PSCS, the absence of any net EH impacts does in particular not increase the EH impacts of the products 1 and services 2 made. The XID, as the result of the EH balance over the retail group PSCS, is especially thus calculated to be zero.

How does this change when a fraction of retail products 1 and services 2 is recycled to and consumed in manufacturing? (Consumed by manufacturing processes, not consumed by individuals 4.)

When drawn in figures, EH impacts of materials and supplies especially feed from one PSCS into the next and accumulate all EH impacts along the supply chain. Without any labor inputs, the PSCS product output is especially correctly calculated by adding all PSCS inputs, without any need for XID correction. This principal continues to apply independently of how the PSCS diagram is drawn (as a straightforward feed or as a recycle stream). Any products 1 and services 2 that are outputs of the retail PSCS and later used as inputs to other PSCSs should preferably be treated as materials and products 1 and services 2 temporarily stored and later used as inputs as for any other PSCS. In principal, the labor output needs to be an input to the PSCS, since labor can be a major source of EH impacts not yet accounted for (LBIs and not PSCS rated MP&S). Therefore, this labor source of EH impacts needs to be an input to the PSCS as any other EH impacts originating from LBI and supplies that are direct inputs to PSCS.

This then leads to the question:

“Why (under non-sustainable conditions) does “recycling” of product and service impacts to employees/consumers lead to supply chain accumulation (requiring an XID correction) while recycling of the same product 1 EH impacts to manufacturing does not?”

The answer is that EH impacts accumulated by products 1 and services 2 along the supply chain are not yet consumed by individuals 4, while EH impacts of products 1 purchased by individuals 4 are consumed or considered consumed. After consumption by individuals 4, the EH impacts present in the labor output represent “excess EH impacts”. The total of EH impacts in the labor output can be divided in two parts; the part that did not yet pass through a PSCS (the 1^{st} pass EH impacts) and the part that did. The latter part represents the 2^{nd} pass amount and needs to be deducted as XID to prevent supply chain accumulation of EH impacts.

### XID and Variable Type

The evaluation of impact accumulation was thus far focused on allowance variables. It was clear that allowance variables can accumulate in the supply chain. While all excess impact deductions (XID) are generically referred to as XID, this name varies with variable type. For allowance variables the XID is referred to as excess natural resource use deduction or XNRD.

Does supply chain accumulation apply to current damage variables? With a large amount of damage done (wildlife area losses and carbon dioxide emissions) and means of restoration currently either non-existent (carbon dioxide sequestration) or in very short supply (wildlife area restoration, soil restoration), supply chain accumulation is certainly an issue for current damage variables. Hence excess current damage deduction (XCDD) applies to current damage variables.

Does supply chain accumulation apply to historic damage variables? With respect to the Metrics, historic damage is the accumulation of current damage done up to a set date τ₀. We can only start to restore the atmosphere back to historic (year 1750) carbon dioxide concentrations, once the carbon dioxide sequestration capacity is larger than needed to sequester the current carbon dioxide emissions for participants. The same applies to wildlife area restoration of historic losses.

For Metric participants, conservation will be purchased as TTC in a 2^{nd} purchase, automatically and immediately after a 1^{st} (original) product purchase, but will need to be limited by TTC availability. Until there is capacity for restoration in access of needs to offset current damage (by participants), it would serve no function to implement the requirement to apply conservation to offset historic damage. Once such excess restoration capacity is reached for a particular variable, the use of that particular historic damage variable would need to be implemented in order to guarantee the continued (exponential) growth of the restoration capacity. Once implemented, any requirement for conservation for historic damage variables preferably not met by participants would enter the labor output and would accumulate in the supply chain. Hence excess historic current damage deduction (XHDD) preferably applies to current damage variables.

Thus far the use of XID is preferably anticipated to be applied to environmental damage; however XID could also be applied to human damage variables.

1^{st} and 2^{nd} Pass: How do they Compare?

Before consuming a product, it first needs to be made. This requires that raw materials first need to flow through a PSCS and only after this step can flow through an ISCS and end up making a 2^{nd} pass through a PSCS. It may appear that the pass through the ISCS is the problem and we might get around this by simply counting all EH impacts originating from LBI and supplies to PSCSs while ignoring any EH impacts originating from ISCS. However, the reality is in particular different. Consumers are the real drivers of consumption. The real consumption thus preferably takes place by consumers and the EH impacts of this consumption enters the PSCS of products 1 and services 2 made by their employers. This pass should thus be treated as the essential or 1^{st} pass. However, this does not match with the time order of events. To prevent confusion, we will use the time order of events to indicate the pass number: 1^{st} pass for LBI and supplies that are inputs to PSCS and the labor inputs to the PSCS as the 2^{nd} pass.

### Calculation of EH Impacts for Products 1 and Services 2 Using XID

### General Method A. Using Excess Impact Deduction (XID)

FIGS. 14A and 14B show in particular the two extremes for global Metrics participating worlds. FIG. 14A reflects a world of only reference individuals 4, with zero excess resource use and damage (U&D) in the labor output and zero XID. FIG. 14B reflects a more realistic but non-sustainable world where no conservation is applied, all U&D ends up in the labor product resulting in an XID equal to the product U&D after the first consumption cycle. For a 100% participating world all U&D of the labor output qualifies as XID.

One way to prevent supply chain accumulation of environ-human (EH) impacts is in particular not counting (or deducting) any EH impacts that are inputs to a product supply chain step (PSCS) for a 2^{nd} time, if this impact was added (and counted) a 1^{st} time as an input to another PSCS. Following this principal, a systematic way to calculate the EH impact of products 1 and services 2 would preferably be:
a) Calculate the (for XID) uncorrected total of all EH impact in the labor output.
b) Calculate the total of all EH impact inputs to the PSCS (from labor, supplies and LBIs)
c) Calculate the total of all EH impacts in the labor inputs that do not qualify as XID.
d) Calculate the XID as the total of a) minus c).
e) Calculate the EH impact of products 1 and services 2 by deducting the XID (d) from the sum of PSCS inputs (b).

ISCS input amounts to the PSCS that do not quality as XID, or have no EH impact contribution, are:
All labor inputs to the PSCS originating form sustainable (participating) employees.
All labor inputs to the PSCS originating from non-participating employees.
MP&S inputs to the ISCS that did not originate from a PSCS (i.e. those originating from an RSCS and location-based impacts (LBI) that are inputs to ISCSs).

XID only applies to PSCS inputs that would represent a 2^{nd} pass of an EH impact already counted during a 1^{st} pass. EH impacts of unrated products 1 and services 2 consumed were not counted as PSCS input impacts originating from suppliers or retail LBIs and their presence in the labor input to the PSCS would not qualify as a 2^{nd} pass.

The EH impacts for variable uₘ qualifying as XID and the resulting EH impacts for variable uₘ for products 1 and services 2 made, can be expressed without making assumptions for variable types and PSA calculation treatment. For each employee part of the own employee ISCS group, the fraction of resource use that qualifies as XID can be calculated based on employee participation and the fraction of resource use consumed as PSCS rated products:

$$\begin{matrix}{u}_{m , Labor , i , XID} = {u}_{m , Labor , i} * {f}_{P , i} * {f}_{m , Rated , i} \\ {f}_{m , Rated , i} = {u}_{m , Rated , i} / {u}_{m , Total , i}\end{matrix}$$

where u_{m,Labor,i,XID}=EH impacts for variable uₘ in labor output of employee i qualifying as XID
where u_{m,Labor,i}=EH impacts for variable uₘ in labor output for employee i
where f_{P,i}=integer representing Metrics participation for employee i (where 1=participation)
where f_{m,Rated,i}=fraction of EH impact variable m for employee i originating from PSCS rated products
where u_{m,Rated,i}=EH impact variable uₘ, for employee i for PSCS rated products 1 and services 2 consumed
where u_{m,Total,i}=EH impact variable uₘ, for employee i for total of all products 1 and services 2 consumed

The sum of the above labor outputs applies for the collection of all own employees E:

$${D}_{m , Labor , XID} + {SUM}_{i}^{E} ( {u}_{m , Labor , i , XID} ) = E * {\overline{u}}_{m , Labor , XID} = N * {u}_{m , XID}$$

where D_{m,Labor,XID}=sum of values of EH impact variable uₘ in labor output for all E employees qualifying as XID
where u_{m,Labor,i,XID}=value of EH impact variable uₘ in labor output for employee i qualifying as XID
where ū_{m,Labor,XID}=value of EH impact variable uₘ in labor output for average employee qualifying as XID
where u_{m,XID}=value of EH impact variable uₘ in PSCS output qualifying as XID
where E=total number of own employees
where N=number of products 1 and services 2 made

The EH impact balance over the PSCS provides:

$$L * {u}_{m , LEI , PSCS} + S * {u}_{m , Supply} + E * {u}_{m , Labor} = N * {u}_{m , Product} + N * {u}_{m , XID} OR \\ N * {u}_{m , Product} = L * {u}_{m , LBI , PSCS} + S * {u}_{m , Supply} + E * {u}_{m , Labor} - N * {u}_{m , XID} \\ with : {D}_{m , Pass - 1} = L * {u}_{m , LBI , PSCS} + S * {u}_{m , Supply} \\ with : {D}_{m , Total - Labor} = E * {u}_{m , Labor} and {D}_{m , Labor , XID} = N * {u}_{m , XID} \\ N * {u}_{m , Product} = {D}_{m , Pass - 1} + {D}_{m , Total - Labor} - {D}_{m , Labor , XID} \\ {u}_{m , Product} = ( {D}_{m , Pass - 1} + {D}_{m , Total - Labor} - {D}_{m , Labor , XID} ) / N$$

where u_{m,Product}=normalized value of EH impact variable uₘ in product 1 made
where u_{m,Labor}=average normalized value for EH impact variable uₘ for labor of employees E
where u_{m,XID}=normalized value of EH impact variable uₘ in PSCS output qualifying as XID
where D_{m,Pass-1}=normalized value of EH impact variable uₘ in combined supplies and LBI_{PSCS} inputs to PSCS
where u_{m,Supply}=normalized average value for EH impact variable uₘ in supplies input to PSCS
where u_{m,LBI,PSCS}=normalized average value for EH impact variable uₘ in LBI_{PSCS} input to PSCS
where S=units of supplies used by PSCS
where L=units of LBI_{PSCS} used by PSCS

Note that D_{m,Total-Labor}−D_{m,Labor,XID}≥0, D_{m,Pass-1}≥0 and therefore u_{m,Product}≥0.

### Excess Impact Deduction for Allowance Variables (XNRD)

The excess impact deduction for allowance variables is in particular calculated using the formulas as listed above, however such that the individual labor output for each individual u_{m,Labor,i} is calculated using the personal sustainable resource use absorption (PSRA) calculation for allowance variables. All instances where the subscript “XID” is used are replaced by the subscript “XNRD” (excess natural resource deduction).

### Excess Impact Deduction for Current Damage Variables (XCDD)

The excess impact deduction for current damage variables is especially calculated using the formulas as listed above, however such that the individual labor output for each individual u_{m,Labor,i} is calculated using the personal current damage absorption (PCDA) calculation for current damage variables. All instances where the subscript “XID” is used are replaced by the subscript “XCDD” (excess current damage deduction).

### Excess Impact Deduction for Historic Damage Variables (XHDD)

The excess impact deduction for historic damage variables is especially calculated using the formulas as listed above, however such that the individual labor output for each individual u_{m,Labor,i} is calculated using the personal historic damage absorption (PCDA) calculation for current damage variables. All instances where the subscript “XID” is used are replaced by the subscript “XCDD” (excess historic damage deduction).

### Calculation of EH Impacts for Products 1 and Services 2 Using an Average

### Method B. Using Arithmetic Average

As it has already been discussed and in particular shown in FIG. 14B, on a global scale, for 100% Metrics participation, for non-sustainable products, without any conservation applied and without application of any excess impact deduction (XID), the environ-human (EH) use and damage (U&D) variable impacts of products 1 and services 2 made especially would be calculated at twice their correct value after a single consumption cycle and further increasing with additional cycles. For allowance variables, this factor two reduces to lower numbers when conservation is applied and reduces to unity (the correct value) when on average sustainable conditions are reached.

Especially early in the global sustainability improvement process, with high resource use, high current damage and little conservation capacity, the EH inputs from labor (after application of XID) will on average be about as high as the 1^{st} pass inputs from LBI and supplies. In that case, a simple averaging calculation would reduce the product 1 use and damage impacts to half and would prevent supply chain accumulation.

The simplest method to calculate the on average correct EH impacts of products 1 and services 2 under highly non-sustainable conditions (and to prevent EH impact accumulation) is to calculate the arithmetic average of EH impacts from the labor inputs and from the rest of the inputs to the product supply chain step (PSCS) (LBI and Supplies). In that case the labor input in its absolute form without discrimination between 1^{st} and 2^{nd} pass EH impacts could be used.

$$\overline{x} = \frac{Y + Z}{2}$$

where x̅=calculated average value for impact variable u in product 1 (u_{Product})
where Y=value for impact variable u in sum of supplies and LBI inputs to PSCS (u_{Supplies,PSCS}+u_{LBI,PSCS})
where Z=value for impact variable u in labor input to PSCS (u_{Labor,PSCS})

In order to account for the EH impact balance over the PSCS, the XID would still need to be calculated, however the XID is now the result of the EH balance calculation over the PSCS.

$${u}_{XID , Average} = {u}_{Supplies , PSCS} + {u}_{LBI , PSCS} + {u}_{Labor , PSCS} - {u}_{Product}$$

One drawback of using the arithmetic average is that the EH impacts of products 1 and services 2 under sustainable labor conditions would be calculated at half their correct value. This problem would already start for un-sustainable labor becoming more sustainable. A correction factor would be needed for labor conditions becoming more sustainable or approaching sustainability.

Method C using Exponential Weighted Average

An alternative method to use is in particular the weighted average. The weighted average is calculated as follows:

$$\overline{x} = \frac{{\sum }_{i = 1}^{n} {w}_{i} \cdot {x}_{i}}{{\sum }_{i = 1}^{n} {w}_{i}} = \frac{{w}_{1} {x}_{1} + {w}_{2} {x}_{2} + … + {w}_{n} {x}_{n}}{{w}_{1} + {w}_{2} + … + {w}_{n}}$$

in this formula xᵢ represents the data values, while wᵢ represent the weights.

One application of this weighted average would be the data weighted average (x̅_{dw}) where the data values are used as weights. For use under the Metrics the EH impact variable values as data can be used. This data weighted average is in particular needed only for two variables (Y and Z), where Y is the EH impact equal to the sum of LBI and supply inputs to the PSCS and where Z is the EH impact of the labor input to the PSCS. The data weighted average is defined as follows:

$${\overline{x}}_{dw} = \frac{{Y}^{2} + {Z}^{2}}{Y + Z}$$

The data weighted average has a value between the arithmetic average and the higher of the two data values. While useful, this data weighted average is a single value. Just as weight factors can be used for the weighted average, in order to allow manipulation of this average towards either the higher of lower of the two values, a formula called in the following an exponential data weighted average can be used. The exponential data weighted average (EDWA or x̅_{edw}) is formulated as:

$${\overline{x}}_{edw} = \frac{{Y}^{( 1 + P )} + {Z}^{( 1 + P )}}{{Y}^{P} + {Z}^{P}}$$

The EDWA has the following properties:

For exponent value P=0, the EDWA is equal to the arithmetic average.

For exponent value P=1, the EDWA is equal to the data weighted average.

For increasing exponent values P>1, the EDWA moves from the data weighted average to the higher of the two data values.

For reducing exponent values 0<P<1 the EDWA moves from the data weighted average to the arithmetic average.

For reducing exponent values P<0 the EDWA moves from the arithmetic average towards the lower of the two data values.

Note that for calculation of the EDWA, precautions should be taken to prevent zero values for Y and Z, since Y^{P} is not defined for Y=0. Similar to a weighted average, the calculated value for the EDWA can be manipulated to move between the higher and the lower of the two values by manipulating the weight factors. By selecting the value for exponent P, the EDWA of two values can thus be moved between the lower and the higher of the two data values. The advantage of using the EDWA is twofold:
The correction factor as needed to correct the arithmetic average when approaching and reaching sustainable labor conditions is no longer needed, since for zero values for either Y or Z (adding the very small value), and exponent values≥1, the exponential average remains equal to the higher of the two values. A similar appropriate adjustment takes place for Y<Z or Z<Y.
Only one exponential factor is needed versus two weight factors using a weighted average of two data.

To allow the use of the exponential data weighted average (EDWA) method under sustainable labor conditions, values for exponent P cannot be smaller than unity in order to prevent calculation of unrealistic low EH impact values for the product. Under non-sustainable conditions values for P≤0 can be used for decumulation of supply chain excess. For its use under the Metrics, the data used for the EDWA are EH impact values and the name exponential data weighted average is renamed to exponential EH impact weighted average (EIWA).

### Incentive to Improve Sustainability

The objective to create a strong incentive for sustainability improvements for all participants was particularly set to the highest priority, since reaching the other two objectives as listed above would be futile if this would result in little or no incentive to reach sustainable conditions in the first place. In the system described for this invention, producers reach particularly lower costs and larger profits by making more sustainable products. All methods that would contribute to improved labor and improved product sustainability should therefore in particular lead to improved values for calculated product sustainability.

Organizations 3 can improve product sustainability in two ways:
a) By reducing environ-human (EH) impact in supplies and LBI inputs to the PSCS
b) By reducing EH impact in the labor input to the product supply chain step (PSCS)

Under the Metrics, supplies and products 1 and services 2 needed to make other products, are merely storage vehicles for EH impacts, ultimately consumed by individuals 4. The labor input to the PSCS reflects the non-sustainable excess of EH impacts consumed by individuals 4. Without employees/consumers striving for improvements b), demanding more sustainable products, organization 3 will have no incentives to make improvements a).

This does not work the other way around: there is no expectation that more sustainable products 1 and services 2 made available, would actually be purchased by consumers without any additional incentive to buy them. The current situation, where more sustainable product options are already available but are not purchased by consumers, in preference of their non-sustainable alternatives, proves that point.

Method A (calculating the XID) initially provides incentives for improving the Metrics participation rate and to buy PSCS rated products, since higher own employee participation, (f_{P,i}) and buying a higher percentage of products 1 and services 2 as rated products 1 and services 2 (f_{m,Rated,i}), (each up to 100%), will increase the excess impact deduction (XID) and thus reduce the EH impacts of the products 1 and services 2 made. This results in the higher product sustainability producers and consumer like to see. Unfortunately, once all employee would participate (f_{P,i}=1) and all buy PSCS rated products 1 and services 2 (f_{m,Rated,i}=1), any further incentives to reduce the EH impacts of labor are removed, since the EH-impacts of labor are equal to the XID. Any reduction in EH impacts of the labor output results in the same reduction of XID, leaving the EH impacts of products 1 and services 2 unchanged. Using the XID method A by itself would thus remove the largest incentive to improve product sustainability by not allowing the effect of increasingly sustainable labor to reflect in improved product sustainability values.

A calculation method based on an average would prevent this issue, since for the average of A and B both lowering of only A or only B would reduce the average and thus provide an incentive for improvement.

### Combination of Methods (D) to Calculate Product Impacts

With the XID method A limiting the incentive to become sustainable and an alternative averaging method available, the question could be asked why not only use an averaging method?

One reason to not use an averaging method as the only method, would in particular be when the averaging method would lower the calculated EH impacts to below their true value. While using P≥1 already can prevent this for sustainable labor conditions, there is another category of cases where this would apply: for a labor input representing a significant fraction of 1^{st} pass EH impacts. This would be the case when the EH impacts in the labor input to the PSCS would have the following properties:
1. a significant fraction of EH impact originate from LBIs inputs to the ISCS
2. a significant fraction of EH impact originate from non-participating employees
3. a significant fraction of EH impact originate from employees buying non-rated MP&S
4. a combination of the above three cases

Particularly, the properties 2 and 3 are common during the early stages of implementation, during which period property 1 is also more common. Under those circumstances, the labor input represents a significant fraction (if not most) of 1^{st} pass EH impacts. Under these conditions these 1^{st} pass EH impacts that are inputs to the PSCS (labor, supplies and LBI_{PSCS}) should simply be additive. Using only method C based on averaging would therefore particularly significantly undercount EH impacts of products 1 and services 2 made. However, the “addition based” calculation mentioned would take place using the XID method A.

In particular, with the XID method A lacking sufficient incentive for sustainability and the averaging method C sometimes (and especially during early stages of implementation) producing product EH impact values that are too low, none of the methods evaluated can be used in all cases to reach all objectives listed above. However, method D as a combination of methods A and C would especially work very well.

Calculating the exponential data weighted average of the values calculated for each method A and C.

ū_{m,Product,AOM}=EDWA(u_{Product,XID},ū_{Product,Average})
where

$$EDWA ( Y , Z ) = \frac{{Y}^{( 1 + Q )} + {Z}^{( 1 + Q )}}{{Y}^{Q} + {Z}^{Q}}$$

where ū_{m,Product,AOM}=EH impact variable for resource use and damage variable uₘ for product 1 made calculated using “average of methods” (AOM), using XID method A and average method C.
where u_{m,Product,XID}=EH impact variable for resource use and damage variable uₘ for product 1 made calculated using XID method A
where ū_{m,Product,Average}=EH impact variable for resource use and damage variable uₘ for product 1 made calculated using the EDWA method C (using values for exponent P≥1 under sustainable labor conditions)

Method D is an exponential data weighed average method of two values (using exponent Q), of which one of the two is an exponential data weighed method by itself (using exponent P).

By adjusting the values for mainly exponent Q, the calculated EH impact for each use and damage variable u_{m,Product} for the sum of all products 1 and services 2 made can be adjusted such that accumulation or decumulation of EH impacts in the supply chain is minimized.

The degree to which the combination of methods D for selected values of exponents P and Q, overcounts or undercounts the EH impacts of products 1 and services 2 leading to either accumulation or decumulation of EH impacts in the supply chain, likely can differ per product group, country, degree of societal sustainability and their changes over time. It would be unlikely that any single or set of methods without adjustable variables would be able to correctly calculate or adjust supply chain accumulation or decumulation of EH impacts.

Calculation of EH impact accumulation or decumulation can be done using an EH impact balance on aggregate level (global, regional, national). Using method D, exponents P and Q can be used to correct for any calculated accumulation or decumulation of EH impacts in the participating fraction of the supply chain and reduce the magnitude of such accumulation or decumulation.

The same values for P and Q will preferably initially be set and adjusted for global use by the Metrics organization 3 in order to correct for supply chain accumulation or decumulation of EH impacts. However, regionally different values could be used in case significant regional differences in supply chain accumulation or decumulation of EH impacts occurs.

### Including Effects of Non-Participants and Un-Rated Products

In absence of a sufficient variety of rated products 1 in local stores, participant will especially have no other choice than to buy some or most of the products 1 and services 2 they need as un-rated products and services. For these un-rated products and services, the EH impacts will in particular be estimated by an impact rating organization 3 (IRO) using automated online methods. Due to the likely high EH impact values of unrated products 1 and services 2 and higher uncertainty in this estimate, this leads to higher EH impact values compared to the “same” products 1 and services 2 sold by participating sellers. However, this effect would still in particular be the best approximation of a true effect. This effect would increase the EH impacts accumulated in the supply chain, but would gradually fade away with increasing participation.

Participating sellers, selling rated products and services, will especially continue to sell to non-participants. While these products 1 and services 2 leave the supply chain, their EH impacts and transfers (out of the participating supply chain sections) are recorded and thus known and the total outflow of EH impacts (out of participating supply chain sections) can be calculated. Accumulation or decumulation of EH impacts in the participating fraction the supply chain can be calculated as before.

### Sustainability Calculation

### Individual Sustainability—Introduction

Calculation of EH-impacts for products 1, services 2 and individuals 4 does especially not require the calculation of sustainability values; absolute EH-impact values are simply added over each ESCS, converted to normalized EH-impact values to allow calculation of personal sustainable absorption (PSA) and excess impact deductions (XID) after which they are converted back to absolute EH-impact values for the individual labor provided and for products 1 and services 2 made. Sustainabilities for product 1, services 2 and individuals 4 are also used for the calculation of the amounts of conservation to be applied automatically as part of the 2^{nd} purchase immediately following the 1^{st} purchase. However, application of such “full complements” of conservation requires TTC availability that will not exist for quite a while. Sustainability values are therefore mainly calculated to aid consumers in their selection of more sustainable products 1 and services 2 and to show how sustainable they really are as individuals. In addition, sustainabilities for product 1, services 2 and individuals 4 can be used as the basis of taxation.

Individual sustainability in particular reflects the degree to which an individual lives sustainable and is determined by individual consumption. With products and services 2 (MP&Ss) consumed and location-based impacts (LBIs) otherwise created, individuals 4 especially have EH impacts on the environment. Products 1 and services 2 and LBIs should include EH use and damage as well as EH conserving impacts. For example: MP&Ss purchased can already include some or all conservation required to meet conditions sustainable with respect to conservation. Otherwise such conservation can be purchased as title to conservation (TTC). LBIs can reflect environmental impacts to the environment, not covered by purchases or other financial agreements. For most individuals 4 such LBIs reflect EH use and damage.

However, for organizations 3 owning and managing wildlife areas for its biodiversity, such conservation would reflect a conserving LBI. For Nature Protectorate organizations 3 (NPOs), the LBIs reflect the protection of wildlife areas and the restoration of their biodiversity to (the best approximate) of original ecoregion conditions. The same applies to carbon sequestration organizations 3, capturing carbon dioxide from the air and sequestering this in underground rock formations (basalt). The same applies to watershed protection organizations 3 protecting watersheds for its fresh water amounts and quality and to soil and sediment protection organizations 3 protecting soils and sediments for their amounts, compositions and quality. In all cases the conserving and restorative LBIs are converted to digital TTC certificates and sold to individuals 4 as conservation products.

Individual sustainability is preferably calculated from the total individual consumption as reflected by inputs to the individual supply chain step (ISCS) as the sum of all EH impacts form MP&S purchased plus all LBIs created. In particular, it has to be noted that labor hours worked and other human conditions that are inputs to the ISCS represented by individual labor hours are not individual consumptions.

### Individual Sustainability for Allowance Variables

Allowance variables can reflect the use of natural resources for which a sustainable allowance can be defined. Resource use is not sustainable without resource conservation. For allowance variables, a certain amount of resource use is in particular sustainable available (the allowance) under conditions where sufficient resources are conserved. The conservation variable applied preferably needs to match the resource use and damage (U&D) variable used. Separate sustainabilities can be defined for resource use (indicated with U for use and damage) and for conservation applied (indicated with P for protection and restoration). The natural resource use sustainability and the natural resource conservation sustainability are combined in the compensated natural resource use sustainability.

### Individual Natural Resource Use Sustainability

An individual lives in particular 100% sustainable with respect to a natural resource use (or allowance) variable, if for a matching set of U&D variables uₘ, and conservation variables pₙ, the exact allowance amount is used (uₘ=1) while the exact required conservation is applied (pₙ=1 for R_{m,n}=1), (See FIG. 14A). These conditions represent reference conditions for the U&D variables uₘ and pₙ. For all other conditions, the sustainability is in particular calculated proportionally. The per capita resource use allowance for variable j is especially calculated by dividing the globally available resource amount for variable j by the global population:

$${U}_{I , A , j , Ref} = \{ {U}_{A , j , Global} * ( 1 - {f}_{j , Correction} ) \} / {P}_{Global}$$

where U_{l,A,j,Ref}=per capita resource use allowance for resource variable j
where U_{A,j,Global}=globally available resource amount for resource variable j
where f_{j,Correction}=correction factor for resource variable j with 0<f_{j,Correction}<1
where P_{Global}=global population
Subscript symbol use: I=individual, A=allowance variable, j=variable used.

The globally available resource amounts used in the above formula for the different resource variables are especially typically corrected values. For example, for terrestrial cultivated area (CA) use only areas with significant biological activity are included; barren lands (deserts and year-round snow and ice covered lands) are deducted from the total of terrestrial areas. For marine areas a similar biological activity correction is in particular applied (deep ocean sections are deducted from the total of marine areas). In addition, roughly half of all terrestrial and marine areas in particular must be protected for their biodiversity and are excluded from area allowances available for cultivated use. For watershed/precipitation areas (used as a measure for water consumption), only the land fractions that are cultivated or from which water is withdrawn are preferably included, while the individual precipitation area allowance reflects the distribution of all global precipitation intensities (high and low precipitation areas). The resource use sustainability expresses the relative amount of renewable resources used compared to the allowance:

$${S}_{I , A , U , j} = {U}_{I , A , j , Ref} / {U}_{I , A , j}$$

| | | |
|---|---|---|
| where S_{I, A, U, j} = | Individual resource use sustainability | |
| | for allowance variable j | |
| where U_{I, A, j, Ref} = | per capita resource use allowance for | [IU/c] |
| | resource variable j | |
| where U_{I, A, j} = | individual resource use for allowance | [IU/c] |
| | variable j | |

For products, cultivated (CA) and precipitation area (PA) use are expressed in units m²*day (=m²·d). For individuals 4 using products, the sum of such resource use is calculated on a daily or yearly basis (and thus per day or per year), resulting in a CA and PA use expressed for individuals 4 in units m²*day/day (=m²) or Ha*year/year (=Ha).

With u=U/U_{Ref}, the above equation can be expressed in normalized terms:

$${S}_{I , A , U , j} = ( {U}_{I , A , j , Ref} / {U}_{I , A , j , Ref} ) / ( {U}_{I , A , j} / {U}_{I , A , j , Ref} ) = {u}_{I , A , j , Ref} / {u}_{I , A , j} = 1 / {u}_{I , A , j}$$

| | | |
|---|---|---|
| where S_{I, A, U, j} = | Individual resource use sustainability | [ ] |
| | for allowance variable j | |
| where u_{I, A, j, Ref} = | normalized reference individual resource | [ ] |
| | use for allowance variable j | |
| where u_{I, A, j} = | normalized individual resource use for | [ ] |
| | allowance variable j | |

### Individual Resource Conservation Sustainability

In order to use a natural resource sustainably, a sufficient fraction of the resource needs to be conserved.

The ratio R in particular reflects the ratio of renewable resource that needs to be conserved over the amount that can be cultivated, where no loss of biodiversity would take place. Ratio R is determined independently for wildlife area conservation, water conservation, and soil and sediment conservation and for other allowance variables. R is unknown until determined in peer reviewed studies carried out for each variable for each ecoregion. Prior to such determination, a higher presumptive standard ratio is in particular used for each variable until actual ratios are determined. Different values for R can be used for different allowance variables, but the presumptive standard for R is initially set to unity (wildlife area protection, watershed area protection, soil and sediment protection). For cultivated area use the presumptive standard (ratio) is defined as:

$${R}_{Presumptive , WA} = WA / CA$$

| | | |
|---|---|---|
| where R_{Presumptive, WA} = | presumptive ratio for wildlife area | |
| | protection | |
| where WA = | protected wildlife area (protected for | [Ha] |
| | its biodiversity) | |
| where CA = | cultivated area used | [Ha] |

For wildlife area protection, the presumptive standard in particular applies to both terrestrial and marine areas. Once determined, the presumptive standard R_{Presumptive} is replaced by the determined ratio (R_{Determined}). Using the generic ratio R, the area to be protected is equal to:

$${p}_{I , A , j , Req} = R * {u}_{I , A , j}$$

| | | |
|---|---|---|
| where p_{I, A, j, Req} = | normalized individual conservation required for | [ ] |
| | allowance variable j | |
| where u_{I, A, j} = | normalized individual resource use for | [ ] |
| | allowance variable | |
| where R = | generic conservation ratio R (presumptive or | [ ] |
| | determined) | |

For the ecologically most sensitive ecoregions, the presumptive standard may in particular need to be set to values larger than unity to prevent unrecoverable loss of biodiversity. The individual resource conservation sustainability for allowance variable j can be calculated as:

$${S}_{I , A , P , j} = {p}_{I , A , j} / {p}_{I , A , j , Req}$$

| | | |
|---|---|---|
| where S_{I, A, P, j} = | Individual resource conservation sustainability | [ ] |
| | for allowance variable j | |
| where p_{I, A, j} = | normalized individual conservation applied for | [ ] |
| | allowance variable j | |
| where p_{I, A, j, Req} = | normalized individual conservation required for | [ ] |
| | allowance variable j | |

Resource use conservation especially needs to be applied immediately upon use of the natural resource. Insufficient conservation applied to natural resource use leads to indirect current damage (even in absence of any direct current damage). Such damage will in particular be calculated and added as current individual damage done.

### Individual Compensated Resource Use Sustainability

The compensated resource use sustainability can be the combination of resource use sustainability and resource conservation sustainability.

$${S}_{I , A , Comp , j} = {S}_{I , A , U , j} * {S}_{I , A , P , j} = ( {u}_{I , A , j , Ref} / {u}_{I , A , j} ) * \{ {p}_{I , A , j} / ( R * {u}_{I , A , j} ) \} = ( {u}_{I , A , j , Ref} * {p}_{I , A , j} ) / ( R * {{u}_{I , A , j}}^{⋀ 2} )$$

| | | |
|---|---|---|
| where S_{I, A, Comp., j} = | compensated individual resource use | [ ] |
| | sustainability for allowance variable j | |

The above sustainability is called a compensated sustainability, since it allows application of additional conservation to compensate for otherwise lower sustainable conditions. Individuals 4 can thus buy and apply additional conservation above requirements, to increase their individual sustainability. The latter is not the case for intrinsic sustainabilities where conservation above requirements is capped at their requirements:

$${S}_{I , A , Intr , j} = {S}_{I , A , U , j} * MIN ( 1 , {S}_{I , A , P , j} ) = ( {u}_{I , A , j , Ref} / {u}_{I , A , j} ) * MIN \{ 1 , {p}_{I , A , j} / ( R * {u}_{I , A , j} ) \}$$

| | | |
|---|---|---|
| where S_{I, A, Intr,, j} = | intrinsic individual resource use sustainability | [ ] |
| | for allowance variable j | |

Even in a sustainable society, individuals 4 with high incomes will in particular not be able to live intrinsically sustainable, unless they buy unused individual allowance fractions from others already living sustainable. In all cases they can live more than 100% compensated sustainable by paying for additional conservation if such additional conservation is available. Unless explicitly stated otherwise, all sustainabilities discussed in this application are in particular compensated sustainabilities.

### Individual Sustainability for Current Damage Variables

No amount of EH-damage is especially sustainable and any EH-damage in particular must be completely restored to meet individual sustainability requirements. Reference conditions reflect zero current damage.

Even when damage can be restored fairly easily (as is the case for carbon sequestration) restoration always costs money and typically requires large investments. In addition, the installed restoration capacity used to neutralize current damage can no longer be used for environmental restoration to historic sustainable conditions. In addition, restoration is sometimes impossible (when species became extinct) while restoration to historic sustainable conditions can require decades or centuries (restoration of biodiverse wildlife areas). Damage prevention (and investments associated with damage prevention) are therefore always more sustainable than continuation of doing damage followed by restoration.

### Individual Current Damage Sustainability (ICDS)

An individual lives preferably 100% sustainable with respect to current damage when no damage is done and 0% sustainable when the annual damage done is equal to the average annual per capita damage done over a representative recent period (last few decennia). The representative damage can be calculated as:

$${U}_{I , C , j , Rep} = {U}_{C , j , Global , Period} / {Y}_{Recent} / {P}_{Global}$$

| | | |
|---|---|---|
| where U_{I, c, j, Rep} = | absolute representative annual per capita | [IU /y · p] |
| | value for current damage variable j | |
| where U_{C, j, Global, Period} = | absolute value for global current damage | [IU] |
| | for variable j over period Y_{Recent} | |
| where P_{Global} = | adult world population | [p] |
| where Y_{Recent} = | | recent period over |
| which the current | [y] | |
| | damage is determined | |

Subscript symbol use: I = individual, C = current damage variable, j = variable used.

Values for the individual current damage can be expressed as normalized variables using the representative current damage:

$${u}_{I , C , j} = {U}_{I , C , j} / {U}_{I , C , j , Rep}$$

$${u}_{I , C , j , Rep} = 1 when {U}_{I , C , j} = {U}_{I , C , j , Rep}$$

| | | |
|---|---|---|
| where u_{I, C, j} = | normalized individual value for current damage variable j | |
| where u_{I, C, j, Ref} = | normalized individual representative value for current | |
| | damage variable j | |
| where U_{I, C, j} = | absolute annual value for individual current | [IU /p · y] |
| | damage variable j | |

For the average individual continuing the current EH damage at unchanged historic levels, the outcome of equation for u_{I,C,j} is unity. Once determined on an annual basis, the same values for u_{I,C,j} can be applied to any desired accounting period (month, week). For example: Annual averages of per capita C-emissions U_{I,C,j,Rep} can be calculated over the last 10 to 20 years as X ton carbon per year per capita or X [tC/y·c]. For a monthly reporting period, the value U_{I,C,j,Rep,Monthy}=X/12 would be used. For on average unchanged monthly damage, U_{I,C,j,Monthy}=U_{I,C,j,Rep,Monthy} and both u_{I,C,j,Monthy} and u_{I,C,j,Rep,Monthy} remain unity. Therefore u_{I,C,j}=u_{I,C,j,Rep}=1 independent of the period used. To become sustainable, individuals 4 must reduce their current damage from average or higher levels (0% sustainable) to zero (100% sustainable). Preventing negative values, the sustainability for net current damage can be formulated as:

$${S}_{I , C , U , j} = MAX ( 0 , 1 - {u}_{I , C , j} / {u}_{I , C , j , Rep} ) = MAX ( 0 , 1 - {u}_{I , C , j} )$$

where S_{I,C,U,j}=individual current damage sustainability for current damage variable j
where u_{I,C,j}=normalized individual current damage for current damage variable j
where u_{I,C,j,Rep}=normalized per capita representative current damage for current damage variable j
Subscript symbol use: I=individual, C=current damage variable, j=variable used.

Individual Current Damage Mitigation Sustainability (ICDMS)

While prevention of current EH damage is preferably always the best strategy, immediate restoration to original environmental conditions and to humane conditions are in particular the next best options. When restoration takes place immediately after the damage is done, then p_{I,C,j,Required}=u_{I,C,j}.

The ICDMS is especially defined as 100% if all damage is mitigated by restoration to original conditions and as 0% if no restoration took place at all.

$${S}_{I , C , P , j} = {p}_{I , C , j} / ( {f}_{2 ndOrder} * {u}_{I , C , j} )$$

where S_{I,C,P,j}=individual current damage mitigation sustainability for current damage variable j
where f_{2ndOrder}=factor >1 reflecting 2^{nd} order effects caused by delayed application of conservation
where u_{I,C,j}=normalized individual damage done for current damage variable j
where p_{I,C,j}=normalized individual restoration applied to current damage variable j

Note: In the equation above the 2^{nd} order effect is reflected by using the factor f_{2ndorder}. It may be easier to not use this factor but instead to calculate the comparable additional amount of damage caused by delayed application of conservation, since the damage was done.

### Individual Compensated and Intrinsic Current Damage Sustainability (ICCDS and IICDS)

The ICDS and ICDMS can be combined in the individual compensated current damage sustainability (ICCDS).

$${S}_{I , C , Comp , j} = {S}_{I , C , U , j} * {S}_{I , C , P , j}$$

where S_{I,C,Comp,j}=individual compensated current damage sustainability (ICCDS) for current damage variable j
where S_{I,C,U,j}=individual current damage sustainability for current damage variable j
where S_{I,C,P,j}=individual current damage mitigation sustainability for current damage variable j

When sufficient restoration capacity is available, the application of additional conservation can allow compensation for otherwise lower sustainable conditions. The latter is not the case for intrinsic sustainabilities where conservation above requirements is especially capped by the requirements.

$${S}_{I , C , Intr , j} = {S}_{I , C , U , j} * MIN ( 1 , {S}_{I , C , P , j} )$$

where S_{I,C,Intr,j}=individual intrinsic current damage sustainability (IICDS) for current damage variable j
where S_{I,C,U,j}=individual current damage sustainability for current damage variable j
where S_{I,C,P,j}=individual current damage mitigation sustainability for current damage variable j

### Individual Sustainability for Historic Damage Variables

Prior to date τ₀, all EH damage is preferably collectivized and referred to as historic damage. The most important types of historic damage are in particular biodiversity damage, atmospheric carbon dioxide emissions, loss of and damage (pollution) to fresh water reservoirs and loss of and damage to soil and sediments.

Historic EH damage variables can be combined into one variable per metrics impact group. The per capita EH damage value for each variable can be calculated by dividing the total EH damage for each historic damage variable j by the global population and by the estimated numbers of years needed to carry out the restoration to historic conditions. For carbon sequestration, the period Y_{Rest,C} is preferably the period during which the bulk of carbon dioxide needs to be removed from atmosphere and oceans and sequestered, but excludes the global cooling period during which global glaciers are restored. For biodiversity restoration, the period Y_{Rest,B} in particular reflects the period needed to acquire lands, otherwise protect areas (marine), establish safe wildlife corridors, pre-plant areas with native vegetation and re-introduce native species, but excludes the period needed to fully re-establish the approximated original biodiversity.

$${U}_{I , H , j , Ref} = {U}_{H , j , Global} / {P}_{Global} / {Y}_{Rest}$$

| | | |
|---|---|---|
| where U_{I, H, j, Ref} = | absolute value for historic damage | [IU /y · p] |
| | variable j assigned to reference | |
| | individual | |
| where U_{H, j, Global} = | absolute total of global value for | [IU] |
| | historic damage variable j | |
| where P_{Global} = | adult world population | [p] |
| where Y_{Rest} = | period over which all historic damage | [y] |
| | is targeted to be restored | |

Subscript symbol use: I = individual, H = historic damage variable, j = variable used.

The reference amount of historic damage can be expressed in normalized terms. For individual i, this can be expressed as:

$${u}_{I , H , j , i} = {U}_{I , H , j , i} / {U}_{I , H , j , Ref}$$

Most historic environmental damage in particular is and was caused by consumption of higher income individuals 4. Historic damage can be therefore assigned to individual i based on individual income cᵢ=Cᵢ/C_{Ref}:

$${U}_{I , H , j , i} = {c}_{i} * {U}_{I , H , j , Ref}$$

A normalization by dividing both sides by U_{I,H,j,Ref} gives:

$${u}_{I , H , j , i} = {U}_{I , H , j , i} / {U}_{I , H , j , Ref} = {c}_{i} * {U}_{I , H , j , Ref} / {U}_{I , H , j , Ref} = {c}_{i}$$

| | | |
|---|---|---|
| where U_{I, H, j, i} = | absolute historic damage value for | [IU/y · p] |
| | variable j for individual I | |
| where u_{I, H, j, i} = | normalized historic damage value for | [ ] |
| | variable j assigned to individual I | |
| where Cᵢ = | income of individual i | [$/y] |
| where C_{Ref} = | income of reference adult individual | [$/y] |
| where cᵢ = | normalized income of individual i | [ ] |

Subscript symbol use: I = individual, H = historic damage variable, j = variable used, i is individual assigned, IU = impact units for the variable used.

To live sustainable with respect to historic damage, the restoration required in particular must be equal or larger than the historic damage assigned (p_{I,Hj,i}≥u_{I,H,j,i}). Since assigned on an individual income basis, no sustainability exists for the creation of historic damage for individuals 4, but only an individual historic restoration sustainability can exist for each historic damage variable j. The individual historic restoration sustainability is defined as the ratio of restoration applied for historic damage variable j by individual i over a period, divided by the amount of historic damage for historic damage variable j assigned to individual i over the same period. The compensated historic damage sustainability for variable j for individual i is calculated as:

$${S}_{I , H , Comp , j , i} = {p}_{I , H , j , i} / {u}_{I , H , j , i} = {p}_{I , H , j , i} / {c}_{i}$$

where S_{I,H,Comp,j,i}=compensated historic restoration sustainability for historic damage variable j individual i
where p_{I,H,j,i}=normalized restoration applied to historic damage variable j by individual i

When sufficient means of restoration are available, more historic restoration could be applied than required by individual i for a period, leading to a compensated individual historic restoration sustainability >100%. The intrinsic historic damage sustainability is calculated by limiting the use of conservation applied to historic damage variable to the required amounts:

$${S}_{I , H , Intr , j , i} = MIN ( 1 , {p}_{I , Hj , i} / {u}_{I , H , j , i} )$$

where S_{I,H,Intr,j,i}=intrinsic historic restoration sustainability for historic damage variable j for individual i

Subscript symbol use: I=individual, H=historic damage variable, j=variable used.

### Product Sustainability—Introduction

Product sustainability can be determined by the EH impact variable values of the product and the price paid. The EH impact variable values of a product 1 can be equal to the sum of the PSCS impact inputs minus the excess impact deduction (XID). Product sustainability can most easily be envisioned applied to an annual product portfolio. This product portfolio would contain all products 1 and services 2 consumed annually by an individual as delivered by a retailer that would provide all imaginable products and services 2 (MP&S). In addition to groceries, these MP&S would in particular include home rental, car lease, all insurances, education, all repair services 2, government services 2 (as paid by taxes) and anything else an individual would need during a year. This annual product portfolio could in particular be delivered and billed monthly, weekly or even daily.

Since almost all products 1 and services 2 are assemblies of parts and labor forming one product, in a similar fashion the weekly or daily product portfolio (arriving in one box) can be an assembly forming a single product. Such a product portfolio consumed by a reference individual, would in particular represent the reference amounts of natural resource consumption, the required conservation and would be free of current damage impacts. While all such reference product portfolios need to reflect the same 100% sustainable natural resource consumption and required conservation, there would still be an infinite number of different products 1 and services 2 (and thus portfolios) that could constitute a 100% sustainable product portfolio. The reference product portfolio preferably represented by the following EH impact variable values (where c_{Ref} is the reference income):
For allowance (@R=1) and historic damage variables:

$$[ l , {u}_{m} , {p}_{n} ] \vert [ {c}_{Ref} ] = [ 1 , 1 , 1 ] \vert [ 1 ]$$

For current damage variables:

$$[ l , {u}_{m} , {p}_{n} ] \vert [ {c}_{Ref} ] = [ 1 , 0 , 0 ] \vert [ 1 ]$$

For allowance variables a more than 100% sustainable product portfolio would be represented by a fraction for the above reference values for uₘ and pₙ (such that uₘ=pₙ for R=1). A less than 100% sustainable (=non-sustainable) product portfolio would in particular be represented by less than required amounts of conservation applied, higher resource use than the allowance, any current damage and less conservation applied to historic damage variables than required. A product 1 is in particular 100% sustainable for allowance and historic damage variables when

$$l / {c}_{Ref} = {u}_{m} / {c}_{Ref} = {p}_{n} / {c}_{Ref} = 1 ,$$

while for all current damage variables uₘ=0 and pₙ=0. Sustainable and non-sustainable product portfolio conditions can be summarized in the below table for allowance variables.

| Product Portfolio | | | |
|---|---|---|---|
| Sustainability for | 100% | >100% | Non- |
| Allowance Variables | Sustainable | Sustainable | Sustainable |
| With respect to labor | l/c_{Ref} = 1/1 = 1 | l/c_{Ref} < 1 | l/c_{Ref} > 1 |
| conditions | | | |
| With respect to U&D | uₘ/c_{Ref} = 1/1 = 1 | uₘ/c_{ref} < 1 | uₘ/c_{Ref} > 1 |
| variables | | | |
| With respect to | pₙ/c_{Ref} = 1/1 = 1 | pₙ > c_{Ref} | pₙ < c_{Ref} |
| conservation variables | | | |

For current damage impacts, any values for uₘ larger than zero are especially non-sustainable. However, when enough conservation pₙ is available and applied immediately, the damage could be fully (or more) compensated, leading to a product 1 with ≥100% compensated sustainability.

The above values for 100% sustainable resource use uₘ can be calculated from the PSCS output under reference conditions but need to be converted to non-normalized values for actual MP&S sold.

To use an example for the allowance variable cultivated area (CA) use, assume a per capita cultivated area allowance of U_{CA,Ref}=1 Ha/p and a global reference income of C_{Ref}=10,000 $/p·y. Under reference conditions u_{CA,Ref}=C_{Ref}=1. A 100% sustainable product 1 then reflects a CA use per dollar spending of U_{CA,Ref}/C_{Ref}=1 m²·y/$. Products 1 with a CA use per dollar spending ≤1 m²·y/$ would be sustainable and those >1 m²·y/$ would be non-sustainable.

Analogous calculations can apply to product sustainability related to current and historic damage variables.

### Product Sustainability for Allowance Variables

### Product Resource Use Sustainability

Conditions for a 100% sustainable (or reference) product portfolio for allowance variables are discussed above. While the entire portfolio can be treated as a product, so can each of its parts. Even people who would live on average 100% sustainable, would especially use a mix of sustainable and non-sustainable products.

The sustainable product portfolio can contain a wide variety of products 1 and services 2 with a wide range of product sustainabilities. Roughly arranged in order of increasing sustainability, such products 1 and services 2 can range from beef, via cereal based products 1 and industrial non-food products 1 to sustainable labor services 2. Products 1 and services 2 within the portfolio with a lower resource use per dollar spent than the reference portfolio itself, can have a higher than average sustainability with respect to the resource use, and vice versa. For each rated product, the resource use, current damage and conservation applied are especially calculated and in particular provided with the product data sheet.

The resource use of the reference product portfolio purchased for the reference income can be used as the benchmark for product sustainability. The 100% benchmark for product resource use can be calculated by dividing the global per capita sustainable available resource use for each allowance variable j by the global per capita income or by dividing the global sustainable available resource use for variable j by the global world product (GWP).

$${U}_{P , A , \$ , j , Ref} = {U}_{G} / {C}_{G} = {U}_{G / p} / {C}_{G / p}$$

| | | |
|---|---|---|
| where U_{P, A, $, j, Ref} = | reference global product resource use | [IU · |
| | for variable j per dollar global | y/$] |
| | spending | |
| where U_{G} = | global sustainable available resource | [IU] |
| | use for variable j | |
| where C_{G} = | global world product (GWP) | [$/y] |
| where U_{G/p} = | global per capita sustainable available | [IU/p] |
| | resource use for variable j | |
| where C_{G/p} = | global per capita (=reference) income | [$/p · |
| | | y] |

Subscript symbol use: P = product, A = allowance variable, $ = per dollar spending, j = variable used, IU = impact units fo the variable used.

Looking at cultivated area (CA) use as an example, the globally per capita available terrestrial surface area (expressed as Ha per capita or Ha/p) with significant bioactivity is in particular about 1.5 Ha/p of which it is particularly assumed about half needs to be protected for its biodiversity. The remaining 0.75 Ha/p is especially sustainable available after the most biodiverse 0.75 Ha/p is protected as wildlife area (using R_{Bio}=1). In particular using 2017 data, the Gross World Product (GWP) was $87.27 trillion/y and the world population was 7.55 billion people, leading to global per capita income of 10,600 $/p·y. The reference CA use used for product sustainability is preferably thus:

$${U}_{P , A , \$ , j , Ref} = {U}_{G / p} / {C}_{G / p} = ( 0.75 Ha / p ) / ( 10 , 600 \$ / p \cdot y ) = 7 , 500 / 10 , 600 = 0.71 {m}^{2} \cdot y / \$$$

A product 1 with a CA use of 1.42 m²·y/$ would in particular have twice the reference CA use per $ and thus half the reference CA use sustainability, resulting in a 50% product use sustainability for CA use. While calculated here for CA use, this can be applied to every allowance variable. For any given product, the resource use per dollar value can be calculated as:

$${U}_{P , A , \$ , j , p} = {U}_{P , A , j , p} / {C}_{p}$$

| | | |
|---|---|---|
| where U_{P, A, $, j} = | product resource use for allowance variable | [IU · |
| | j per dollar value for product p | y /$] |
| where U_{P, A, j} = | resource use for allowance variable j for | [IU · |
| | product p | y] |
| where Cₚ = | list price product p | [$] |

For any given product, the sustainability for allowance variable j can be calculated as the ratio of the reference resource use per dollar over the product resource use per dollar:

$${S}_{P , A , U , j , p} = {U}_{P , A , \$ , j , Ref} / {U}_{P , A , \$ , j , p}$$

| | | |
|---|---|---|
| where S_{P, A, U, j, p} = | resource use sustainability for | |
| | allowance variable j for product p | |
| where U_{P, A, $, j, Ref} = | reference product resource use for | [IU · |
| | allowance variable j per dollar spending | y / $] |
| where U_{P, A, $, j, p} = | resource use for allowance variable j | [IU · |
| | per dollar spending for product p | y / $] |

The “U” in the subscript for S_{P,A,U,j,p} indicates that the sustainability value can reflect the “use” of a use and damage variable, compared to the application of “conservation” applied to a use and damage variable.

The aforementioned equation can be expressed under normalized conditions:

$${S}_{P , A , U , j , p} = ( {U}_{P , A , \$ , j , Ref} / {U}_{P , A , \$ , j , Ref} ) / ( {U}_{P , A , \$ , j , p} ) / ( {U}_{P , A , \$ , j , Ref} ) = 1 / {u}_{P , A , j , p}$$

where u_{P,A,$,j,Ref}=normalized reference product resource use for allowance variable j per dollar spending
where u_{P,A,$,j,p}=normalized resource use for allowance variable j for product p per dollar spending

While comparing the absolute values for resource use and damage (U&D) variables “U” as used for individuals 4 and products, the latter are especially expressed on a per dollar basis. For this reason, the “$” symbol is included in the subscript (“U_{$}”).

With the aforementioned equation it is possible to compare products 1 and services 2 offered for sale expressed as a sustainability percentage. Comparing products, some products 1 and services 2 have in particular a very high CA use (beef, lamb, butter and cheese), while some have preferably no CA use expressed in m²·y/$. The latter is in particular the case for services 2 provided by sustainable individuals 4 only selling their hourly services 2 (home cleaners and servants). For all rated products 1 and services 2 the resource use U_{P,A,$,j,p} can be calculated and compared to the reference value U_{P,A,$,j,Ref}. Force ranking all products 1 and services 2 from high to low resource use per dollar price, we find that:
all products 1 and services 2 with a resource use U_{P,A,$,j,p}>U_{P,A,$,j,Ref} or u_{P,A,j,p}>u_{P,A,j,Ref}=1 are non-sustainable.
all products 1 and services 2 with values for U_{P,A,$,j,p}≤U_{P,A,$,j,Ref} or u_{P,A,j,p}≤u_{P,A,j,Ref}=1 are sustainable

Even an on average 100% sustainable society will in particular have a very large distribution of product sustainabilities, where the consumption of the non-sustainable fraction of products 1 and services 2 in the sustainable mix is only sustainable due to the high sustainability of the sustainable fraction of products 1 and services 2 consumed. Improvement of product sustainability for allowance variables has the largest effect if the consumption of the highest resource using inputs to the PSCS is reduced.

### Product Resource Conservation Sustainability

In order for a product 1 to be 100% sustainable with respect to conservation, the required amount of conservation especially must be applied. Using the generic ratio R:

$${P}_{P , A , j , p , Req} = R * {U}_{P , A , j , p}$$

| | |
|---|---|
| where P_{P, A, j, p, Req} = | product conservation required for allowance |
| | variable j for product p |
| where U_{I, A, j, p} = | product resource use for allowance variable |
| | j for product p |
| where R = | generic conservation ratio R |

Symbols used for subscripts: P = product, A = allowance, j = variable used, p = product number

The value for U_{P,A,j,p} can be provided on the product data sheet. The product resource use conservation sustainability for allowance variable j for product p can be calculated as:

$${S}_{P , A , P , j , p} = {P}_{P , A , j , p} / {P}_{P , A , j , p , Req}$$

where S_{P,A,P,j,p}=resource conservation sustainability for allowance variable j for product p
where P_{P,A,j,p}=product conservation applied for allowance variable j for product p
where P_{P,A,j,p,Ref}=product conservation required for allowance variable j for product p

The 2^{nd} “P” in the subscript for S_{P,A,P,j,p} indicates that this sustainability reflects a “protection or conservation” related to the allowance variable used.

### Compensated and Intrinsic Product Resource Sustainability

The product resource use sustainability and product resource conservation sustainability can be combined in the compensated product resource sustainability:

$${S}_{P , A , Comp , j , p} = {S}_{P , A , U , j , p} * {S}_{P , A , P , j , p}$$

where S_{P,A,Comp.j}=compensated product resource sustainability for allowance variable j for product p

Conservation can be applied in excess to the required amount to compensate for otherwise lower product sustainability. The latter does in particular not apply to the intrinsic product sustainability where for the calculation the conservation is capped at the required amount.

$${S}_{P , A , Intr , j , p} = {S}_{P , A , U , j , p} * MIN ( 1 , {S}_{P , A , P , j , p} )$$

where S_{P,A,Intr,j,p}=intrinsic product resource sustainability for allowance variable j for product p

Unless explicitly stated differently especially all sustainabilities discussed in this text are compensated sustainabilities.

### Product Sustainability for Current Damage Variables

### Product Current Damage Sustainability (PCDS)

A product 1 can be 100% sustainable with respect to current damage when no damage is done and 0% sustainable when the current damage per dollar price is in particular equal to the average over a representative recent period. Current damage larger than “average” would especially remain at 0% sustainability.

$${U}_{P , C , \$ , j , Rep} = {U}_{C , j , Global , Period} / {Y}_{Recent , j} / GWP$$

| | | |
|---|---|---|
| where U_{P, C, $, j, Rep} = | absolute representative annual value | [IU /$] |
| | for current damage variable j for | |
| | products | |
| where U_{C, j, Global, Period} = | absolute value for global current | [IU] |
| | damage for variable j over period | |
| | Y_{Recent} | |
| where GWP = | global world product | [$/y] |
| where Y_{Recent, j} = | recent period over which the current | [y] |
| | damage for variable j is determined | |

Subscript symbol use: P = product, C = current damage variable, $ = per dollar spending, j = variable used IU = impact units fo the variable used.

For every rated product, the current damage U_{P,C,j} for each variable j can be calculated from the EH balance over the PSCS. The current damage per dollar value can be calculated by dividing by the price Cₚ of product p:

$${U}_{P , C , \$ , j , p} = {U}_{P , C , j ,} / {C}_{p}$$

The associated current damage variable j sustainability for product p can be calculated as:

$${S}_{P , C , U , j , p} = MAX ( 0 , 1 - {U}_{P , C , \$ , j , p} / {U}_{P , C , \$ , j , Rep} ) = MAX ( 0 , 1 - {u}_{P , C , \$ , j , p} )$$

| | | |
|---|---|---|
| where S_{P, C, U, $, j, p} = | current damage sustainability for | |
| | current damage variable j for product p | |
| where U_{P, C, $, j, p} = | current damage attributed to product p | [IU /$] |
| | for variable j | |
| where u_{P, C, $, j, p} = | normalized damage attributed to product | |
| | p for current damage variable j | |
| where U_{P, C, $, j, Rep} = | representative damage attributed to | [IU /$] |
| | product for current damage variable j | |

### Product Current Damage Mitigation Sustainability (PCDMS)

A product 1 or a service 2 has a 100% current damage mitigation sustainability when the required restoration is applied.

This corresponds to P_{P,C,j}=U_{P,C,j}. The current damage mitigation sustainability is formulated as:

$${S}_{P , C , p , j} = {P}_{P , C , j} / {U}_{P , C , j}$$

where S_{P,C,P,j}=current damage mitigation sustainability for product p for current damage variable j
where U_{P,C,j}=damage attributed to product p for current damage variable j
where P_{P,C,j}=restoration applied to product p for current damage variable j

Since products 1 and services 2 are only temporary storage vehicles for damage, while individuals 4 consume and store such damage, 2^{nd} order effects of damage do especially only apply to individuals 4 and not to products.

### Compensated and Intrinsic Product Current Damage Sustainability

The PCDS and PCDMS can be combined in the compensated product current damage sustainability (CPCDS).

$${S}_{P , C , Comp , j} = {S}_{P , C , U , j} * {S}_{P , C , P , j}$$

where S_{P,C,Comp,j}=compensated product current damage sustainability

When sufficient restoration capacity is available, the application of additional conservation can allow compensation for otherwise lower product sustainability conditions, providing higher CPCDS. The latter is in particular not the case for intrinsic sustainabilities where conservation above requirements can be capped by the requirements (IPCDS).

$${S}_{P , C , Intr , j} = {S}_{P , C , U , j} * MIN ( 1 , {S}_{P , C , P , j} )$$

where S_{P,C,Intr,j}=intrinsic product current damage sustainability for current damage variable j
where S_{P,C,U,j}=product current damage sustainability for current damage variable j (PCDS)
where S_{P,C,P,j}=product current damage mitigation sustainability for current damage variable j

### Product Sustainability for Historic Damage Variables

In order to calculate the product sustainability for historic damage impact variables, the average (=reference) historic damage can be calculated and assigned to products 1 and services 2 on a per dollar basis.

$${U}_{P , H , \$ , j , Ref} = {U}_{H , j , Global} / {Y}_{Rest} / GWP$$

| | | |
|---|---|---|
| where U_{P, H, $, j, Ref} = | absolute reference historic damage | [IU/$] |
| | for variable j assigned to products | |
| where U_{H, j, Global} = | absolute global value for historic | [IU] |
| | damage impact variable j | |
| where Y_{Rest} = | period over which all historic damage | [y] |
| | is targeted to be restored | |
| where GWP = | gross world product | [$/y] |

Subscript symbol use: P = product, H = historic damage variable, j = variable used.

For each historic damage variable j the restoration required can be a constant amount per dollar spent. Using the PSCS outputs for a product 1

[L,U,P]|[C],

the historic damage impact for each product 1 can be calculated on an absolute basis my multiplication of the absolute reference historic damage amount per dollar value U_{P,H,$,j,Ref} with the product price Cₚ. For each amount of historic damage, restoration must be applied to restore conditions to original conditions.

$${P}_{P , H , j , p , Ref} = {U}_{P , H , j , p} = {C}_{p} * {U}_{P , H , \$ , j , Ref}$$

| | | |
|---|---|---|
| where P_{P, H, j, p, Ref} = | reference historic restoration for variable j | [IU] |
| | to be applied to product p | |
| where Cₚ = | price of product p | [$] |

In reality no or a much smaller amount of restoration P_{P,H,j,p} may be applied for historic damage variable j, due to lack of TTC available. The compensated historic restoration sustainability for historic damage variable j can be calculated as the ratio of the actual amount restored over the reference amount to be restored:

$${S}_{P , H , Comp , j , p} = {P}_{P , H , j , p} / {P}_{P , H , j , p , Ref} = {P}_{P , H , j , p} / {U}_{P , H , j , p}$$

where S_{P,H,Comp,j,p}=compensated historic restoration sustainability for historic damage variable j for product p
where U_{P,H,j,p}=historic damage impact for variable j assigned to product p
where P_{P,H,j,p}=restoration applied to historic damage variable j for product p

Alternatively, the amount of restoration applied to the product 1 can be calculated on a per dollar basis as:

$${P}_{P , H , \$ , j , p} = {P}_{P , H , j , p} / {C}_{p}$$

And the historic restoration sustainability for historic damage variable j can be calculated from the per dollar amounts as:

$${S}_{P , H , Comp , j , p} = {P}_{P , H , \$ , j , p} / {U}_{P , H , \$ , j , p , Ref}$$

This sustainability can be labeled compensated, since no upper limit is set to the amount of historic restoration applied. The historic restoration sustainability for products 1 and services 2 could be set to >100% in order to boost the individual sustainability of individuals 4 buying the product. The intrinsic historic damage sustainability is calculated by limiting the use of conservation applied to historic damage variable to the required amounts and thus to 100%:

S_{P,H,Intr,j,i}=MIN(1,S_{P,H,Comp,j,p})
where S_{P,H,Intr,j,i}=intrinsic historic restoration sustainability for historic damage variable j for product p

### Combining Sustainabilities

While minimization of natural EH resource use and damage impacts and maximization of conservation impacts are especially important for all EH impact groups, there is a single EH impact group that in particular trumps all other groups in importance: biodiversity protection. Life on Earth will become increasingly more difficult and ultimately impossible unless all variables in all other EH impact groups are optimized to maximize the remaining biodiversity.

EH sustainability values can reflect an individual or a product 1 or service 2 with respect to sustainability and/or humane conditions for a single or for a combination of EH impact variables. Sustainability values can be first calculated per metric impact variable and then combined per metric impact group. Sustainability values for use and damage and their associated conservation variables in particular need to be combined by simple multiplication, as shown earlier for each use and damage variable and the corresponding conservation. When combining sustainabilities representing different variable types (allowance, current and historic damage) within the same metric group, the use of weight factors or other methods may be needed to reflect their relative importance.

Sustainabilities for multiple metric groups can be combined in a single value by using a combination of weighted averages, geometric averages and exponential geometric averages. For weighted and exponential geometric averages, the weight factors and exponents for each of the variables are used to give appropriate weights to each variable, such that these best reflect the natural dynamics and interactions between abiotic and biotic environmental systems. In order to maximize biodiversity and quality of life, these weight factors and exponents especially need to be optimized (preferably using modeling of future trajectories) such that biodiversity losses at the end of the restoration period (ages) are preferably minimized. The starting values for these weight factors and exponents are in particular not the optimum values. In turn, the optimum values are in particular to change depending on the number of metrics groups and variables implemented, the relative sustainability improvement reached and the actual trajectory followed.

For environmental impacts and their combinations, the calculated individual sustainabilities especially need to reflect the inverse number of Earths that would be required (1/E, where E=1 represents one Earth) in order to allow 100% sustainable conditions, for the case where preferably all humans would preferably live under the EH variable conditions represented by the individual.

Combined sustainability values can be limited to the variables implemented or include variables not yet implemented. In the latter case, the same estimated sustainability values for the non-implemented EH impact variables need to be used for all participants.

Sustainabilities can also be combined in particular only per type as for types A to F below and/or be selected from at least one of the following groups.
A. All minimum acceptable human conditions are met (humane condition sustainability)
B. Natural resource use is equal or less than the individual allowance (resource use sustainability)
C. Natural resource use conservation meets requirements (resource conservation sustainability)
D. No current EH damage is done (current EH damage sustainability)
E. All current EH damage done is restored (current EH restoration sustainability)
F. Required restoration of historic damage is applied (historic EH restoration sustainability)

The combined individual sustainability values will initially be very low for most people and hard to improve quickly. All sustainability improvements start with current damage prevention (D) and EH conservation. Combining all conservation based sustainabilities C, E and F in the overall conservation sustainability, would provide a sustainability that is easier to improve and therefore more appealing to use by both individuals 4 and organizations 3.

Product sustainabilities can be combined in similar ways as proposed for individual sustainabilities. Combining all sustainability types would lead to a very wide distribution of product sustainability values, ranging from very unsustainable to very sustainable. However, most rated products 1 and services 2 would be non-sustainable. In addition, a relative product sustainability value comparing sustainabilities for each product 1 or service 2 to “best in similar class” products 1 or service 2 would make the selection of more sustainable products 1 and services 2 much easier and stimulate both the marketing and selection of such more sustainable products.

While all EH-impacts and sustainability values for products 1 and services 2 would be listed in publicly available product data sheets, a much more limited amount of sustainability information would be printed on product packaging to facilitate comparing similar products 1 and services 2 during shopping and would be standardized world-wide at any given time.

The overall formulas for individual and product sustainability, with the weight factors and exponents optimized to maintain the highest biodiversity, can be used by all organizations 3 to evaluate the most sustainable path forward. It would allow optimization in timing and amounts of investments between different sustainable objectives (minimizing cultivated area use of buildings by using more floors, versus changes to carbon neutral systems or minimization of water use and erosion). Since higher sustainabilities are associated with lower costs, such overall formulas also allow calculation of the lowest cost path to the most sustainable future of organizations 3 and societies.

### Providing Conservation as Title to Conservation (TTC)

There are in particular three processes to increase sustainability:
A. Sustainability improvement by:
a. continual reduction of current damage leading to its (essential) elimination and/or
b. reduction of natural resource use in excess of allowances (to below reference values) and/or
c. applying 100% conservation of natural resources and/or
d. applying 100% restoration of historic damage
B. Sustainability improvement by:
a. applying 100% conservation of natural resources while maintaining excessive resource use and/or
b. applying 100% restoration of historic damage while maintaining current damage
C. Sustainability “improvements” without meeting sustainability requirements (the current process used)

Under option C, the world in racing towards an increasingly lower overall sustainability.

Options A are a combination of preventive and net restorative measures, while options B are particularly only corrective measures not leading to improvements and thus leading to continual deterioration. In essentially all cases, preventive measures under A represent lower costs than corrective measures under B.

Measures A are needed to allow return in particular to pre (year) 1750 environmental conditions. Since preventive measures represent lower cost and have less or no capacity limits, preventive measures should be selected preferentially. Since we cannot switch overnight from the current option C to options A, options B will need to be applied, especially during the transition period where options A are not sufficiently available.

Units of various types of conservation can be purchased (in the future), where the EH conservation is or will be implemented in the field, but where the “title” to the payment of the conservation can be put in the name of the individual paying for it. Such “Title to Conservation” (TTC) can be sold by the organization 3 providing protection and/or restoration. TTCs need to be purchased from an EH conservation fund organization 3 (ECFO). TTC can be purchased by anyone interested in owning such title (e.g. TTC for restoration of 1 Ha of biodiverse land, or TTC for sequestration of 1 ton of carbon dioxide). All types of TTC can be purchased in any fractional amount of conservation and paid for in any fractional amount of money. After purchase of TTC, the total costs paid by a participating consumer can be the same as would be paid by a non-participating consumer buying the same product from the same vendor (not applying any conservation) at the same time.

TTC can be purchased and held in an account until needed and applied at a later time. TTC can be applied by assigning TTC to an individual (self) or to a product. Once applied, TTC cannot be “un-applied”, re-assigned, or re-sold. TTC applied to a product 1 travels with the product 1 until consumed by an end-user consumer, at which time the title to conservation (TTC) is permanently assigned to the consuming individual. TTC can be purchased as already available or for future delivery. In both cases the TTC purchased can be applied immediately. TTC will be made available on subscription basis, such that only the amount of TTC needed is purchased and applied immediately.

Under the Metrics, EH impact variable values for protection and restoration can be calculated separately. For example, wildlife area protection for its biodiversity can be valued at different but constant levels of biodiversity, while restoration only values improvements in biodiversity. Under well managed conditions, organizations 3 managing wildlife areas for their biodiversity can sell TTC for protection while separately selling TTC for biodiversity increases. TTC for protection typically represents protection for a given period, while TTC for restoration typically represents an improvement of the underlying EH-condition variables irrespective of time (e.g. permanent sequestration of 1-ton carbon).

The various organizations 3 providing TTC can be:
Human conditions protection and rehabilitation organizations 3 (HCPROs) provide TTC to protect humane conditions and rehabilitate affected individuals 4 and/or
nature protectorate organizations 3 (NPOs) provide TTC for biodiversity conservation by effective protection and restoration of wildlife areas for their biodiversity and/or
precipitation area protection organizations 3 (PAPOs) provide TTC for fresh water conservation by protection and restoration of watershed areas for water quality and amounts available to nature and/or
carbon sequestration organizations 3 (CSOs) provide TTC for protection of stored carbon and for sequestration of carbon dioxide captured from air and/or
soil and sediment conservation organizations 3 (S&SCO) provide TTC for soil and sediment protection and restoration by managing protective and restoration programs for soils and sediments and/or
coastal flooding protection organizations 3 (CFPO) provide TTC for coastal area protection against flooding of currently terrestrial areas and protection of shallow marine waters and marsh areas.

TTCs for the different forms of conservation in particular need to be sold as standardized units. For some types of conservation, the units can be easy to define: carbon dioxide sequestered can be expressed as tons of carbon dioxide (tCO₂) or alternatively as ton carbon (tC) sequestered. For other types of conservation such definition is more difficult. For those types, TTC especially must be expressed under standardized conditions and amounts. This applies to biodiversity.

Virgin wildlife areas in different ecosystems have different biodiversities, different species assemblies and different connectivity. Biodiversity values and areas of protected wildlife areas can be compared and converted to a modified sized area of reference biodiversity. Analogously, increases in biodiversity of wildlife area are also scaled to reference increases in biodiversity of a modified area.

Restorative conditions will in particular not show a continuous improvement over time, but reflect natural or manmade setbacks from time to time. Reductions in biodiversity of areas and leakage of carbon dioxide from pipelines and underground storage reservoirs over time especially must be treated as new damage done and to be restored.

Some types of conservation can provide TTC of multiple types. Organizations 3 protecting wildlife areas for their biodiversity can qualify as NPO, CSO and PAPO and sell TTC for each type of conservation.

In order to market any form of TTC, organizations 3 are preferably Metrics participants, and are more preferably certified by the Metrics organization 3 and/or monitor more preferable all relevant conditions and are particularly frequently audited by licensed IROs specialized in each type of conservation. In addition, organizations 3 providing TTC preferably have financial reserves sufficient to restore any damage done (burning or cultivating a wildlife area). In case of insufficient financial reserves, a total loss insurance is preferably required, while most of the TTC receipts will in particular be routed to an independent organization 3 to build a total loss fund.

While likely very sustainable, organizations 3 providing TTC still use cultivated area, emit greenhouse gasses and other pollutants, consume fresh water, may not provide sufficient protection against coastal flooding, and may not meet humane conditions for all employees. Except for the focus on conservation, TTC can be a product 1 or a service 2 as any other for which EH-impacts are expressed as a collection of EH impact variable values.

Currently no TTC is available and the capacity to supply TTC will only gradually increase over time with increasing demand. Likely TTC will be in short supply during most of the EH restoration period.

### Financial Transactions

Removing EH-Liabilities from Financial Accounts and Payments

In our current system the buyer does preferably not knowingly accept the financial liability for the environ-human (EH) impacts that come with the product 1 or service 2 bought. Since no agreements on such liabilities are made, the EH impacts of money used for payment are in particular undefined. This can change when agreements with respect to EH liabilities are made. If it is agreed that damaging EH impacts represent a financial liability and that money used for payment of a product 1 accurately reflect all aspects of financial value of the product 1 sold, then all EH-liabilities can be reflected in the money used for payment. Under those conditions, all payments received reflect the EH-impacts and thus EH liabilities of products 1 and services 2 sold. The same especially applies for savings made.

When users further agree that EH impacts can only move in consumer direction, money used for payments moving in the opposite direction especially must be free of EH impacts. When damaging EH impacts represent a financial liability, then conservation impacts must represent a financial asset. The combination of the two agreements leads to conditions where the actual price paid for a product 1 or service 2 can be equal to the asking price corrected for the value of the EH assets and liabilities that come with the product. Currently, in almost all cases the net sum of EH assets and liabilities represent a net EH lability. Under the Metrics, participants accept such conditions as part of the participation agreement. The seller of a product 1 or service 2 can have two choices:
A. Remove the financial liability by paying for the corresponding title to conservation (TTC).
B. Accept a price reduction equivalent to the cost of the corresponding TTC.

In case B the seller “kicks the can down the road”. The buyer pays a lower price but takes over the financial liability. When the buyer further agrees to buy TTC corresponding to the EH-impacts of the product 1 purchased, the price discount (conservation withholding or CW) is used in full to buy the required TTC. As a further agreement between participants, participant sellers agree to charge the same non-corrected list price (NCLP) to all participant and non-participant buyers and publish the NCLP for each item for sale on day D on the previous day (D−1).

Under the Metrics, EH impacts of transfers between participants are in particular only allowed to move in end-user direction. Payments between participants preferably must be free of EH impacts and especially originate from EH impact-free financial accounts (IFFA). Such moneys free of EH impacts can only be created by paying for the cost of conservation of EH resource use and EH damage represented by the “classic” money used. Option B as listed for the purchase of products 1 and services 2, does in particular not apply to money; to remove EH impacts from money, the liabilities cannot be “kicked down the road” as for option B, but need to be removed as under option A.

In its classic use, money and assets merely can represent a monetary value. Under the Metrics system, money and assets can represent a combination of monetary value and many EH-impacts variables for which money can be a carrier and of which monetary value expressed as currency and amount can be just two variables.

However, since EH-impact variables were never determined for classic accounts and since classic accounts have no account features to store such EH-impact variable values, classic accounts do not have the required properties to allow the use of sustainability-enabled transactions.

To start the process of fund conversion, the EH impacts of moneys and assets held in classic accounts must be quantified by an impact rating organization 3 (IRO). Following this step, a fraction or all the money/assets in the account, now with known EH impacts, can be moved to impact rated financial account (IRFA). The monetary value of money or assets with nonzero EH impacts and free of EH impacts can be respectively referred to as the non-sustainable asset value (NSAV) and sustainable asset value (SAV).

The monetary value and EH-impacts for money and assets can be expressed as a collection of elements A={a, b, c, . . . zz}. Members a and b of A can be envisioned as the currency and denomination/amount used, while the remainder of the members of A are the various metric impact variable values representing EH damage and EH assets. Collection of elements A can thus be used to calculate the EH impacts.

The per dollar cost to remove EH liabilities from money and assets can be calculated by dividing the global cost of conservation (reflecting all historic EH damage) as needed to return to year 1750 conditions by either the value of all money in circulation or by the value of all global assets. Depending on choices made, this corresponds to about 2% for the total of all assets to 4% for all money in circulation.

The cost of title to conservation (TTC) for the various types of conservation will in particular vary over time and can be represented by a collection of elements C={α, β, γ, . . . , ω}. Collection of elements C can thus be used to help calculate the costs of EH liabilities represented by the EH impacts calculated from A.

Herewith, an example is given: Collection of elements A can be used to calculate the environ-human (EH) impact of a financial account holding $5000 to be 2 ton carbon dioxide (=2 tCO₂). When collection of elements C lists the current cost of carbon sequestration as $100/tCO₂, then the EH liability for a $5000 account with a 2 tCO₂ impact is calculated as $200.

The EH liability can represent the conservation cost that must be applied to render money or assets free of EH impacts. These withholdings are referred to as account conservation withholdings (CW_{Account}) and can be calculated as a function of collections of elements A and C:

CW_{Account}=f(A,C).

While EH-impacts of money or assets can represent both EH damages (EH liabilities) and EH assets (EH conservations), at this stage EH-impacts almost exclusively represent EH liabilities. In most cases the last term in the following equation is zero.

$${CW}_{Account} = Sum {( EH liabilities )}_{Account} + SUM {( EH Assets )}_{Account}$$

In order to remove the EH impacts from the account, TTCs need in particular to be purchased from an EH conservation fund organization 3 (ECFO) for the amount equal to the conservation withholding (CW_{Account}) and applied to the non-sustainable money or assets. After transfer of the CW_{Account} to the ECFO, the remaining funds are preferably free of EH impacts and are preferably transferred to an impact-free financial account (IFFA). Since the CW_{Account} in this case represents a financial liability, it has a negative value. The ECFO is contractually (and therefore legally) in particular obligated to spend the funds received on the specified conservation. The sustainable asset value (SAV) is equal to the non-sustainable asset value (NSAV) plus the account conservation withholding CW_{Account}. For financial accounts and assets in general it can be formulated:

$${SAV}_{Account} = {NSAV}_{Account} + {CW}_{Account}$$

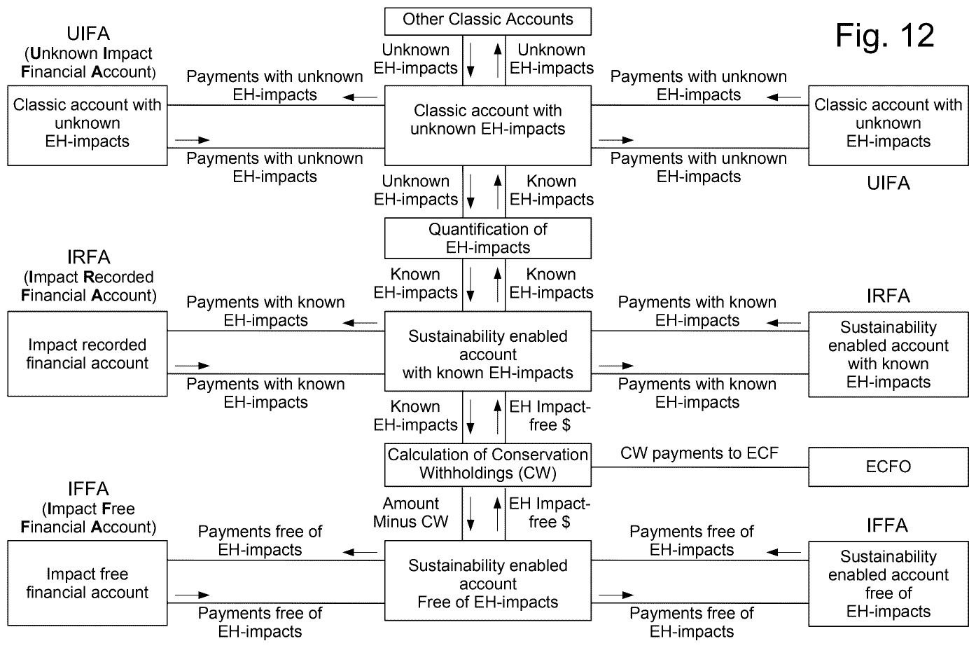

This conversion process can be carried out for each amount of money or assets that is transferred from a classic “non-IFFA” account to an IFFA and thus for transfers between accounts held by the same individual and for transfers from classic accounts held by others. This thus applies to salary paid by non-participating employers to participating employees and payments for products 1 and services 2 bought by non-participating customers to participating sellers. Impact rated financial accounts (IRFA) and impact free financial accounts (IFFA) can be held by Metrics Licensed Financial Organizations 3 (MLFOs). MLFOs are especially required to apply Metrics approved accounting calculation rules, which include the application of CW. IRFAs and IFFAs are both sustainability enabled financial accounts (SEFA) where the account can store all members of collection of elements A and C for each transaction. If started from a classic account, the transfer takes place in two steps, where in step one the EH impacts for the amounts to be transferred are determined (by an IRO) after which the funds (now with known EH impacts) are transferred to the IRFA. In step two the conservations are applied to amounts in the IRFA to be transferred, after which the IRFA funds are transferred to the target IFFA. A schematic of fund conversion from classic accounts to IFFA is shown in FIG. 12. Within participating networks all payments are made between IFFA and thus free of EH impacts. But even in that case the initial moneys to be used for payments need to be converted from classic to EH impact-free amounts. Producers/retailers selling to non-participant buyers are in particular paid with classic money, which especially needs to be converted to EH impact-free money. Such conversion costs do not exist for sales to participating buyers.

Organizational assets can be held anywhere and would include assets of all types: e.g. financial assets, inventory, equipment, real estate, etc. If used for the production of rated products, the EH-impacts and liabilities of the organizational assets used need to be determined and the EH liabilities need to be calculated and removed. While many assets depreciate over time, their EH liabilities appreciate due to the 2^{nd} derivative effects of EH impacts. Even for fully depreciated assets, the EH liabilities remain and appreciate on the organizational balance sheet (and on the individual's account) until converted to impact-free assets.

### Treatment of EH Product Liabilities: Paving Up or Pushing Forward

All manufactured product 1 and services 2 (MP&S) currently sold can represent a certain amount of environmental damage and inhumane conditions. These damages are referred to as environ-human (EH) damage. Since employees consume MP&S, the associated EH damage consumed but not absorbed as PSA can transfer to the labor product (labor). This damage can (at least in part) in particular be compensated by applying EH conservation. EH conservation can come in the form of protection (e.g. wildlife area protection for its biodiversity and watershed protection for water quality and amounts) or in the form of restoration. Environmental restoration examples are preferably wildlife area restoration or atmospheric restoration. In the latter case carbon dioxide is removed from the air and sequestered deep underground. Conservation can also be applied to improve human conditions. All forms of conservation in particular cost money. The more EH damage a product 1 or service 2 represents, the more environ-human (EH) conservation needs to be applied and the higher the costs. EH use and damage thus can represent a financial liability. Vice versa, EH conservation can represent a financial asset.

### Conservation Withholdings for Manufactured Product and Services

There are three different types of CW: CW_{Prod}, CW_{Labor} and CW_{Account}. Rules for financial transactions under the Metrics are based on selling products 1 and services 2 and paying salaries at 100% conservation sustainability to individuals 4. In order to sell products 1 and services 2 with 100% conservation sustainability, producers would need to buy the required amounts of title to conservation (TTC). Due to shortage of TTC, TTC will likely be rationed and products 1 and services 2 will likely be sold with some but less than the required amounts of TTC until sufficient TTC capacity is available. Since EH-impact variable values are in particular quantified for rated products and services, the financial value of both positive and negative EH impacts contributions can be calculated. EH conservations can represent positive EH impacts and are treated as financial assets while EH resource use and damages represent negative EH impacts and are treated as financial liabilities. Participants can agree (as part of the participation agreement) to sell products 1 and services 2 to participants at the non-corrected list price (NCLP) after which a correction for the value of the product conservation withholdings (CW_{Prod}) takes place. Similar conservations withholdings can be calculated for salaries paid (CW_{Salary} see below). Products 1, services 2 and labor provided by individuals 4 can be exchanged at the conservation corrected transaction price (CCTP) calculated as:

$$CCTP = NCLP + CW .$$

Participating buyer/employer pay and seller/employee can receive the CCTP. For non-participant buyers no CW can apply and buyer can pay and seller can receive the higher non-corrected list price (NCLP).

The CW for products 1 and services 2 (CW_{Prod}) is calculated from the product EH-impacts.

$${CW}_{Prod} = Sum {( EH liabilities )}_{Prod} + SUM {( EH Assets )}_{Prod}$$

For products 1 and services 2 sold, the participant buyer and seller pay and receive the CCTP_{Prod}.

$${CCTP}_{Prod} = {NCLP}_{Prod} + {CW}_{Prod}$$

For products 1 and services 2 sold to non-participant buyers in particular no CW_{Prod} is used and the buyer in particular pays and the seller in particular receives the higher NCLP_{Prod}.

Non-participating consumers can pay with money not free of EH impacts. Participating sellers receive the NCLP_{Prod} payment from non-participating consumers, which needs to be converted to EH impact free money requiring a conservation withholding CW_{Account}, calculated similarly to CW_{Prod}.

Participant sellers especially face a CW_{Prod} for sales to participant buyers, but face a CW_{Account} for the payments received from non-participant buyers. There are three aspects affecting CW_{Account} and CW_{Prod}:
a) The CW_{Prod} will reduce over time due to sustainability improvements by participating suppliers.
b) Non-participating buyers are likely to buy less sustainable products;
   resulting in payments from classic bank accounts reflecting higher CW_{Account} EH liabilities.
   uncertainties in the estimation of the average EH liabilities are also higher than these would be for participating buyers, further increasing the CW_{Account} liabilities.

Non-participants buyers can have higher estimated EH impacts and an impact uncertainty multiplier (IUM>1) can be used to multiply the estimated EH impacts represented by their payments. This results in the CW_{Account} for non-participants to be larger than the CW_{Prod} for participant. The retailer thus has higher costs selling to non-participants. Retailers may for this reason offer a price discount to participant buyers. This would be an additional inducement for participation.

As per above formula, the conservations withholdings CW_{Prod} can be turned from a (typically) negative value to a zero (or even positive) value by application of TTC. The purchase of such TTC is “essentially free” of net costs for all participants (organizations 3 and individuals 4). To maintain the “essentially free” costs of TTC, the participating employer must reimburse participating employees for all TTC purchased, as is explained in the example below.

Assume a participating employee A (working for a participating employer) has an average daily (damaging) EH impact corresponding to a $10 per day EH liability (say due to CO2 emissions). This would correspond to a daily CW_{Prod}=−$10 for the products the employee purchases. These EH liabilities are reflected in her labor output, resulting in a CW_{Salary}=−$10. The CW_{Salary} is added to her daily salary, resulting in a $10 salary withholding. To prevent a loss of purchasing power, the participating employer gives all participating employees a salary raise equal to their individual average CW. After application of the raise and the CW, all employee incomes are back to their “pre-participation” values. If the employee produces one product per day, the EH impacts corresponding to the $10 liability is transferred to product 1 produced. We further assume that the employer/producers does not add any EH liabilities to the products made. The participating consumer buying product 1 does not pay for the EH liability of the product. The CW_{Prod}=−$10 is added to the non-corrected (product) list price (NCLP) resulting in a $10 lower conservation corrected transaction price (CCTP). The consumer thus pays (and the producer receives) $10 less for the product than the NCLP.

The employee now decides to buy TTC at $10 per day and the employer reimburses the employee daily for this TTC purchase. The employee now no longer has a EH liability (CW_{Salary}=$0) and the daily product made is now also free of EH liabilities (CW_{Prod}=$0). The participating consumer does not pay for the EH liabilities and the CW_{Prod} (=$0) is added to the non-corrected list price (NCLP), resulting in a conservation corrected transaction price equal to the non-corrected list price (CCTP=NCLP). The participating customer pays and the participating producer thus receives $10 more for the product, which is the exact same amount already paid to the employee as compensation for the TTC purchased. The $10 reimbursement by the employer to the employee who purchased TTC for $10 is thus not a “gift” of the employer, but is the additional $10 amount received from a customer who bought a product (in this case) free of EH impacts. The participating consumer B is himself an employee of a participating employer and the same salary compensation and CW_{Salary} apply to him as applied to employee A.

Summarizing: Employers/producers must reimburse employees for the full amount of TTC applied because they will receive the same dollar value back from the customer buying their products. Hence there are essentially no net costs for employer/producers for application of conservation. The employee/consumer initially pays the full cost of TTC, but these costs are fully reimbursed by the employer. Hence there are essentially no net costs for employees/consumers applying TTC.

Note: The “essentially no net costs” aspect is mathematically not correct under all circumstances, since someone has to pay for the cost of conservation. Suppose, for example that there were no limits to the amount of conservation available and the entire society would start full participation on day one of Metrics implementation. In that case the average cost of EH liability corresponding to 6% of GDP would also require a spending of 6% of GDP on conservation and everybody would on average spend 6% of income on conservation. In that case there are significant costs to everybody. However, in reality there is currently no conservation available as TTC and the capacity to generate TTC will only grow slowly. In combination with an initially low societal participation, little TTC will be purchased and only by a small fraction of the population. Even in case of a 10% employee/consumer participation, applying 10% of all required TTC (due to limited availability) and 100% employer/producer participation, the product price increase needed to maintain producer's profits (due to TTC cost) is only 0.018% and essentially negligible for all practical purposes. These costs are paid by consumers, but since for the above case only 10% of consumers are participating and these 10% are more sustainable than average, almost all costs are paid by non-participating consumers. Even so, under those circumstances the “essentially no net costs” aspect is mathematically correct.

It will likely take years to reach the above sketched degree of participation. In the meantime, participating employee/consumers and producers have made investments in carbon neutral systems which earn themselves back in 5 to 10 years, resulting in significant net savings for participants much larger (by two orders of magnitude) than the 0.018% increase in product cost price. Under those conditions the “essentially no net costs” aspect remains mathematically correct even at continuously increasing societal participation.

In addition to being seen as “not needed” in the past, the cost for all types of conservation (e.g. wildlife area biodiversity protection and restoration, removal from CO₂ and NOx from cars and smokestacks) have thus far been seen as too high and “not worth their costs”. The method of providing title to conservation (TTC) essentially free of costs is novel and non-intuitive. The ability for individuals 4 and organizations 3 to buy TTC essentially free of net costs can be a surprising aspect of the inventive method and/or system.

For individual labor (by individuals 4), the CW_{Labor} especially needs to be calculated differently. In order to encourage individuals 4 to participate, individuals 4 should never pay a penalty for participation as compared to non-participant individuals 4. EH liabilities originating from employee labor can be transferred via the employer (organization 3) to the products 1 made and services 2 provided (employees provide labor and their own EH impacts). The same can apply to investors (investors provide investment money and their own EH impacts). Organizations 3 cannot become sustainable without sustainable employees and investors (both persons 4), and their participation can be the first step towards sustainability. Since participating organizations 3 greatly benefit from participating employees along their supply chain, not only must participating employees be reimbursed for the value of TTC purchased (C_{TTC}) paid, but in addition, participating employees should be reimbursed for the prevention of employee-created EH liabilities (L_{Prevented}) which would otherwise flow to their employers. For participating employees, the CW applied to their salary (CW_{Labor}) can be the sum of the CW_{Prod} withheld with purchases made, TTCs, and L_{Prevented} by the individual over the accounting period.

$${CW}_{Labor} = {CW}_{Prod} + {C}_{TTC} + {L}_{Prevented}$$

Note that CWs are typically negative values, while the values of C_{TTC} and L_{Prevented} are positive values. requiring positive signs for the latter two in the above calculation of CW_{Labor}. In case no TTC would be applied (C_{TTC}=0) an absolute value for L_{Prevented} larger than the absolute value for CW_{Prod} would turn CW_{Labor} into a positive value increasing the individual salary payment.

### Conservation Credits

Prior to any sustainability improvements (PV solar, heat pumps, electric vehicles) no savings can be claimed form such improvements. Participating producers would need to select participating suppliers in order to benefit from conservation withholdings (CW).

In particular, non-participants customers represent higher costs for the retailer than participants due to the higher account conversion costs for the classic monies use for payment (CW_{Account}>CW_{Prod}). Participating retailer would therefore prefer to have participating customers and are likely to attempt converting non-participants to become participants. In addition to offering sign-up forms to join the Metrics system, retailers will likely offer a price discount for new or all participants.

Investments in carbon neutral systems made along the participating supply chain can be paid back in 5 to 7 years, while electric cars would pay themselves back over their useful life or faster. At low interest rates and financed as loans, these investments and purchases could produce an immediate cost reduction.

If we assume that the most forward-looking producers are the already most sustainable, most technologically advanced, most efficient and most willing to participate in the Metrics, the remainder of producers form the group with the opposite of these features. This means that after the participating producers select their participating suppliers, the remainder of organizations 3 is likely to have higher costs, leading to costs increases for non-participating producers (see FIG. 4A to 5B) Consequently, during the earlier years prices may go up to some extent and participating employers could pay participating employees a conservation credit (CC):
To overcome price increases at retailers and/or
to help pay for installation of carbon neutral home HVAC system (in particular provide low interest loans to finance heat pumps and PV solar) and/or
help financing electric cars (in particular provide low interest loans) and/or
pay reimbursements for pass-through EH liabilities which the employer avoids (L_{Prevented}).

Employee reimbursements for pass-through environ-human (EH) liabilities avoided (L_{Prevented}) should be continued for a number of years to shorten the pay-back time of the carbon neutral systems installed/purchased. In addition to the conservation credits received, the employee has lower cost using the carbon neutral systems compared to their fossil fuel alternatives.

The cost of conservation is in part paid by non-participating consumers and for the remainder paid out of cost savings from investments towards carbon neutrality.

### Availability of Conservation

### Ample TTC Availability:

In case of ample availability of title to conservation (TTC), all products 1 and services 2 originating from participating organizations 3 can be processed through the above metrics process. Producers could apply all required conservation to sell their products 1 and services 2 at 100% conservation sustainability, in which case no additional TTC would need to be purchased by consumers to compensate for any EH impacts for these products and services purchased. Participating consumers would still need to buy TTC to compensate for private LBIs, like CO₂ emissions from privately owned systems not yet converted to carbon neutrality (as well as for all other EH damages) and for use of natural resources not already covered by products

However, where organization would not apply sufficient amount of conservation to render products 1 and services 2 sustainable, consumers would need to apply the required remaining amounts of conservation to consume the products sustainably.

If the TTC is made available exclusively through individuals 4, TTC will be purchased by individual consumer only. In that case, the only way organizations can apply significant conservation to their products 1 and services 2 is through high employee participation.

### TTC in Short Supply:

At the time of filing of the present application, TTC is an inventive theoretical concept, since it does not yet exist. Even after actual creation, TTC is preferably likely to be in short supply throughout most of the EH restoration period and especially so in the case of a rapid Metrics implementation. Since purchase of TTC allows individuals 4 to be (more) sustainable, access to TTC must be given to all. In case of high demand, this may require rationing of TTC over the participating world population and organizations 3. Purchase of TTC to restore (particularly historic) EH damage done is thus limited to availability. The balance of CW (for which insufficient TTC is available) will be experienced as a combination of product price discount and salary withholding. This combination does in particular not lead to a net change in spendable income since the lack of TTC purchased will reduce CW_{Labor} to the same extent as CW_{Prod}.

### Method for Automatic Application of Conservation as a 2^{nd} Purchase

The price correction (also called “conservation withholding” or CW) as applied to each product and salary mostly can represent EH resource use and net EH damage done and thus an EH liability. As per participation agreement, the CW can be used in full for the purchase of conservation (as TTC) as a 2^{nd} purchase automatically and immediately following the 1^{st} purchase. The title to conservation (TTC) can be purchased in the amounts needed to match the EH usage and damage for each metric impact group (but limited to TTC availability). This can apply to the EH conservation as needed and can remove the EH impacts from the product and thus physically “transforms” the product. Application of TTC can remove (or can reduce) the EH damage done and may render EH resource use sustainable. In early stages of implementation, TTC will in particular be in short supply. TTC supply shortages are particularly likely to continue for most of the environmental restoration period, especially for carbon dioxide sequestration and wildlife areas & biodiversity restoration.

Access to TTC preferably needs to be rationed and requirements for application of “full conservation” will be limited by supply for some types of conservation. The requirement of automatic application of conservation as a 2^{nd} purchase immediately following any 1^{st} purchase, limited to availability of conservation, can allow use of the full global EH conservation capacity available at any given time along the growth curves. This in turn can allow the fastest possible (in particular exponential) growth of such global conservation capacities.

### Trading of Unused Resource Use Allowance Fractions

Allowances for use of natural resource can be per capita values and can be thus the same for all adult individuals 4. The world's rich use more than their individual allowance, while the world's poor may use less than their individual allowance. While the poor could live very sustainably with respect to resource use, they may do so living under inhumane conditions. These differences would continue even in on average sustainable societies. The situation can be improved by exchanging unused allowance fractions between rich and poor. In this case the unused fraction of resource use allocation assigned to the low income individual can be sold to a higher income individual who desires to increase his/her individual allowance for the specific variable to become more sustainable. For all ensuing calculations, the resource use allowances for the seller are reduced and for the buyer are increased by the amount traded. The objective would be to set the price of an annual complement of individual allowances equal to the global annual per capita income (or the same expressed in smaller increments for each allowance variable). A low-income individual selling half his complement of individual allowances would in that case receive half the global per capita income. This would essentially eradicate global poverty. Prices for an annual complement of individual allowances lower than the global per capita income would also work and would especially be needed to start the trading system. Note that the lower income individual desiring to trade unused allowance fractions must live sustainably on the natural resource variable in order for the unused allowance fraction to be sustainably available. This requirement to live sustainable in order to receive significant income, would create a demand for sustainable products 1 and services 2 at the lower end of the income scale, where consumers otherwise would only be interested in day-to-day survival.

In order to trade unused fractions of allowances, unused allowance trading organizations 3 (UATOs) can be participants, and are preferably certified by the Metrics organization, can more preferably monitor all relevant conditions and/or can be frequently audited by licensed impact rating organizations 3 (IRO).

The demand for buying unused allowance fractions would be strongly stimulated by implementation of sustainability-based taxation. This would work especially well when the tax savings due to higher individual sustainability would be larger than the costs of the unused allowance fraction purchased.

### Sustainability-Based Taxation or Taxation Alternative

Classic taxation can be mostly based on reported income, property value and value of purchases. In the US, in particular about 12% of GDP is estimated to go unreported over which no income taxes are paid. Complicated tax laws and tax loopholes further facilitate tax evasion especially for businesses and higher income earners.

Under current taxation systems, taxes paid can be independent of the sustainability of the product purchased (for sales tax) or the sustainability of spending of the income earned (income tax). Once the EH impacts and the sustainability of products can be measured and the non-sustainable product fraction can objectively be determined sales and income tax could be levied only over the non-sustainable fraction of product price and salary. Since essentially all products are in particular unrated and thus will particularly start with 0% product sustainability, the tax revenues will in particular remain initially unchanged. Such a sustainability based taxation (SBT) system would provide a strong incentive for changes towards sustainability. As an alternative to government taxation, the Metrics organization could levy a sustainability based charge, in an overall (per country) revenue neutral system where the proceeds can be used to help consumers to install carbon neutral or otherwise more sustainable systems (e.g. through low or no-interest financing).

The detailed accounting resulting from a metrics participant's location-based impacts (LBIs such as lot size, emissions, water and material extractions) and purchases made, allows generation of accurate income statements that could be used for purpose of taxation. In addition, all individual spending is recorded including the sustainability of all products 1 and services 2 bought. This combination of accurate data on income and the sustainability of spending, particularly allows the introduction of sustainability-based taxation (SBT). SBT is particularly taxation based on the sustainability of products 1 and services 2 purchased (sales tax), overall income earned and spent (income tax) and location-based impacts (property tax). The larger tax basis especially allows a lower tax rate for the same tax revenues. Under SBT, initially only the non-sustainable product fraction is in particular taxable, where the non-sustainable product fraction is in particular calculated as 100% minus the product sustainability percentage. A 100% sustainable product 1 would preferably not be taxed at all, while a 25% sustainable product 1 has a 75% non-sustainable fraction and would preferably be taxed at 75% of the standard sales tax rate. The same would preferably apply for income tax based on the sustainability of income spent. Since all products 1 and services 2 start preferably with a zero percent sustainability rating, all products 1 and services 2 can initially have a 100% non-sustainable fraction and can be fully taxable. The same would apply to the spending of income, where income tax could be levied over the non-sustainable fraction of income spent. The latter would result in the same tax revenues under current tax systems anywhere, but would provide a huge incentive to become sustainable. If the average product sustainability would increase by 1% each year, the tax rates would need to be increased by 1% annually to maintain tax revenues, further increasing the incentive to become sustainable. This tax increase only applies to the non-sustainable product 1, service 2 or income spending fraction.

Sustainability-based taxation would be the only tax where consumers could choose how much tax to pay, since the tax amount paid depends on their individual sustainability. By changing quickly to a carbon neutral lifestyle, eliminating EH-damage done, and buying unused EH resource-use allocations where needed, motivated individuals 4 could preferably choose to pay less taxes. Such a legal and intentional tax scheme would in particular encourage others to do the same and greatly benefit global sustainability and human conditions.

An in particular alternative SBT could be implemented on an overall cost neutral exchange basis. In this case fees are in particular charged to participants by a non-profit (a charity set up by the Metrics organization) similar to the sustainability-based taxation scheme discussed above. Participants are then reimbursed for a fraction of costs paid for carbon neutral systems and products, such that the overall accounting is preferably revenue and cost neutral. Sustainability-based user fees could be used to help participants or entire participant communities. Funds could be used to provide low interest loans to finance carbon neutral systems or to build sustainable buildings. Such participant-based taxation alternatives could greatly accelerate the rate of change toward a sustainable society.

### Phased and Controlled Implementation

Many of the organizations 3 needed to use the Metrics system do at the time of filing of the present application not yet exist at all or not in the form needed. The same in particular applies to procedures and software needed. A phased implementation is in particular needed at multiple levels. Implementation will preferably start with the use of only a few environ-human (EH) impact variables and is likely to expand in phases with one or two variables at a time once the groundwork (new organizations 3, methods, software and oversight) for these additional variables is laid. Due to the likely shortage of the various forms of conservation during most of the environmental restoration period, not all conservation can be applied as needed immediately following all purchases. Of all types of conservation needed, carbon (C) sequestration from air can represent by far the largest costs while essentially no capacity is currently available. In absence of attempts to reduce current carbon (C) emissions, the costs of C-sequestration would correspond to 5 to 6% of global GDP, using a nominal price of $100 per ton of CO2 sequestered. For the average retail organization 3 this preferably translates to 5 to 6% of revenues. Investments made in carbon neutral systems would reduce these energy related costs by half and in particular would be earned back in 5 to 7 years.

In case all historic C-emissions would be sequestered over a 50-year period, this would in particular represent additional costs of 5 to 6% of revenues. With scale-up of C-sequestration these costs are likely to come down. Under the Metrics all title to conservation (TTC) for C-sequestration applied by an individual will first be applied to current damage. With shortage of C-sequestration capacity, this means that none of the historic C-emission can be sequestered until large global C-emissions reductions take place. This in turn means that the requirement for C-sequestration of historical C-emissions can be delayed to a later phase.

In addition, the requirements to reach 100% conservation sustainability could be temporarily reduced to meet conservation capacity. These two control measures would reduce both the cost of reaching 100% conservation sustainability but also reduce the incentive for change to a carbon neutral and otherwise sustainable society. In turn, when conservation capacities and consumer demand warrant this, the control measures could be adjusted to require more conservation closer to the theoretical requirements and phase in C-sequestration of historical emissions earlier. The latter would increase the costs reaching 100% conservation sustainability but also increase the incentives for rapid implementation of carbon neutral systems and otherwise sustainable practices and increase the investments made in C-sequestration, leading to a faster return to environmental pre-industrial conditions.

In the following concepts and/or advantages are described which can be realized independently or together due to the inventive method or the inventive system:

Assigning EH Impacts Resulting from Inhumane Living and Working Conditions as a Non-Separable Part of Individual Labor

While valued as important by an increasing fraction of the consuming public, inhumane working and living conditions (including all aspects of humane conditions and human rights) are thus far not quantitatively or qualitatively valued as part of the labor provided. As part of the invention, employee human conditions will preferably be expressed and included quantitatively or qualitatively as EH impact variables of the labor inputs to the PSCS.

The concept, that all humane condition impacts collected as part of an individual's labor and living conditions can be defined and can be treated as an integral part of the individual labor produced, can be an essential inventive concept

Definition, measurement, improvements and rehabilitation of human conditions, resulting from inhumane treatment of workers, or from the individual consumption of products using such labor, can be an essential inventive concept.

Assigning EH Impacts Resulting from Non-Sustainable Individual Consumption as a Non-Separable Part of Individual Labor

Non-sustainable aspects of individual consumption (e.g. too much use of cultivated area and watershed area, loss of biodiverse wildlife areas, pollution, carbon dioxide emissions and the existence of inhumane conditions) are in particular in large measures not recognized as such and can be otherwise accepted as an undesirable but thus far unpreventable consequence of living one's life.

The concept, that all EH impacts collected by an individual as part of consumption can be defined and can be treated as an integral part of the individual labor produced, until such damaging impacts can be removed through the application of conservation, can be an essential inventive concept

As the central principal of the Metrics invention, all EH impacts of individual labor are preferably defined as part of that labor, and remain so until removed through the application of conservation. EH impacts can be assigned per EH impact variable for each metric impact group. Definition and treatment of all EH impacts, resulting from individual consumption and other actions, as an integral part of the individual's labor output until their removal by application of the corresponding conservation, can be an essential inventive concept.

Assigning EH Impacts Resulting from the Production of a Product as Non-Separable Part of the Product

While a product 1 or service 2 in its current definition as merely an item offered for sale that can serve a function, under the invention products and services can be carriers of environ-human (EH) impacts until such impacts are removed. Unless removed, the EH impacts are transferred to the consuming products (in manufacturing) or to the consuming individual. Under the invention and from a sustainability point of view, products 1 and services 2 can be merely temporary storage vessels for EH impacts (both damaging and conserving).

Non-sustainable aspects of products 1 and services 2 can be generally accepted as an undesirable but thus far unpreventable consequence of the manufacturing of products and services. However, such acceptance can only exist on an aggregate level, with little association to particular products. The concept, that all EH impacts created for a product along the supply chain can be an integral part of the product until such damaging impacts can be removed through the application of conservation, can be an essential inventive concept.

As a central principal of the Metrics invention, all EH impacts of a product made can remain part of the product, until removed through the application of conservation. EH impacts can be assigned per EH impact variable for each metric impact group. Such a definition and systematic assigning of EH impacts to all good & services and their treatment as an integral part of the product until their removal can be an essential inventive concept.

### Organizational Sustainability

### Introduction

Under the Metrics, natural resource use, current damage and historic damage for all products 1 and services 2 can be expressed per dollar price paid. For 100% sustainable products and services, the natural resource use per dollar is in particular low, while the current damage per dollar must preferably be zero. Some products and services, based on the production process used, can require a high use of natural resources and create large amounts of damage when expressed per dollar cost. Compared to (per definition 100% sustainable) reference products and services, products and services with high use of natural resources and large current damage per dollar sales price are in particular non-sustainable. Beef, lamb and mutton, which their very high cultivated area use, water use and methane emissions and fossil fuels with their very high carbon dioxide emissions per dollar price paid are examples of (very) non-sustainable products. The service 2 of providing access to golf courses with typically very high cultivated area use, water consumption and pesticide use, is an example of very non-sustainable service.

How can the organizational sustainability for non-sustainable products 1 or services 2 be expressed? One simple option would in particular be to calculate the (sales) weighted average sustainability of all products produced. In that case, for organizations 3 making a mix of products, the resulting average organizational sustainability might still look favorable. However, this particular calculation would make a farmer producing beef non-sustainable irrespective of how hard the farmer would try to live and produce sustainably. Sustainability improvements are possible everywhere and in particular on farms. Without an incentive to improve, no improvements are in particular likely to take place.

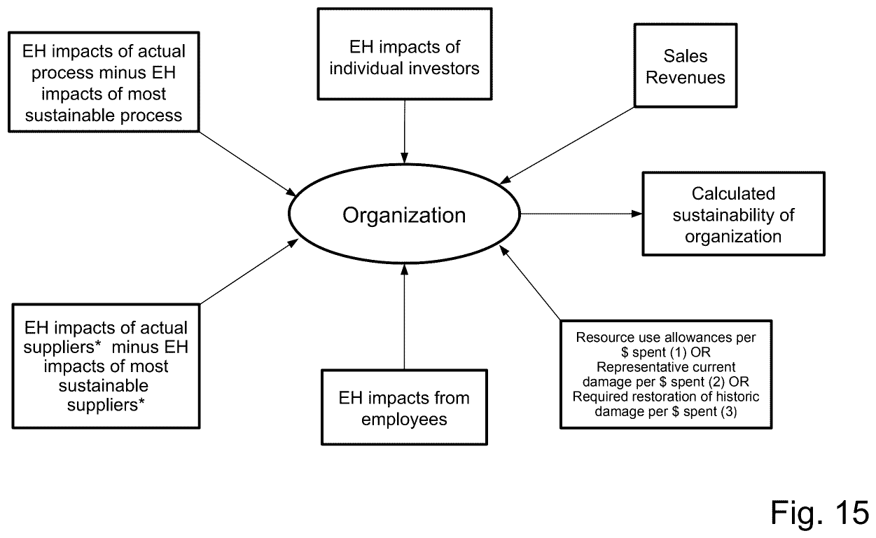

A schematic view of the sustainability or the influences of the sustainability of an organization 3 is shown in FIG. 15. FIG. 15 shows that several impacts each have an influence on the organization 3 and/or the sustainability of the organization 3. The arrows symbolize which ones have an influence on the organization 3 and which influences can be used to calculate the sustainability of an organization 3.

### Aspects of a Sustainable Organization

As an example, in the following the (relatively) simple case of a family farm should be discussed. As the owner of his own business, the farmer can control not all but still quite a few aspects of his organization. Listed in order of decrease level of control (by the farmer), the aspects to evaluate with respect to organizational sustainability are in particular:
A. Farmer sustainability (Does the farmer-owner live sustainable?)
B. Process sustainability (Does the farm operate his farm in the most sustainable way?)
C. Employee sustainability (Do his employees live sustainable?)
D. Supplier sustainability (Are the most sustainable suppliers selected?)

The farmer-owner is preferably in full control of his own EH impacts and any EH impacts represented by his own labor (labor product) are preferably inputs to his organization. It has to be noted that the farmer owning his farm in particular translates to investors owning shares in businesses in general. Under the Metrics, supplies to a PSCS in particular include all services, including financial services providing investment capital. Since for the calculation of organizational sustainability, the EH impacts from owners/investors will in particular be treated as a separate group, they are no longer included under supplies. To indicate this difference, supplies excluding investor services (and their suppliers) are in particular indicated using an asterisk as in supplies* (and suppliers*).

While not in full control, the farmer can preferably persuade his own employees to participate; EH impacts represented by the labor product of his employees are preferably also inputs to his organization. The farmer has less influence over his suppliers, but he can select the combination of most sustainable suppliers available for products 1 and services 2 needed. The difference of EH impacts of his actual suppliers used and the “best” (most sustainable) suppliers are used as inputs to his organization.

Limited to the range of process options used for his type of production, the farmer is also in particular in full control of the processes used to operate his farm. The difference of EH impacts of his actual process used and the “best” (most sustainable) process that could be used, should be inputs to his organization. This is a more complex aspect.

If the farmer would simply maximize crop yields irrespective of sustainability aspects, pesticide and fertilizer use would in particular reduce soil structure, soil biodiversity and reduce above ground biodiversity. Simple crop yield maximization might also in particular lead to unsustainable water consumption and soil erosion. Variables relevant for an agro business are in particular:

### Location Based Impacts (Direct LBI):

Deforestation/landscape change and reforestation of sections.
Carbon storage/release of lands (combination of CO2, Methane, NOx).
Carbon and nitrogen emissions from use of fossil fuels.
Soil and surface water acidification and/or abatement, restoration.
Total land area used for farming/commercial forestry.
Total area used for buildings, roads and other infrastructure (catch basins).
Land areas set aside for natural nitrogen fixation.
Land areas/strips bordering crop fields planted with wildflowers and other plants to increase habitat areas for insect, birds and any species facing habitat declines.
Other land areas set aside to protect or restore biodiversity.
Techniques used to reduce/prevent soil erosion (catch basins, forest strips).
Techniques used to improve soil amount, structure and soil biodiversity.
Techniques used to reduce water consumption (catch basins, pumping surface water underground for storage, soil improvements).
Provide cultivated areas as safe wildlife corridors.
Tilling prevention applied (erosion minimization).
Growing climate and soil appropriate crops (water consumption, pesticides, fertilizer).
Amounts, frequencies and types of pesticides used (and their effects on soil and above soil sustainability).
Use of water treatment systems for animal sewage.
Use of water treatment systems for surface runoff water (pesticides, fertilizer).

### Efficiency of Using Supplies (Indirect LBIs)

Fraction of fertilizer retained by crops and soil
Fraction of pesticide effectively used
Water pollution caused by inefficient fertilizer and pesticide use
Efficiency of net amounts of water used (pumped water is treated as a supply)

For a classic chemical process “optimum process conditions” can be defined as the conditions with least byproducts, best internal recycle of materials, highest yield, best emission prevention, least harmful emissions to air, water and soil, lowest energy use, lowest water use, while providing the required quality. “For participant organizations “optimum process conditions” can be redefined as the most sustainable process providing the required product quality.”

It is clear that the same applies preferably to other processes, like agriculture (and essentially all others).

As for (non-natural) chemical processes, where optimum conditions vary strongly with the chemicals produced and the process selected, the most sustainable conditions for (cultivated biochemical) agricultural processes will vary strongly on the crop produced, the soil conditions and the climate where the crop is grown.

The variables listed above are only an example. Biologists and agricultural scientists will need to develop the most appropriate set of variables and determine optimum values or ranges to minimize damaging EH impacts and operate under the most sustainable conditions. The above list is essentially the same list of location based impacts used to calculate all LBIs for products 1, services 2 and persons 4 as well as the corresponding sustainabilities and can be expanded with additional sources of LBIs. While used here in an example for a farm, the evaluation of type and magnitude of LBIs is preferably essentially the same for all organizations 3. In particular, it has to be noted that in addition to the reduction of damaging EH impacts of all inputs to all PSCS of products made by the organization 3, the organizational sustainability can in particular only be improved indirectly through the reduction of damaging EH impacts and through the application of TTC by employees, investors (both persons 4) and/or TTC applied to resources used for products 1 made and services 2 provided.

### Calculation of Organizational Sustainability

The EH impacts assigned to an organization over a defined period t are:

$${U}_{Org} = {U}_{Org , Lab} + {U}_{Org , Inv} + Δ {U}_{Org , {Sup}^{*}} + Δ {U}_{Org , Proc}$$

| | | |
|---|---|---|
| where U_{org} = | sum of all EH impacts assigned to the | [IU/t] |
| | organization over period t | |
| where U_{org, Lab} = | EH impact contribution originating from | [IU/t] |
| | employee labor over period t | |
| where U_{org, Inv} = | EH impact contribution originating from | [IU/t] |
| | investors over period t | |
| where ΔU_{Org, Sup}* = | EH impact contribution originating from | [IU/t] |
| | suppliers* (difference of actual and most | |
| | sustainable) over period t, | |
| where ΔU_{Org, Proc} = | EH impact contribution originating from | [IU/t] |
| | processes used (difference of actual and | |
| | most sustainable) over period t, | |

All EH impacts are calculated over the same defined period and expressed in the specific units for each specific impact variable. Individuals 4 can have different sources of income. For these calculations all sources are divided over two groups; income from labor provided to the employer and income from investments.

$${C}_{Ind} = {C}_{Empl} + {C}_{Inv}$$

| | | |
|---|---|---|
| where C_{ind} = | total individual income earned over period t | [$/t] |
| | (all sources) | |
| where C_{Empl} = | individual labor income earned over period t | [$/t] |
| where Cᵢₙᵥ = | individual investments income earned over | [$/t] |
| | period t | |

Investments made by individual investors are often forms of indirect spending, where the direct spending is carried out by the organization buying and installing hardware and software and doing the work needed to create a profit. Moneys held in bank accounts typically pay little to no interest but are regardless treated as investments. In case of multiple sources of individual income, there are as many outflows from the (single) ISCS to as many PSCSs as there are income sources. The EH impacts to each of the PSCSs are proportional to the fraction of the income distributed to each PSCS. For each employee e, the sum of outflows from ISCSₑ to all PSCSs for all products made by the organization is calculated as:

$${U}_{Org , Empl , e} = {U}_{Ind , e} * {f}_{e} = {U}_{Ind , e} * {C}_{Empl , e} / {C}_{Ind , e}$$

| | | |
|---|---|---|
| where U_{Org, Empl, e} = | EH impact contribution of employee e to | [IU/t] |
| | evaluated organization | |
| where U_{Ind, e} = | total of impacts of individual e (to all | [IU/t] |
| | organizations) | |
| where fₑ = | income fraction paid by organization to | [ ] |
| | employee e of total income received by | |
| | individual e | |
| where C_{Empl, e} = | salary paid by organization to individual | [$/t] |
| | e of E | |
| where C_{Ind, e} = | total income of individual e of E | [$/t] |

Note that “IU/t” stands for impact units over period t. The EH impacts used for all individuals 4 are in particular the labor outputs of their ISCSs to the PSCS corresponding to the value of the financial transaction but irrespective of the type of paying organization 3. For example, if an employee has two jobs earning $15,000 (employer 1) and $5,000 (employer 2), of all employee labor output EH impacts % are inputs to the organization of employer 1 and 4 are inputs to the organization of employer 2. The organizational impact representing all employee payments is calculated as the sum of all individual employee impact contributions:

$${U}_{Org , Lab} = {\sum }_{e = 1}^{E} {U}_{Org , Empl , e} = {\sum }_{e = 1}^{E} {U}_{Ind , e} * {f}_{e}$$

where U_{Org,Lab}=EH impact contribution of all employees E to evaluated organization [IU/t]

The same applies to investors; if the profits paid out by organization 1 are $10,000 for a total income of $40,000, 25% of all EH impacts of the investor's labor product are inputs to organization 1.

$$\text{?} = {U}_{Ind , i} * {f}_{i} = {U}_{Ind , i} * \text{?} / {C}_{Ind}$$

$$\text{?} \text{indicates text missing or illegible when filed}$$

| | | |
|---|---|---|
| where U_{Org, Inv, i} = | EH impact contribution of investor i | [IU/t] |
| | to evaluated organization | |
| where U_{Ind, I} = | total of impacts of individual i of I | [IU/t] |
| | (to all organizations) | |
| where fᵢ = | fraction of individual income paid by | [ ] |
| | organization over total individual | |
| | income received | |
| where C_{Inv, i} = | individual profits paid by | [$/period] |
| | organization to investor i of I | |
| where C_{Ind, i} = | total income of individual i of I | [$/period] |

The organizational impact representing all profit payments is calculated as the sum of all individual investor impact contributions:

$${U}_{Org , Inv} = \text{?} * {f}_{i}$$

$$\text{?} \text{indicates text missing or illegible when filed}$$

For supplies used, the sustainabilities of the actual supplies* are compared with the sustainabilities of the most sustainable supplies* available.

$$Δ {U}_{Org , {Sup}^{*} , s} = ( {U}_{S , s , Actual} - {U}_{S , s , Best} )$$

difference in EH impacts for actual versus

| | | |
|---|---|---|
| where ΔU_{Org, Sup*, s} = | most sustainable available supply* s | [IU/t] |
| where U_{S, s, Actual} = | EH impacts of supplies* for actual | [IU/t] |
| | supply* s | |
| where U_{S, s, Best} = | EH impacts of supplies* for most | [IU/t] |
| | sustainable available supply* s | |

The overall supplier impact contribution is calculated by calculation the sum for all S supplies*

$$Δ {U}_{Org , {Sup}^{*}} = {\sum }_{s = 1}^{S} Δ {U}_{Org , {Sup}^{*} , s} = {\sum }_{s = 1}^{S} ( {U}_{S , s , Actual} - {U}_{S , s , Best} )$$

| | | |
|---|---|---|
| where U_{S, s, Actual} = | EH impacts of supplies* for actual | [IU /t] |
| | supply* s of S supplies* | |
| where U_{S, s, Best} = | EH impacts of supplies* for most | [IU/t] |
| | sustainable available supply* s of | |
| | S supplies* | |

In some cases a product 1 or service 2 can be “self-provided” but equal or more sustainable than supplied by the “best” supplier. In that case the EH impacts of the self-provided product or service can be used for U_{S,s,Best}.

For some types of supplies* organizations cannot choose their supplier. This is for example the case for suppliers of governmental services paid by taxes, in which case the supplier is a national or local government. In those cases the U_{S,s,Best} will be limited to the suppliers the organization is in reality able to choose from.

For production processes used, the sustainabilities of the actual processes used are compared with the sustainabilities of the most sustainable processes available to produce the same or comparable product.

$$Δ {U}_{Org , Proc , p} = ( {U}_{Proc , p , Actual} - {U}_{Proc , p , Best} )$$

| | | |
|---|---|---|
| where ΔU_{Org, Proc, p} = | difference in EH impacts for actual versus | [IU/t] |
| | most sustainable available process p | |
| where U_{Proc, p, Actual} = | EH impacts for actual process p used | [IU/t] |
| where U_{Proc, p, Best} = | EH impacts for most sustainable process p | [IU/t] |
| | available. | |

The overall EH impact contribution for processes used is calculated as the sum for all EH impacts for all P processes used.

The overall EH impact contribution for processes used is calculated as the sum for all EH impacts for all P processes used.

$$Δ {U}_{Org , Proc} = {\sum }_{p = 1}^{P} ( {U}_{Proc , p , Actual} - {U}_{Proc , p , Best} )$$

The sum or EH impact contributions U_{Org} reflects in particular the EH impacts the organization incurred in excess of sustainable investors and employees and in excess of using the most sustainable suppliers and in excess of using the most sustainable process. The sum of these EH impacts can be called “the organization's EH impacts” or “organizational EH impacts” since they could in particular be reduced to zero by making better choices even while producing products and services that are non-sustainable like beef, fossil fuels and flights to space.

Note that process impacts include all inputs to the process and thus include labor, investors, LBIs and supplies*. The sum or EH impact contributions U_{Org} reflects the EH impacts the organization incurred in excess of sustainable investors and employees and in excess of using the most sustainable suppliers* and in excess of using the most sustainable processes. We will call the sum of these EH impacts “the organization's EH impacts” or “organizational EH impacts” since they could be reduced to zero by making better choices even while producing products and services that are non-sustainable like beef, fossil fuels and flights to space. In case the “actual” and “best” processes compared are very different in EH impacts (ΔU_{Org,Proc}>>0), some of the EH impacts represented by ΔU_{Org,Proc}, may already be represented by U_{Org,Inv}, U_{Org,Empl} and ΔU_{Org,Sup*} resulting in double counting of some EH impacts. In that case additional corrections are needed.

In the above equations the impact variable j was not specified to keep the formulas easier to read. The organizational EH impacts are in particular calculated per EH impact variable (for all three types) and divided by the organization's revenues for the period of determination, resulting in organizational EH impacts for each variable per dollar revenue.

$${U}_{Org , \$ , j} = \text{?} / {C}_{Org}$$

$$\text{?} \text{indicates text missing or illegible when filed}$$

| | | |
|---|---|---|
| where U_{Org, $, j} = | organizational EH impacts for variable j per | [IU/$] |
| | dollar revenue | |
| where U_{Org, j} = | organizational EH impacts for variable j | [IU] |
| where C_{Org} = | revenues for organization | [$] |

For allowance variable j the organizational EH impacts per dollar revenue are in particular compared to the (universal) reference EH impact for allowance variable j per dollar value for products.

$${S}_{P , A , U , j , p} = {U}_{P , A , \$ , j , Ref} / {U}_{P , A , \$ , j , p}$$

| | | |
|---|---|---|
| where S_{P, A, U, j, p} = | product resource use sustainability for | [ ] |
| | allowance variable j for product p | |
| where U_{P, A, $, j, Ref} = | reference product resource use for | [IU/$] |
| | allowance variable j per dollar spending | |
| where U_{P, A, $, j, p} = | resource use for allowance variable j per | [IU/$] |
| | dollar spending for product p | |

Note:
The “A” in the subscript for S_{P, A, U, j, p} indicates the use of an allowance variable, while the “U” indicates that the sustainability value reflects the use of a “use & damage variable” compared to the “C” used for “conservation” applied.

For allowance variables the organizational sustainability is in particular calculated similar to the aforementioned for products. The analog version for organizational sustainability for allowance variables is:

$${S}_{Org , A , U , j} = {U}_{P , A , \$ , j , Ref} / {U}_{Org , A , \$ , j}$$

| | | |
|---|---|---|
| where S_{Org, A, U, j} = | organizational resource use | [ ] |
| | sustainability for allowance | |
| | variable j | |
| where U_{P, A, $, j, Ref} = | reference product resource use | |
| | for allowance variable j per | [IU/$] |
| | dollar spending | |
| where U_{Org, A, $, j} = | organizational resource use for | [IU/$] |
| | allowance variable j per dollar | |
| | revenue | |

The same analogy applies preferably to the conversion of product resource conservation sustainability to organizational resource conservation sustainability.

For current damage variables no allowance exists. Instead a representative damage value representing the typical (say recent decadal) average current damage for the variable is used. The organizational sustainability is in particular calculated similar to equation for products:

$${S}_{P , C , U , j , p} = MAX ( 0 , 1 - {U}_{P , C , \$ , j , p} / {U}_{P , C , \$ , j , Rep} )$$

| | | |
|---|---|---|
| where S_{P, C, U, $, j, p} = | current damage sustainability for | [ ] |
| | current damage variable j for product p | |
| where U_{P, C, $, j, p} = | current damage attributed to product p | [IU/$] |
| | for variable j per dollar spending | |
| where U_{P, C, $, Rep} = | representative damage attributed to | [IU/$] |
| | products for current damage variable j | |
| | per dollar spending | |

The analog version for organizational sustainability is:

$${S}_{Org , C , U , j} = MAX ( 0 , 1 - {U}_{Org , C , \$ , j} / {U}_{P , C , \$ , j , Rep} )$$

| | | |
|---|---|---|
| where S_{Org, C, U, $, j} = | organizational current damage | [ ] |
| | sustainability for current | |
| | damage variable j | |
| where U_{Org, C, $, j} = | organizational current damage | [IU/$] |
| | for variable j per dollar | |
| where U_{P, C, $, j, Rep} = | representative damage attributed | [IU/$] |
| | to products for current damage | |
| | variable j per dollar spending | |

The same analogy applies preferably to the conversion of product current damage mitigation sustainability to organizational current damage mitigation sustainability.

For historic damage variables a conservation requirement can exist. This requirement is in particular only activated once sufficient TTC is available to apply to historic damage. The same analogy applies in particular to the conversion of product historic restoration sustainability to organizational historic restoration sustainability. The various organizational sustainabilities can be combined in the same ways as shown earlier for individual and product sustainabilities.

As can be seen from the above formulas, even for an organization producing very non-sustainable products, the organizational sustainability can be equal to 100% in particular when:
Employee sustainability is 100%,
Investor sustainability is 100%,
Supplies* used are the most sustainable and/or originate from the most sustainable supplier*,
The process used to produce the product is the most sustainable for the specific product.

The organizational sustainability is in particular merely a function of the organization's performance on these four aspects.

In particular, with the inventive method and/or system the following advantages can be reached:

### 1. Directionality of EH Impacts:

Defining the directionality of EH impact flows of LBIs, products 1, services 2 and labor of persons 4 to only flow in consumer direction, can lead to a surprising fundamental change in the use of money.

### 2. Quantifying EH Impacts:

Quantifying the magnitude of EH impacts and using the cost of the associated EH conservation to express the EH impacts as EH liabilities and EH assets, can lead to a system of product pricing where non-sustainable products 1, services 2 and labor costs (of persons 4) are more expensive and therefore less attractive.

### 3. Cost Free Conservation:

Under most conditions everything has costs while nothing is free. It is therefore, in particular, not intuitive that the costs of conservation can be essentially free. However, by expressing environ-human (EH) impacts as EH liabilities and EH assets and by setting the 100% conservation sustainability standard for all products 1, services 2 and individual of persons 4 labor, buying or not buying conservation can result in the same costs/purchasing power. When purchasing or not purchasing conservation can have the same costs, the conservation is free of costs. The ability for individuals 4 and organizations to buy conservation essentially free of net costs is a surprising aspect of the method and/or system.

### 4. Product Transformation:

Under the Metrics, products 1, services 2 and labor of person 4 provided are defined as the all-inclusive mixtures of intended and unintended materials, services and labor output produced. The feature/aspect of application of conservation in the right amount and to the right product and otherwise under the right conditions (the “triggering” requirements) can transform the product 1 or service 2 or labor by individual 4 from non-sustainable to fully sustainable by removing EH damage and excess EH resource use. This can be essential to creating a sustainable society and is a surprising result of the inventive method and/or system. Such transformation is in particular shown in FIG. 16A.

### 5. Selling Unused Allowances:

The possibility of selling unused fractions of natural resource use allowances by the poor to the rich can be an unexpected effect of the Metrics system. This effect was only “dreamed up” after defining EH resource use allowances and the realization that poor consumers using less than their allowance (while being >100% sustainable) would have no additional benefits. While the Metrics system in particular is intended to improve EH conditions in general, expectations are in particular that participation would be mainly feasible for (and start with) the richer individuals 4 in richer countries and the producers selling products 1 and services 2 to these consumers. These richer consumers would be more interested in sustainability, have the means to buy rated products 1 and services 2 and make the investments needed to implement changes towards sustainability. The possibility of selling unused fractions of natural resource use allowances by the poor created the unexpected result of the world's poor becoming major actors in global sustainability improvements while preferably lifting themselves out of poverty.

### 6. Maximizing of Conservation:

The requirement to apply conservation to the full extent available as a 2^{nd} automatic transaction immediately following the purchase of a product 1, service 2 or after payment for labor of individual 4 can guarantee that all conservation available will be sold and maximizes the rate of growth of additional conservation capacity, minimizing the period needed to return to sustainable conditions.

### Superiority of the Solution

The solution is in particular superior to others in at least one of the following aspects:

### a) Global System:

The same standardized system for determination of EH impact variables is used globally, allowing seamless use over all types of products 1, services 2, individuals 4, organizations 3 and over all countries.

### b) Employees Included:

EH impacts of employees are included in the calculation of EH impacts of products 1, services 2 manufactured and salaries of persons 4 paid.

### c) Real Time Determination:

EH impact variables for labor of individuals 4 provided are essentially measured in real time allowing real time calculation of EH impacts for products 1 and services 2 manufactured and services 2 provided. All transactions are processed almost instantaneously during which process the EH-impacts of the product 1 and services 2 are transferred from seller to buyer. Real time EH-impact transfer for supplies and products 1 and services 2 eliminates errors and inaccuracies resulting from delayed quantifications taking days, weeks, months or even longer.

### d) Flexible Granularity:

The method allows environmental supply chain steps (ESCS) to be defined as very narrow (one step) or to include a series of steps as long as the inputs used reflect the product 1 or service 2 or labor with reasonable accurately

### e) Electronic Storage Blocks:

Electronic storage calculation blocks (using preset product lifetimes) can be used for larger purchase (appliances, cars, etc.) to average out EH-impacts over the typical product life cycle. The same can be done for smaller spending, further evening the EH-impacts over the accounting period for consumers.

### f) Employee Selection:

The invention allows employers to select employees based on the individual's sustainability history and/or to pay a higher salary to more sustainable employees.

### g) Employer Selection:

The invention allows employees to select employers based on employer participation and sustainability history.

### h) Humane Conditions Increase Profits:

Inclusion of human conditions not only prevents changes towards deteriorating human conditions but rewards organizations 3 for improving human conditions by increasing profits, while deteriorating human conditions will lead to higher costs and lower profits.

### i) Product Sustainability Evaluation:

The invention allows selling of EH-impact rated products 1 (“rated products”) and services 2 (“rated services”) between Metrics participants (“participants”). The product rating and barcode linking of product 1 or service 2 to its product data sheet in turn allows the buyer (person 4) to evaluate the sustainability of products 1 and service 2 and to choose the most sustainable product or service.

### j) Higher Prices for Non-Sustainable Products:

Use of conservation withholdings (CW) leads to higher prices for products 1 and services 2 of lower sustainability, driving such products 1 and services 2 out of the market.

### k) Sustainability by Ranking:

Producers and all organizations 3 in general, will apply sustainability by ranking, a process whereby participating suppliers will be preferentially selected and ranked by degree of Metrics participation and product sustainability even before more sustainability improvements are implemented. Motivated and likely more sustainable producers will thus lay claim to already more sustainable suppliers putting exceedingly more pressure on remaining suppliers to participate.

### l) Organizational Sustainability:

The invention allows the calculation of organizational/employer sustainability and allows sustainability based business valuation and investment ratings.

### m) Free TTC:

The invention allows participating consumers to buy title to conservation (TTC) essentially free of net costs. Since the participating employer/producer would otherwise need to buy the same amount of conservation at the same costs, and these costs are paid for by the increased sales price for products sold to participating customers, there are essentially no additional costs for the participating employer/producer or for the participating employee/consumer.

### n) Automatic TTC Purchase:

The invention requires participating consumers working for participating employers to buy title to conservation (TTC) automatically and immediately as a 2^{nd} purchase for the full amount of conservation withholdings (limited to availability). This leads to the highest rate of change towards sustainable conditions that the society is technically able to support.

### o) Slavery Eradication:

The invention allows the eradication of slavery and child labor in coordination with dedicated NGOs and thus can significantly improve human conditions.

### p) Payments to NGOs Helping the Poor:

The invention allows organizations 3 improving human conditions (NGOs helping the poor) to be paid for services 2 rendered independent of their classic sources of revenue (governments, donations). While these organizations 3 will need to be meet strict conditions for both organization 3 and work done, this will allow such organizations 3 to fund their humane condition conservation objectives much better and reduce poverty and human conditions in general.

### q) Unused Allowance Fraction:

The invention allows the exchange of unused individual allowance fractions providing the lower income half of the world population with financial means to cover costs of living, education/training and starting businesses, eradicating poverty over time.

### r) Conservation Services:

The invention allows organizations 3 providing conservation, like wildlife conservation, carbon sequestration and improvement of human conditions to be paid for services 2 rendered independent of their classic sources of revenue (governments, donations). This will allow such organizations 3 to fund their conservation objectives much better and will allow expansion of conservation services 2 at the fastest possible rates. The moneys flowing into the nature protectorate organizations 3 (NPO) will also flow into the local participating communities and local economies will benefit while doing so sustainably. The financial influx tied to nature protectorates (NP) and NGOs will foster stronger cooperation between NP, NPO, surrounding communities and governments than could be possible without such financial influxes.

### s) Creates Market for CSOs:

The invention allows organizations 3 providing carbon sequestration directly from air to make the large investments needed to grow at the fastest rate societies can sustain. This in turn allows the fastest possible route towards a reduction of global warming and a period of (managed) global cooling.

### t) Driver to Carbon Neutrality:

The invention creates a strong economic driver and therefore a fast transition to carbon neutrality for individuals 4 (and their families) and organizations 3. Non-carbon neutral equipment will need to be replaced by carbon neutral equipment (PV solar, heat pumps, well insulated buildings, electric vehicles and batteries).

### u) Conservation Credits:

The use of conservation credits provides incentives for changes to carbon neutrality, pays employees for reduction of EH liabilities their employer otherwise faces and increases purchasing power for participating employees, creating a strong driver for participation.

### v) Sustainability Based Taxation:

The method allows change to a sustainability-based taxation system or taxation alternative. Implementation of sustainability-based taxation or taxation alternative would be the strongest driver towards a sustainable world.

### w) Employment Increase:

The invention will lead to a large demand in labor in order to implement all aspects of sustainability improvements at the rates needed and in all participating countries.

### x) Cost Reduction:

Participating producers and consumers implementing resource use and damage preventive measures to their fullest extent, would not only avoid the cost of corrective measures, but would also reduce base costs.

### y) Higher Quality of Life:

Participating consumers can enjoy a higher quality of life (better working and living conditions and more income to spend) and are more attractive as employees, commanding higher salaries.

### z) Minimum Period to Sustainability:

Implementation of the combined set of methods would guarantee the full utilization of the (essentially) free TTC system, pushing sustainability changes to the maximum rates which developed societies can support, guaranteeing full employment during the conversion period to a sustainable society.

List of Acronyms and Terms

| Acronym/ | |
|---|---|
| term | Meaning |
| CA | cultivated area |
| CFPO | coastal flooding protection organization |
| CSO | carbon sequestration organization |
| CW | conservation withholdings |
| ECFO | environ-humane conservation fund organization |
| EFAV | EH liability free asset value |
| EH | environ-human (combination of environmental and |
| | human) |
| EH conservation | combination of EH protection and EH restoration |
| EH damage | combination of environmental damage and non- |
| | acceptable/inhumane treatment |
| EH protection | combination of environmental protection and |
| | protection of humane treatment |
| EH resource use | combination of use of natural resources and labor |
| EH restoration | combination of environmental restoration and human |
| | rehabilitation |
| ESCS | environmental supply chain step as used for the |
| | Metrics system |
| HCPRO | humane conditions protection and rehabilitation |
| | organization |
| IAEO | individual allowance exchange organization |
| ICTP | Impact corrected transaction price |
| IFFA | impact-free financial account |
| IRFA | impact recorded financial account |
| IRFT | impact recorded financial transactions |
| IRO | impact rating organizations |
| IU | impact units for impact variable used |
| ISCS | individual supply chain step |
| ISCS-PSCS | combined single PSCS and ISCS for all own |
| | employees |
| LBI | location based impacts |
| MLFO | metrics licensed financial organization |
| MP&S | manufactured products and services |
| NCLP | non-corrected list price |
| NP | nature protectorate (the wildlife area protected) |
| NPO | nature protectorate organization managing one or |
| | more NPs |
| NSAV | non-sustainable asset value |
| NSFA | non-sustainable financial account |
| PAPO | precipitation area protection organization |
| PCDA | personal current damage absorption |
| PHDA | personal historic damage absorption |
| PSA | personal sustainable absorption |
| PSCS | product supply chain step |
| PSRA | personal sustainable resource use absorption |
| RSCS | rating supply chain step |
| SAV | sustainable asset value |
| SEFA | sustainability enabled financial account |
| SEFT | sustainability enabled financial transaction |
| S&SCO | soil and sediment conservation organization |
| SBT | sustainability based taxation |
| TTC | title to conservation |
| UATO | unused allowance trading organization |
| UIFT | financial transaction with unknown EH impacts |
| UIFA | financial account with unknown EH impacts |
| U&D | use and damage |
| V | pre-defined evaluation variables |
| WSMO | World Sustainability Metrics Organization |
| XCCD | excess current damage deduction |
| XHDD | excess historic damage deduction |
| XID | excess EH-impact deduction |
| XNRD | excess environmental resource use deduction |

### LIST OF REFERENCE NUMERALS

1 product
2 service
3 organization
4 person/individual

1-28. (canceled)

29. A method for determining or evaluating a sustainability of a product, a service, an organization and a person, wherein said method comprises the steps of:
i. providing or establishing an evaluation system on the basis of pre-defined evaluation variables, which evaluation system is configured to assign a sustainability value to the product, the service, the organization or the person to be evaluated,
ii. quantifying, on the basis of the pre-defined evaluation variables, impacts on the environment and impacts affecting human conditions for the product, the service, the organization or the person to be evaluated,
wherein step ii. comprises
quantifying damaging impacts on the environment and damaging impacts affecting human conditions for the product, the service, the organization or the person to be evaluated and
determining a conservation required to neutralize the damaging impacts or use of resources, and
iii. assigning, on basis of the quantified impacts, a specific sustainability value to the product, the service, the organization or the person to be evaluated,
wherein the conservation required to offset the impacts on the environment and impacts affecting human conditions for the product, the service, the organization or the person to be evaluated in step ii. can be selected from at least one of the following groups
human condition conservation,
wildlife area conservation,
watershed area conservation,
carbon sequestration,
soil and sediment conservation,
soil and surface water pH restoration,
dike protection of coastal areas at risk of flooding.

30. The method of claim 29, wherein step ii. comprises measuring the pre-defined evaluation variables for at least one of
cultivated area use,
biodiversity change,
climate change,
fresh water use and conservation,
human conditions,
human reproduction,
soil and sediment use and conservation,
soil and surface water acidification and/or pH change,
coastal area use and conservation,
infectious disease prevention and mitigation, and
atmospheric ozone layer damage and conservation.

31. The method of claim 29, wherein in step ii. the quantification of impacts is based on three types of environmental supply chain steps, namely,
individual supply chain steps for quantifying the impacts of persons,
product supply chain steps for quantifying the impacts of manufactured products and rendered services, and
rating supply chains steps for estimating location based impacts and the impacts of labor, products and services not evaluated previously.

32. The method of claim 29, wherein in step ii., for the product, the service, the organization or the person to be evaluated, the conservation determined in step ii. is automatically applied with regard to the price of the product, the service, the organization or the person.

33. The method of claim 29, wherein the evaluation variables are organized and stored in a metrics database.

34. The method of claim 29, wherein the evaluation variables are measured in terms of allowance values, current damage values, historic damage values, and conservation values.

35. The method of claim 29, wherein the method runs computer-implemented.

36. The method of claim 29, wherein the method allows for comparison of sustainability values of products, services, persons and organizations of the same kind or different kinds.

37. The method of claim 29, wherein the method allows for assigning a commercial price, value or salary to the persons, product, the organization or the service to be evaluated.

38. A system for determining or evaluating a sustainability of a product, a service, an organization and/or a person, wherein said system is configured to
a. quantify, on the basis of pre-defined evaluation variables, impacts on the environment and impacts affecting human conditions for the product, the service, the organization or the person to be evaluated,
b. quantify damaging impacts on the environment and damaging impacts affecting human conditions for the product, the service, the organization or the person to be evaluated,
c. determine a conservation required to neutralize the damaging impacts or use of resources,
d. assign, on basis of the quantified impacts, a specific sustainability value to the product, the service, the organization or the person to be evaluated, and
e. to select the conservation required to offset the impacts on the environment and impacts affecting human conditions for the product, the service, the organization or the person to be evaluated in step d. from at least one of the following groups
human condition conservation,
wildlife area conservation,
watershed area conservation,
carbon sequestration,
soil and sediment conservation,
soil and surface water pH restoration,
dike protection coastal areas at risk of flooding.

39. The system of claim 38, wherein said system is configured to measure the predefined evaluation variables for at least one of
cultivated area use,
biodiversity change,
climate change,
fresh water use and conservation,
human conditions,
human reproduction,
soil and sediment use and conservation,
soil and surface water acidification and/or pH change,
coastal area use and conservation,
infectious disease prevention and mitigation, and
atmospheric ozone layer damage and conservation.

40. The system of claim 38, wherein said system is configured to quantify said impacts on basis of three types of environmental supply chain steps, namely,
individual supply chain steps for quantifying the impacts of persons,
product supply chain steps for quantifying the impacts of manufactured products and rendered services, and
rating supply chains steps for estimating location based impacts and the impacts of labor, products and services not evaluated previously.

41. The system of claim 38, wherein said system is configured to automatically apply, for the product, the service, the organization or the person to be evaluated, the conservation determined with regard to the price of the product, the service, the organization or the person.

42. The system of claim 38, wherein said system comprises a metrics database in which the evaluation variables are organized and stored.

43. The system of claim 38, wherein said system is configured to measure the evaluation variables in terms of allowance values, conservation values, current damage values, and historic damage values.

44. The system of claim 38, wherein said system comprises a processor configured to execute the method of claim 29.

45. The system of claim 38, wherein said system is configured to compare sustainability values of products, services, organizations and persons of the same kind or different kinds.

46. The system of claim 38, wherein said system is configured to assign a commercial price, value or salary to the persons, product, organization or the service to be evaluated.

47. Use of a system of claim 38 for determining or evaluating a sustainability of a product, a service, an organization or a person.
